(19) United States
(12) Patent Application Publication
(10) Pub. No.: US 2012/0033034 A1
(43) Pub. Date: Feb. 9, 2012

(54) RECEIVING APPARATUS AND RECEIVING METHOD

(75) Inventors: Satoshi OTSUKA, Yokohama (JP); Sadao TSURUGA, Yokohama (JP)

(73) Assignee: Hitachi Consumer Electronics Co., Ltd.

(21) Appl. No.: 13/092,322

(22) Filed: Apr. 22, 2011

(30) Foreign Application Priority Data
Aug. 6, 2010 (JP) 2010-176925

(51) Int. Cl. H04N 13/00

(52) U.S. Cl. 348/42; 348/E13.001

(57) ABSTRACT

A receiving apparatus, for receiving a digital broadcast signal, which is broadcasted by combining 3D video program content and 2D video program content, for displaying the most suitable picture to a user, at a changing point between 2D video and 3D video, comprises: a receiver unit, which is configured to receive a digital broadcast signal, including program content and a first identification information for identifying the program content to be a 3D picture program or a 2D picture program; and a controller unit, which is configured to determine the program content received to be a 3D video program content or a 2D video program content, upon basis of the first identification information about the program content received by the receiver unit, and further determine a 3D view preparation condition, being a condition for preparing view of 3D video by a user, wherein a video signal is outputted, being exchanged between 2D display and 3D display, determined from the 3D view preparation condition of the user and the information of whether the program content identified from the first identification information is the 3D video program content or the 2D video program content.

This application relates to and claims priority from Japanese Patent Application No. 2010-176925 filed on Aug. 6, 2010, the entire disclosure of which is incorporated herein by reference.

### BACKGROUND OF THE INVENTION

The present invention relates to a broadcast receiving apparatus of three-dimensional (hereinafter, 3D) video or picture, a receiving method, and a transmitting method, as well.

In the Patent Document 1 is described, “for displaying suitable 2D picture or 3D picture, by taking fatigue of eyes into the consideration thereof” as the problem(s) to be dissolved, and as the dissolving means thereof, “the picture generated by the an output T2 of a 2D/3D converting means comes to be the picture L31 shown in 1-3. The picture L31 is such 3D picture that the pictures for the left-side eye and the right-side eye are produced upon basis of the T1 signal and are aligned. When 2D is selected through a 2D/3D manual switching, 2-6 picture is supplied to a stereographic picture display means, and the picture L51-2 of 2-9 is displayed. When 3D is selected through the 2D/3D manual switching, the picture of 2-7 is supplied to the three-dimensional picture display means, and the picture L51-3 of 2-10 is displayed. Since 2-7 is 3-dimensional picture, and a 2D/3D exchange control means controls the stereographic picture display means, so as to obtain 3-D picture display, therefore it results into 3-D picture display. As was mentioned above, the control is done in such a manner, that the T2 signal not suitable for display can be avoided from being selected.” and so on.

### PRIOR ART DOCUMENTS

### Patent Documents

[Patent Document 1] Japanese Patent Laying-Open No. 2006-121553 (2006).

### BRIEF SUMMARY OF THE INVENTION

However, in the Patent Document 1 is no disclosure about a process at a time-point when the video signal is exchanged or switched, such as, exchange of a program, etc., and therefore having a problem that there are cases where an appropriate display of the picture cannot be achieved, depending on situations.

For dissolving such the problem as mentioned above, according to one embodiment of the present invention, it is sufficient to apply the technical idea or concept, which is described in the claims, for example.

According to such means as mentioned above, it is possible to output the most suitable picture for a user, in the case where the switching is generated among various video signals, such as, 2D and 3D, and as a result thereof, it is possible to increase usability for the user.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is an example of block diagram for showing the structures or configuration of a system;

FIG. 2 is an example of block diagram for showing the structures or configuration of a transmitting apparatus 1;

FIG. 3 shows an example of allocation of types of stream format;

FIG. 4 shows an example of the structure of a component descriptor;

FIG. 5A shows an example of component contents and component classification, being the constituent elements of the component descriptor;

FIG. 5B shows an example of component contents and component classification, being the constituent elements of the component descriptor;

FIG. 5C shows an example of component contents and component classification, being the constituent elements of the component descriptor;

FIG. 5D shows an example of component contents and component classification, being the constituent elements of the component descriptor;

FIG. 5E shows an example of component contents and component classification, being the constituent elements of the component descriptor;

FIG. 6 shows an example of the structure of a component group descriptor;

FIG. 7 shows an example of a component group classification;

FIG. 8 shows an example of a component group classification;

FIG. 9 shows an example of accounting unit discrimination;

FIG. 10A shows an example of the structure of a 3D program details descriptor;

FIG. 10B is a view for showing 3D/2D classifications;

FIG. 11 is a view for showing an example of method classification of 3D;

FIG. 12 shows an example of the structure of a service descriptor;

FIG. 13 shows an example of service form classification;

FIG. 14 shows an example of the structure of a service list descriptor;

FIG. 15 shows an example of a send-out management regulation, within the transmitting apparatus 1 of the component descriptor;

FIG. 16 shows an example of a send-out management regulation, within the transmitting apparatus 1 of the component group descriptor;

FIG. 17 shows an example of a send-out management regulation, within the transmitting apparatus 1 of the 3D program details descriptor;

FIG. 18 shows an example of a send-out management regulation, within the transmitting apparatus 1 of the service descriptor;

FIG. 19 shows an example of a send-out management regulation, within the transmitting apparatus 1 of the service list descriptor;

FIG. 20 shows an example of a process for each field of the component descriptor, in a receiving apparatus 4;

FIG. 21 shows an example of a process for each field of the component group descriptor, in the receiving apparatus 4;

FIG. 22 shows an example of a process for each field of the 3D program details descriptor, in the receiving apparatus 4;

FIG. 23 shows an example of a process for each field of the service descriptor, in the receiving apparatus 4;

FIG. 24 shows an example of a process for each field of the service list descriptor, in the receiving apparatus 4;

FIG. 25 shows an example of the structure of the receiving apparatus according to the present invention;

FIG. 26 shows an example of an outlook view of an internal function block diagram of a CPU in the receiving apparatus according to the present invention;

FIG. 27 shows an example of a flowchart of 2D/3D picture display process upon basis of a fact that a next program is 3D content or not;

FIG. 28 shows an example of message display;

FIG. 29 shows an example of message display;

FIG. 30 shows an example of message display;

FIG. 31 shows an example of message display;

FIG. 32 is an example of block diagram for showing the structures or configuration of a system;

FIG. 33 is an example of block diagram for showing the structures or configuration of a system;

FIG. 34 is a view for showing a process for 3D reproducing/outputting/displaying of 3D content;

FIG. 35 is a view for showing a process for 2D reproducing/outputting/displaying of 3D content;

FIG. 36 is a view for showing a process for 3D reproducing/outputting/displaying of 3D content;

FIG. 37 is a view for showing a process for 2D reproducing/outputting/displaying of 3D content;

FIG. 38 shows an example of message display;

FIG. 39 shows an example of message display;

FIG. 40 shows an example of combination of streams when transmitting 3D picture;

FIG. 41 shows an example of the structure of a content descriptor;

FIG. 42 shows an example of a code list about program genre

FIG. 43 shows an example of the code list about program characteristics;

FIG. 44 shows an example of the code list about program characteristics;

FIG. 45 is a view for explaining an example of 2D/3D conversion;

FIG. 46 shows an example of a flowchart of a system control unit when the program is exchanged;

FIG. 47 shows an example of a flowchart of the system control unit when determining 2D/3D conversion;

FIG. 48 shows an example of a 3D program conversion setup menu;

FIG. 49 shows an example of a 3D program conversion setup menu; and

FIG. 50 shows an example of a user response receipt object.

### DETAILED DESCRIPTION OF THE PREFERRED EMBODIMENTS

Hereinafter, embodiments according to the present invention will be fully explained by referring to the attached drawings. However, the present invention should not be limited to the embodiments. In the embodiments, explanation will be given, mainly on a receiving apparatus, and therefore suitable for implementation in the receiving apparatus; however, this does not prevent the application to those other than the receiving apparatus. Also, the constituent elements of the embodiments are not always necessary to be applied, but can be applied, selectively.

### <System>

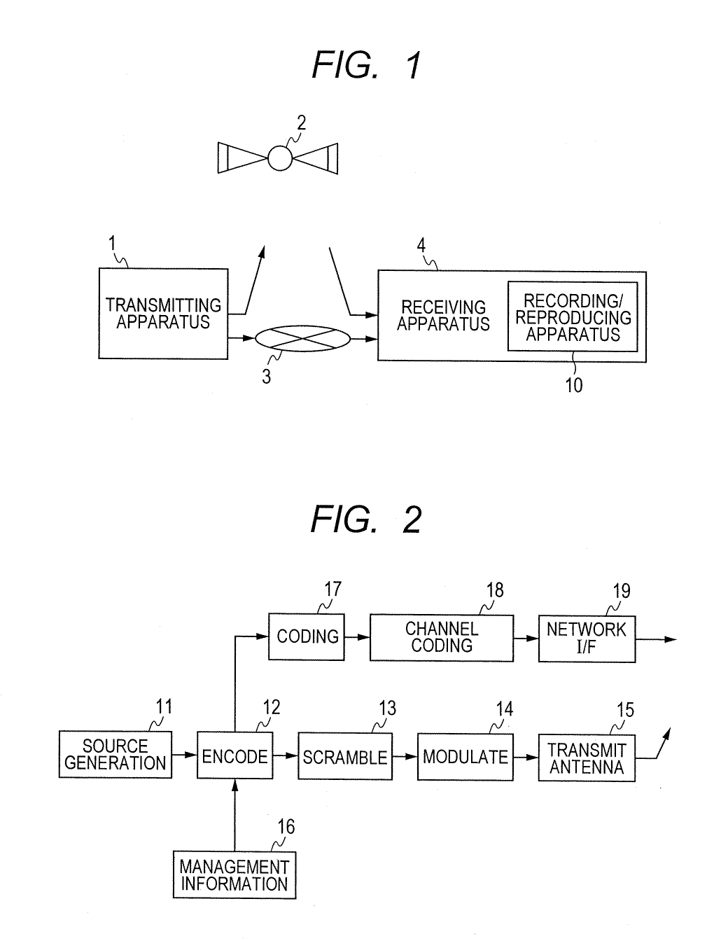

FIG. 1 is a block diagram for showing an example of the structures of a system, according to a present embodiment. This shows an example of case where information is transmitted on air (broadcasted), and thereby recording/reproducing it. However, not limited to the broadcasting, it may be VOD by communication, and is called “distribution”, collectively.

Reference numeral 1 depicts a transmitting apparatus, which is installed in an information providing station, such as, a broadcast station, 2 a relay apparatus, which is provided in a relay station or a broadcast satellite, etc., 3 a public network connecting between an ordinary home or house and the broadcast station, such as, Internet, etc., 4 a receiving apparatus, which is provided within a house of user, and 10 a receiving/recording/reproducing unit, which is built in the receiving apparatus 4, respectively. Within the receiving/recording/reproducing unit 10, the information broadcasted can be recorded or reproduced, or content from a removable external medium can be reproduced, etc.

The transmitting apparatus 1 transmits signal waves, which are modulated through the relay apparatus 2. Other than the transmission through a satellite, as is shown in the figure, it is possible to apply the transmission by a cable, the transmission by a telephone line, the transmission by a terrestrial broadcast wave, and transmission through a network, such as, Internet through the public network 3, etc. This signal wave received by the receiving apparatus 4, as will be mentioned later, after demodulated into an information signal, is recorded on a recording medium, depending on necessity thereof. Or, when transmitting it through the public network 3, it is converted into a format, such as, a data format (an IP packet), etc., according to a protocol suitable for the public network 3 (for example, TCP/IP), while the receiving apparatus 4 receiving the data mentioned above decodes it into the information signal, and it is recorded on the recoding medium, to be a signal suitable for recording depending on necessity thereof. Also, the user can view/listen video/audio shown by the information signals on a display, when this display is built in within the receiving apparatus 4, or by connecting a display not shown in the figure with the receiving apparatus 4, when it is not built therein.

### <Transmitting Apparatus>

FIG. 2 is a block diagram for showing an example of the structure of the transmitting apparatus, in the system shown in FIG. 1.

Reference numeral 11 depicts a source generator unit, 12 an encoder unit for conducting compression according to MPEG 2 or H.264 method, etc., thereby adding program information, etc., 13 a scramble unit, 14 a modulator unit, 15 a transmission antenna, and 16 a management information attachment unit, respectively. Upon the information, which is generated by the source generator unit 11 composed of a camera, a recording/reproducing apparatus, etc., is treated the compression of date amount or volume, within the encoder unit 12, so that it can transmitted with occupying a less band. After being modulated to be a signal suitable to be transmitted, such as, OFDM, TC8PSK, QPSK, multi-value QAM, etc., in the modulator unit 14, it is transmitted as a airwave directing to the relay apparatus 2, from the transmission antenna 15. In this instance, in the management information attachment unit 16, it is attached with program identifying information, such as, an attribute, etc., of the content produced in the source generator unit 11 (for example, coding information of video and/or audio, coding information of audio, structure of program, 3D picture or not, etc.), and also attached with program alignment information produced by the broadcast station, etc. (for example, the structure of the present program and next programs, a method or form of service, structure information of the programs for one week, etc.) Those program identifying information and program alignment information are called, collectively in combination, “program information” hereinafter.

However, there are many cases where plural numbers of information are multiplexed with using a manner, such as, time division, a spread spectram, etc. Though not shown in FIG. 2 for the purpose of simple explanation, in this case, there are plural pieces of systems of the source generator unit 11 and the encoder unit 12, wherein a multiplexor unit for multiplexing plural numbers of information is disposed between the encoder unit 12 and the scramble unit 13, or between the encoder unit 12 and an encoder unit 17.

Also, similar to the signal to be transmitted through the public network 3, the signal produced in the encoder unit 12 is encoded within the encoder unit 17, to be visible/audible for a specific viewer. After being encoded to be a signal suitable for transmission through the public network 3 in a communication path coding unit 18, it is transmitted directing to the public network 3, from a network I/F (Interface) unit 19.

### <3D Transmission Method>

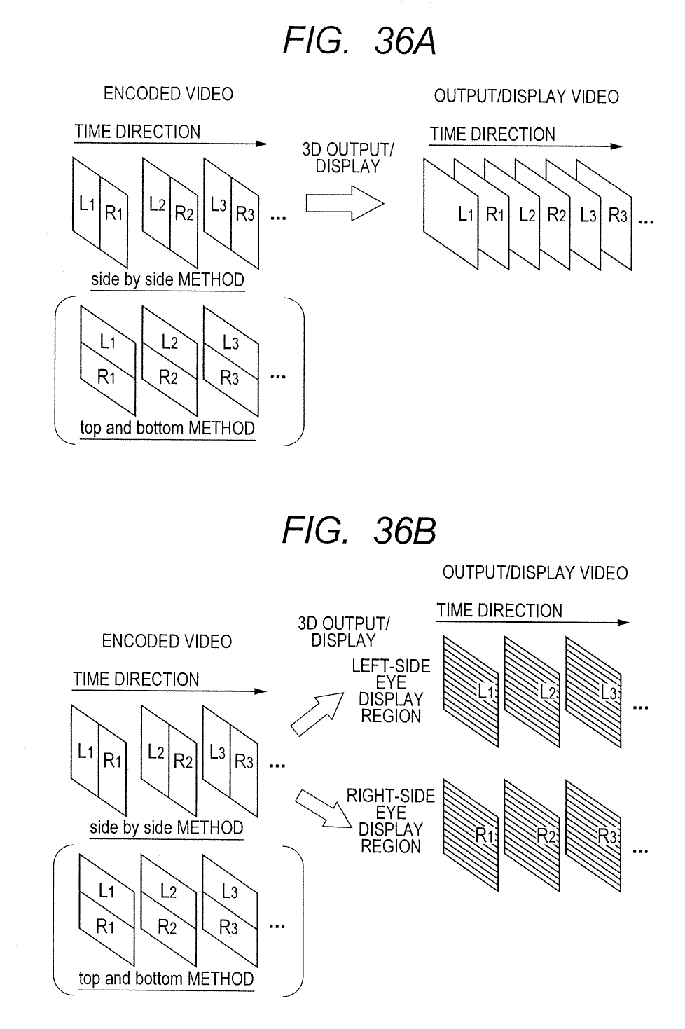

As the transmission method of 3D program to be transmitted from the transmitting apparatus 1, there are two (2) methods, roughly diving it. One of the methods is a method of accepting the pictures for the left-side eye and the right-side eye within one (1) piece of a screen, with utilizing the existing broadcast method for 2D program. In this method is applied the existing MPEG 2 (Moving Picture Expert Group 2) or H.264 AVC, and the feature thereof lies in that compatibility can be obtained between the existing broadcast, and therefore is able to use the existing relaying infrastructure, and enables receipt by the existing receiver (STB, etc.); however, this results to transmit the 3D picture having a half of the maximum resolution of the existing broadcast (the vertical direction, or the horizontal direction). For example, as is shown in FIG. 36A, there are following methods: a “Side-by-Side” method of accepting the picture for the left-side eye (L) and the picture for the right-side eye (R), after dividing one (1) piece of screen into left and right, each within a screen size, width in the horizontal direction being about a half (½) of that of the 2D program and width in the vertical direction being nearly equal to that of the 2D program; a “Top-and-Bottom” method of accepting the picture for the left-side eye (L) and the picture for the right-side eye (R), after dividing one (1) piece of screen into up and down, each within a screen size, width in the horizontal direction being nearly equal to that of the 2D program and with in the vertical direction being about a half (½) of that of the 2D program; and others, such as, a “Field alternative” method of accepting with using interlace, a “Line alternative” method of accepting the pictures for the left-side eye and the right-side eye alternately, for each one (1) scanning line, and a “Left+Depth” method of accepting 2-dimensional (one-side) picture and depth (distance to an object) information for each pixel. In those methods, one (1) piece of screen is divided into plural numbers of screens, and those screens from plural numbers viewpoints are accepted, but as a coding method itself, there can be applied the coding method, as it is, such as, the MPEG 2 or H.246 AVC (except for MVC), originally, not a multi-aspect video coding method, and then, they have a merit of enabling 3D broadcasting with using the method for broadcasting the existing 2D program. Further, in case where the 2D program can be transmitted with a screen size, for example, 1,920 dots in the horizontal direction and 1,080 lines in the vertical direction, at the maximum, it is sufficient to divide one (1) piece of the screen into the left and the right, and accept those pictures for the left-side eye (L) and the picture for the right-side eye (R) into a screen size, for each, 860 dots in the horizontal direction and 1,080 lines in the vertical direction, to be transmitted, in particular, when executing the 3D program broadcast with using the “Side-by-Side” method. Similarly in this case, in particular, when executing the 3D program broadcast with using the “Top-and-Bottom” method, it is sufficient to divide one (1) piece of the screen into the left and the right, and accept those pictures for the left-side eye (L) and the picture for the right-side eye (R) into a screen size, for each, 1,920 dots in the horizontal direction and 540 lines in the vertical direction, to be transmitted.

As other method, there is a method of transmitting the picture for the left-side eye and the picture for the right-side eye, respectively, on separated Elementary stream (ES). In the present embodiment, hereinafter, that method is called “2 viewpoint separate ES transmission”. As an example of this method, for example, a transmission method by means of H.264 MVC, being the multi-aspect video coding method. The feature thereof lies in that the 3D picture of high resolution can be transmitted. With using this method, there can be obtained an effect that the 3 D picture of high resolution can be transmitted. However, the multi-aspect video coding method is a coding method standardized for encoding the multi-aspect picture, wherein multi-aspect pictures can be encoded, but without dividing one (1) screen for each aspect, and thereby encoding separate screen for each aspect.

When transmitting the 3D picture with this method, while determining an encoded picture of an aspect for the left-side eye, as a main aspect screen, it is sufficient to transmit an encoded screen for the left-side eye, as other aspect picture, for example. With doing this, about the main aspect picture, it is possible to maintain a compatibility with the existing 2D program broadcasting method. For example, when applying the H.264 MVC as the multi-aspect picture coding method, about a base sub-stream of the H.264 MVC, the main aspect picture can maintain the compatibility with the 2D picture of the H.264 MVC, and thereby enabling to display the main aspect picture as the 2D picture.

Further, in the embodiment of the present invention, as other methods of “3D 2-aspect separate ES transmission method” are included the following methods, too.

As one other example of “3D 2-aspect separate ES transmission method” is included a method of encoding a picture for the left-side eye as a main aspect picture, by the MPEG 2, while encoding a picture for the right-side eye as the other aspect picture, by the H.264 AVC; thereby obtaining separate streams, respectively. With this method, since the main aspect picture is MPEG 2 compatible or operable, and can be displayed as the 2D picture, it is possible to maintain the compatibility with the existing 2D program broadcasting method, in which pictures encoded by the MPEG 2 are widely spread.

As other example of “3D 2-aspect separate ES transmission method” is included a method of encoding the picture for the left-side eye as the main aspect picture, by the MPEG 2, and encoding the picture for the right-side eye as the other aspect picture, by the MPEG 2, thereby obtaining separate streams. With this method, since the main aspect picture is MPEG 2 compatible or operable and can be displayed as the 2D picture, it is possible to maintain the compatibility with the existing 2D program broadcasting method, in which pictures encoded by the MPEG 2 are widely spread.

As further other example of “3D 2-aspect separate ES transmission method” may be included one of encoding the picture for the left-side eye as the main aspect picture, by the H.264 AVC or the H264 MVC, while encoding the picture for the right-side eye as the other aspect picture, by the MPEG 2.

Further, separating from “3D 2-aspect separate ES transmission method”, even with a coding method, such as, the MPEG 2 or the H264 AVC (except for MVC), etc., but not the coding method regulated as the multi-aspect video coding method, originally, it is also possible to produce a stream storing the picture for the left-side eye and a frame for the right-side eye, alternately, and thereby enabling 3D transmission.

### <Program Information>

Program identify information and program alignment information are called program information, collectively.

The program identify information is also called, PSI (Program Specific Information), and it is the information necessary for selecting a desired program, i.e., it is made of four (4) tables, including PAT (Program Association Table) for designating a packet identifier of a TS packet for transmitting PMT (Program Map Table) relating to broadcast programs, PMT for designating a packet identifier of TS packet for transmitting each coded signals building up the broadcast programs, NIT (Network Information Table) for transmitting information relating to transmission path, such as, a modulation frequency, etc., and information relating to the broadcast programs, and CAT (Conditional Access Table) for designating a packet identifier of TS packet for transmitting individual or particular information among relating information of pay broadcasts, and they are regulated by a system regulation of MPEG 2. For example, it includes the encoded information of video, the encoded information of audio, and the structures of programs. According to the present invention, there is added the information indicative of whether being the 3D picture or not, newly. That PSI is added within the management information attachment unit 16.

The program alignment information is also called, SI (Service Information), including various types of information defined for the purpose of convenience of program selection, and there is included PSI information of MPEG-2 system regulation, and there are followings: EIT (Event Information Table) describing information relating to programs therein, such as, a program title, broadcast date/time, broadcast content, etc., for example, SDT (Service Description Table) describing information relating to composition of channels (or services) therein, such as, a composite channel name, a name of broadcast undertaker, etc.

For example, it includes composition of a program presently broadcasted and/or a program to be broadcasted next, a form of service, or information indicating composite information of programs for 1 week, and is added within the management information attachment unit 16.

In the broadcast information are included a component descriptor, a component group descriptor, a 3D program detail descriptor, a service descriptor and a service list descriptor, etc., being a constituent elements of the broadcast information. Those descriptors are described in the tables, such as, PMT, EIT [schedule basis/schedule extended/present/following], NIT, SDT, for example.

As a way of using of the respective tables, PMT and EIT, for example, about PMT, since it is only for describing the information of the program present broadcasted, it is impossible to confirm the information of the program, which will be broadcasted in future. However, since a transmission cycle from a transmitter side is short, the time until completion of the transmission is also short, and therefore it has a feature of being high in reliability in the meaning that there is no change because of the information of the program broadcasted at present. On the other hand, about the EIT [schedule basis/schedule extended], although information of programs up to 7 days ahead can be obtained, other than the program broadcasted at present; however, from meanings that the time until completion of receipt is long since the transmission cycle from the transmitter side is long comparing to PMT, that it needs a lot of memory regions for holding, and that there is possibility of being changed because of being a phenomenon of future, therefore, it has a demerit that a reliability is low, or the like. About EIT [following], it is possible to obtain information of the programs of the next broadcast time.

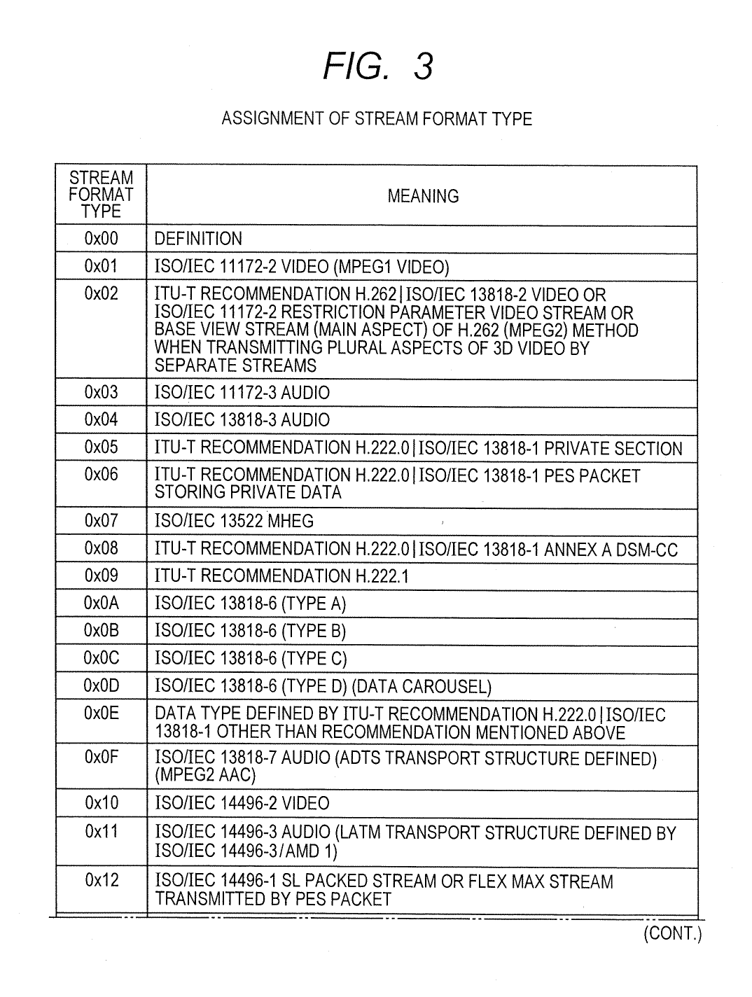

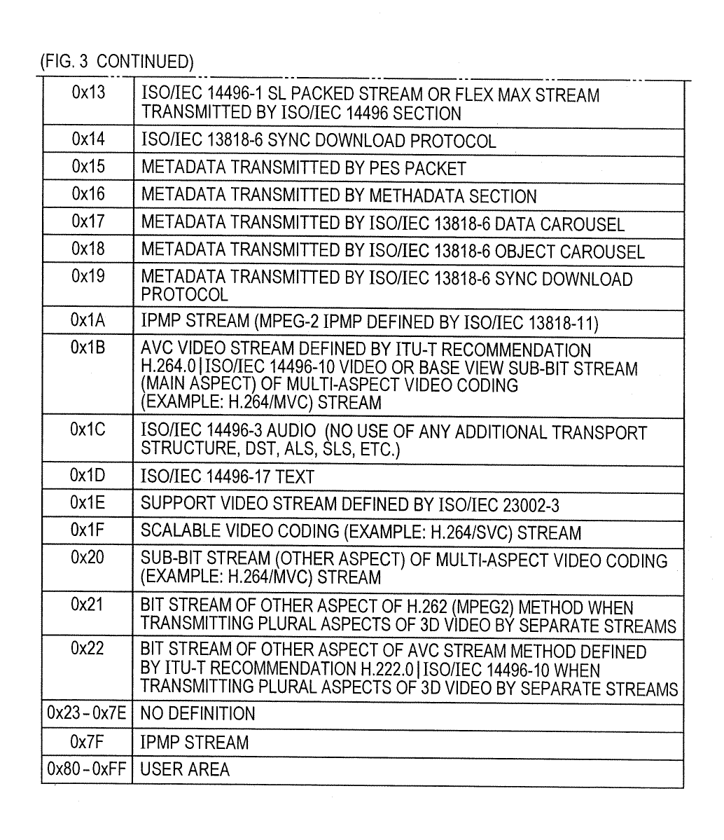

PMT of the program identify information, with using the table structures defined in ISO/IEC 13818-1, is able to show a format of ES of the program under broadcast, by “stream_type” (stream format type), i.e., the information of 8 bits, which is described in a second loop thereof (a loop for each ES (Elementary Stream)). In an embodiment of the present invention, with increasing the formats of ES more than that of the conventional one, the formats of ES of the programs to be broadcasted are assigned, as is shown in FIG. 3, for example.

First of all, in relation to a base-view bit stream (main aspect) of the multi-aspect video coding (example: H.264/MVC) stream, “0x1B” is assigned, which is same to AVC video stream, which is defined by the existing ITU-T recommendation H.264|ISO/TEC 14496-10 picture. Next, sub-bit stream (other aspect) of the multi-aspect video encoded stream (for example, H.264 MVC), which can be used in the 3D picture program, is assigned to “0x20”.

Also, in relation to a base-view bit stream (main aspect) of H.262 (MPEG 2) method, when it is applied in “3D 2-aspect separate ES transmission method” for transmitting multi-aspects of 3D picture as a separate stream, “0x02” is assigned, which is same to the existing ITU-T recommendation H.264|ISO/TEC 113818-2 video. Herein, the base-view bit stream (main aspect) of H.262 (MPEG 2) method of the case when transmitting the multi-aspects of 3D picture as a separate stream, is a stream, only the main aspect picture of which is encoded with of H.262 (MPEG 2) method, among the multi-aspect pictures of the 3D pictures.

Further, to “0x21” is assigned a bit stream of other aspect of H.262 (MPEG 2) method of the case when transmitting the multi-aspects of the 3D picture as the separate stream.

Further, to “0x22” is assigned bit stream of other aspect bit stream of AVC stream format, which is defined by ITU-T recommendation H.264|ISO/IEC 14496-10 video of the case when transmitting the multi-aspects of the 3D picture as separate stream.

However, in the explanation given herein, the sub-bit stream of multi-aspects video coding stream, which can be used in the 3D picture program, is assigned to “0x20”, the other-aspects bit stream of H.262 (MPEG 2) method of the case when transmitting the multi-aspects of the 3D picture as separate stream is assigned to “0x21”, and AVC stream defined by ITU-T recommendation H.264|ISO/IEC 14496-10 picture of the case when transmitting the multi-aspects of the 3D picture as separate stream is assigned to “0x22”; however, they may be assigned to any one of “0x23” to “0x7E”. Also, the MVC video stream is only one example, but it may be a video stream other than H.264/MVC, if indicating multi-aspects encoded video steam, which can be used in the 3D picture program.

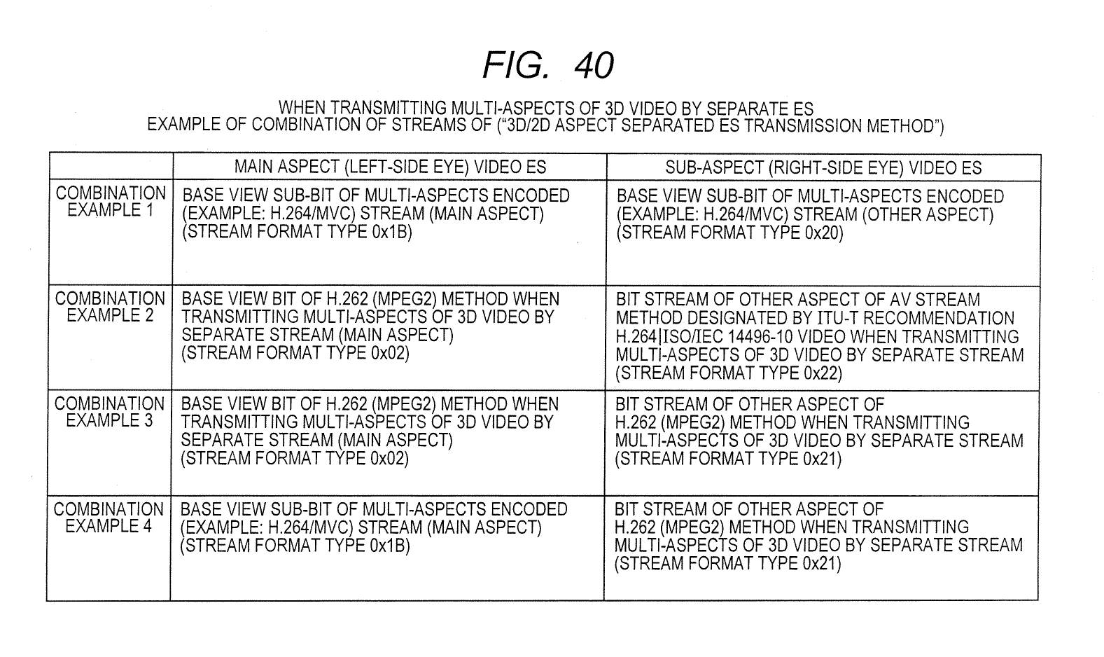

As was mentioned above, by assigning bits of “stream_type” (stream format type), according to the embodiment of the present invention, it is possible to transmit the 3D program with a combination of streams, as shown in FIG. 40, for example, when the broadcast undertaker on the side of transmitting apparatus 1 transmits (or, broadcasts) it.

In a combination example 1, as the main-aspect (for the left-side eye) video stream is transmitted a base-view sub-bit stream (main aspect) (stream format type “0x1B”) of the multi-aspects video encoded (example: H.264/MVC) stream, and as a sub-aspect (for the right-side eye) video stream is transmitted a sub-bit stream for use of other-aspect (stream format type “0x20”) of the multi-aspects video encoded (example: H.264/MVC) stream.

In this case, for both the main-aspect (for the left-side eye) video stream and the sub-aspect (for the right-side eye) video stream, there are used streams of the multi-aspects video encoding (example: H.264/MVC) method. The multi-aspects video encoding (example: H.264/MVC) method is, originally, a method for transmitting a multi-aspects picture, and under the combination shown in FIG. 40, the 3D program can be transmitted, effectively at the most.

Also, when executing 3D display (output) of the 3D program, the receiving apparatus processes both the main-aspect (for the left-side eye) video stream and the sub-aspect (for the right-side eye) video stream, and thereafter, is able to reproduce the 3D program.

When the receiving apparatus executes the 2D display (output) of the 3D program, it processes only the main-aspect (for the left-side eye) video stream, and thereafter, is able to display (output) it as the 2D program.

Further, because of compatibility between the base-view sub-bit stream of the multi-aspect coding method H.264/MVC and the existing video stream of H.264/AVC (except for MVC), there can be obtained the following effect, by assigning the stream format type of both to the same “0x1B”, as is shown in FIG. 3. Thus, it is an effect that, even if the receiving apparatus, having no function of executing 3D display (output) of the 3D program, receives the 3D program of the combination 1, it is possible to display (output) the main-aspect (for the left-side eye) video stream of that program, as an ordinary 2D program, by recognizing that to be the same stream to the existing video stream of H.264/AVC (except for MVC) upon basis of the stream format type, if the receiving apparatus has such a function that displays (outputting) the video stream (AVC video stream defined by ITU-T recommendation H.264|ISO/IEC 14496-10 video).

Further, since to the sub-aspect (for the right-side eye) video stream is assigned the stream format type, which is not provided conventionally, it is neglected within the existing receiving apparatus. With this, it is possible to prevent the sub-aspect (for the right-side eye) video stream from being displayed (outputted), as is not intended by the broadcast station side.

Therefore, even if starting the broadcast of 3D program of the combination example 1, newly, it is possible to avoid a situation where it cannot be displayed (outputted) on the existing receiving apparatus, having the function of displaying (outputting) the video stream of the existing H.264/AVC (except for MVC). With this, If starting such 3D program broadcast, newly, in the broadcast managed by an income of advertisement, such as, CM (commercial message), since it can be viewed/listened on the receiving apparatus, which is not enabled to the 3D display (output) function, it is possible to avoid an audience rating from being reduced due to the limit of function of the receiving apparatus; i.e., there is a merit on the broadcast station side.

In a combination example 2, as the main-aspect (for the left-side eye) video stream is transmitted a base-view dot stream (main-aspect) (stream format type “0x02”) of H.262 (MPEG 2) of the case when transmitting the multi-aspects of 3D picture, and as a sub-aspect (for the right-side eye) video stream is transmitted an AVC stream (stream format type “0x02”), which is defined by ITU-T recommendation H.264|ISO/IEC 14496-10 video of the case when transmitting the multi-aspects of 3D picture as a separate stream.

Similar to the combination example 1, when executing 3D display (output) of the 3D program, the receiving apparatus processes both the main-aspect (for the left-side eye) video stream and the sub-aspect (for the right-side eye) video stream, and thereafter, is able to reproduce the 3D program, and also when the receiving apparatus executes the 2D display (output) of the 3D program, it processes only the main-aspect (for the left-side eye) video stream, and thereafter, is able to display (output) it as the 2D program.

Further, adapting the base-view bit stream (main aspect) of H.262 (MPEG 2) of the case when transmitting the multi-aspects of 3D picture as a separate stream, to the stream compatible or operable with the existing ITU-T recommendation H.262|ISO/IEC 13818-2 video stream, and also, as is shown in FIG. 3, assigning the stream format type of both to “0x1B”, it can be displayed (outputted) to be the 2D program, on the receiving apparatus having the function of displaying (outputting) the existing ITU-T recommendation H.262|ISO/IEC 13818-2 video stream, even if not having the 3D display (output) function.

Also, similar to the combination example 1, since to the sub-aspect (for the right-side eye) video stream is assigned the stream format type, which is not provided conventionally, it is neglected within the existing receiving apparatus. With this, it is possible to prevent the sub-aspect (for the right-side eye) video stream from being displayed (outputted), as is not intended by the broadcast station side.

Since the receiving apparatus having a function of display (output) with the existing ITU-T recommendation H.262|ISO/IEC 13818-2 video stream is widely spread, it is possible to prevent an audience rating from being reduced, much more, due to the limit of function of the receiving apparatus, and thereby achieving the most suitable broadcasting for the broadcast station.

Further, adapting the sub-aspect (for the right-side eye) video stream to AVC stream (stream format type “0x22”) defined by the existing ITU-T recommendation H.264|ISO/IEC 14496-10 video, it is possible to transmit the sub-aspect (for the right-side eye) video stream with high compression rate.

Namely, with the combination example 2, it is possible to achieve compatibility of a commercial merit of the broadcast station and a technical merit due to high-efficiency transmission.

In a combination example 3, as the main-aspect (for the left-side eye) video stream is transmitted a base-view dot stream (main-aspect) (stream format type “0x02”) of H.262 (MPEG 2) of the case when transmitting the multi-aspects of 3D picture, and as a sub-aspect (for the right-side eye) video stream is transmitted the bit stream of other aspect (stream format type “0x21” of H.262 (MPEG 2) method of when transmitting the multi-aspects of 3D video as a separate stream.

In this case, also similar to the combination example 1, it is possible to display (output) it as the 2D program, on the receiving apparatus having the function of displaying (outputting) the existing ITU-T recommendation H.262|ISO/IEC 13818-2 video stream, if not having the 3D display (output) function.

In addition to the commercial merit for the broadcast station, i.e., preventing the audience rating from being lowered down due to the restriction of the function of the receiving apparatus, with unification of the coding methods of both the main-aspect (for the left-side eye) video stream and the sub-aspect (for the right-side eye) video stream into H.262 (MPEG 2) method, it is possible to simplify the hardware construction of the video decoding function in the receiving apparatus.

Further, as in a combination example 4, it is also possible to transmit the base-view sub-bit stream (main aspect) (stream format type “0x1B”) of the multi-aspect video encoded (example: H.264/MVC), as the main-aspect (for the left-side eye) video stream, and transmit the bit stream of other aspect (stream format type “0x21) of H.264 (MPEG 2) of the case when transmitting the multi-aspects of 3D video as a separate stream, as the sub-aspect (for the right-side eye) video stream.

However, in the combination shown in FIG. 40, if applying the AVC video stream (stream format type “0x1B”) defined by the ITU-T recommendation H.264|ISO/IEC 14496-10 video stream, in the place of the base-view sub-bit stream (main aspect) (stream format type “0x1b”) of the multi-aspect video encoded (example: H.264/MVC) stream, it is possible to obtain the similar effect.

Also, in the combination shown in FIG. 40, if applying the AVC video stream (stream format type “0x1B”) defined by the ITU-T recommendation H.262|ISO/IEC 13818-2 video stream, in the place of the base-view sub-bit stream (main aspect) of H.262 (MPEG 2) method of the case when transmitting the multi-aspects of 3D picture as a separate stream, it is possible to obtain the similar effect.

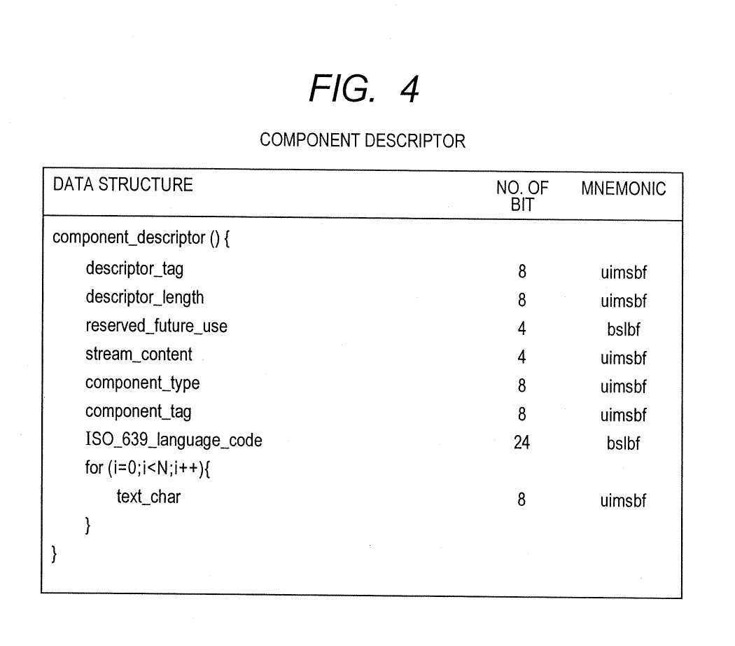

FIG. 4 shows an example of the structure of a component descriptor (Common Descriptor), one of the program information. The component descriptor indicates a type of component (elements for building up the program. For example, video, audio, character, various kinds of data, etc.), and it is also used for expressing an elementary stream in the form of characters. This descriptor is disposed in PMT and/or EIT.

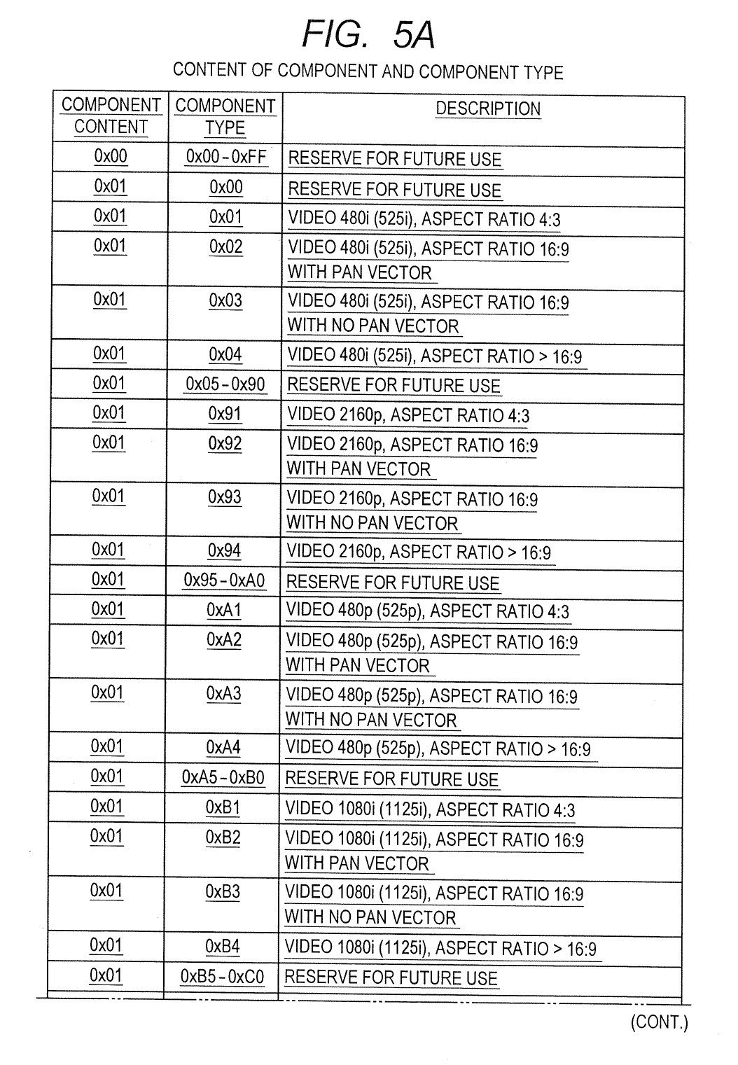

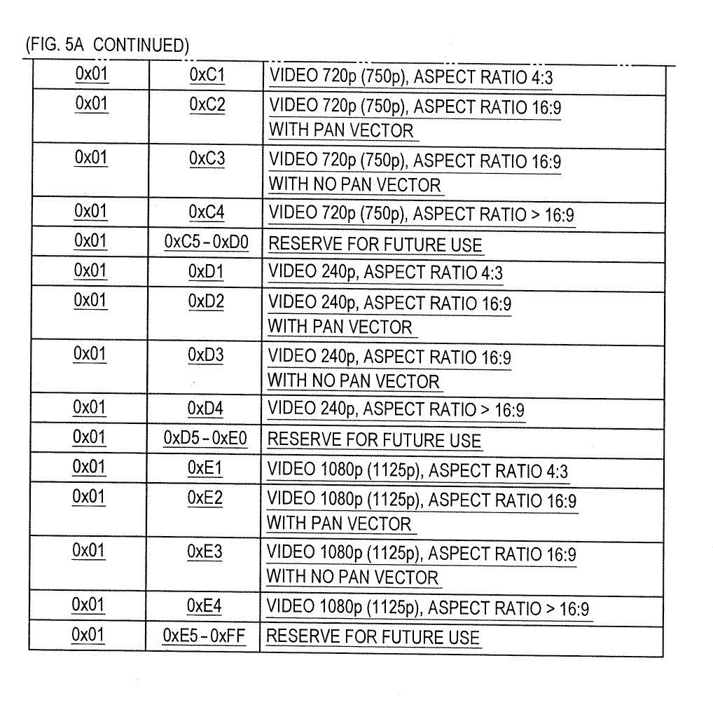

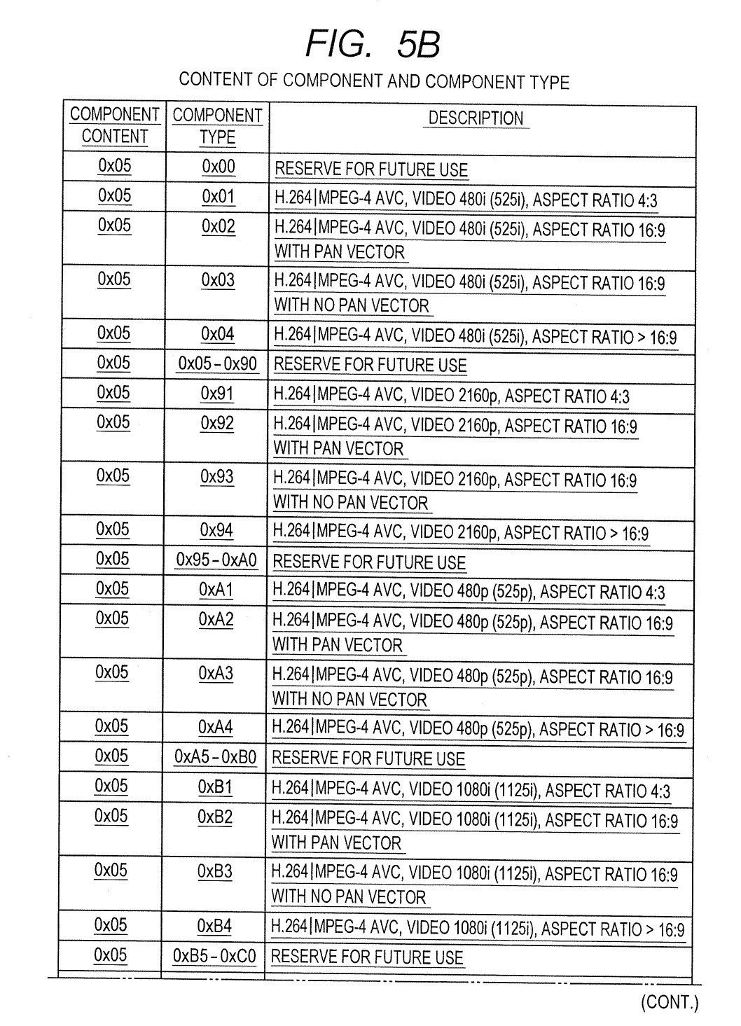

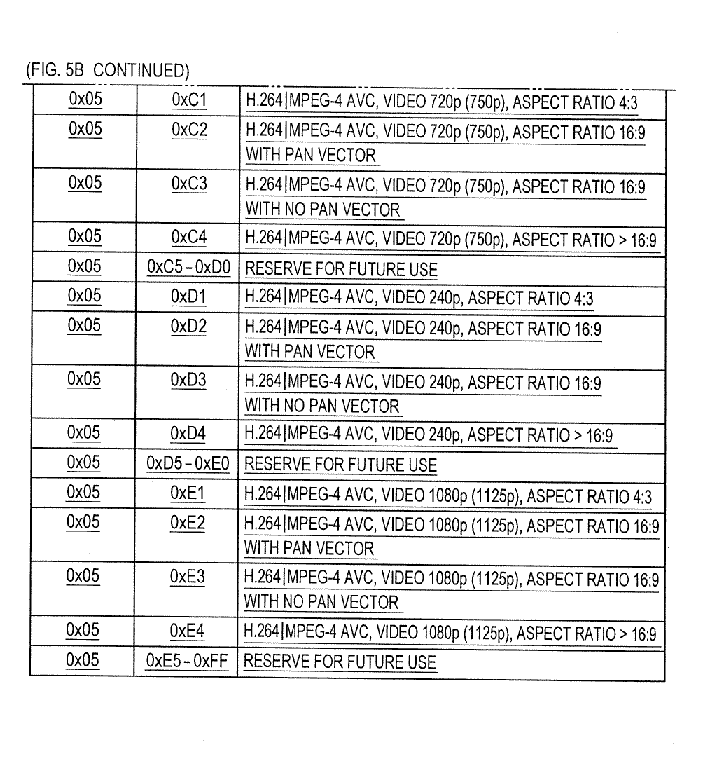

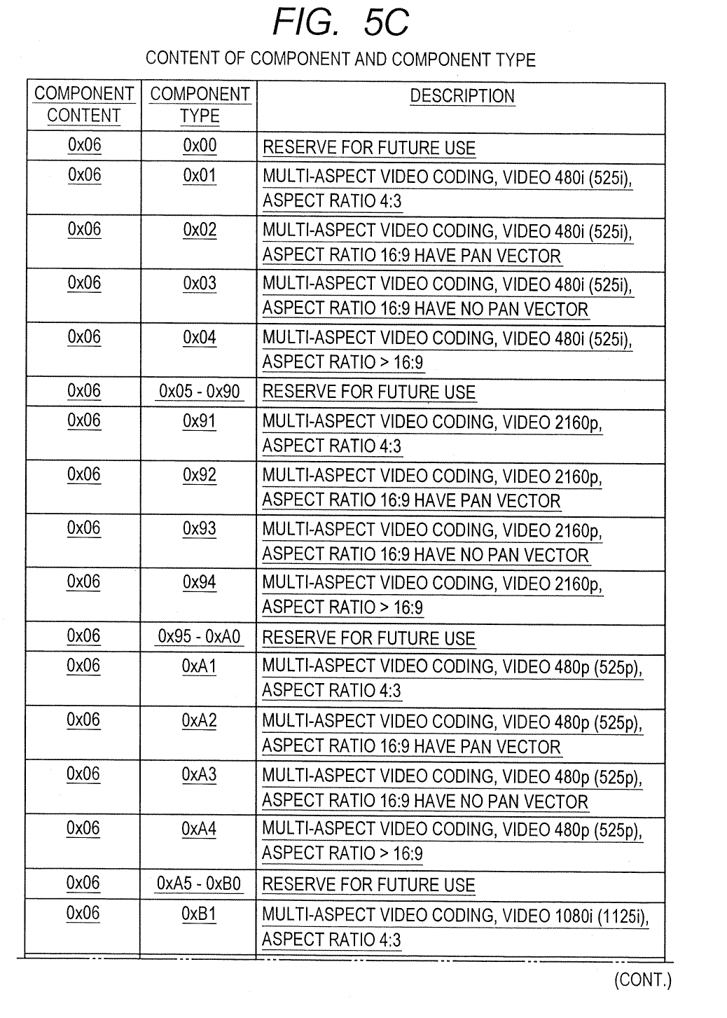

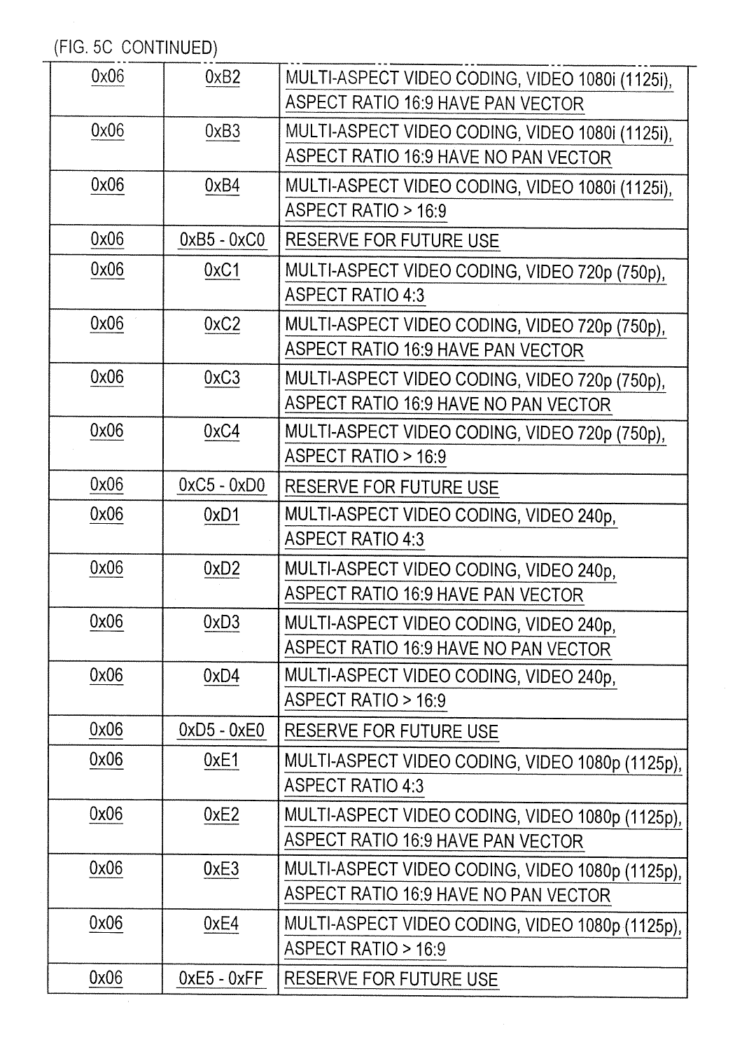

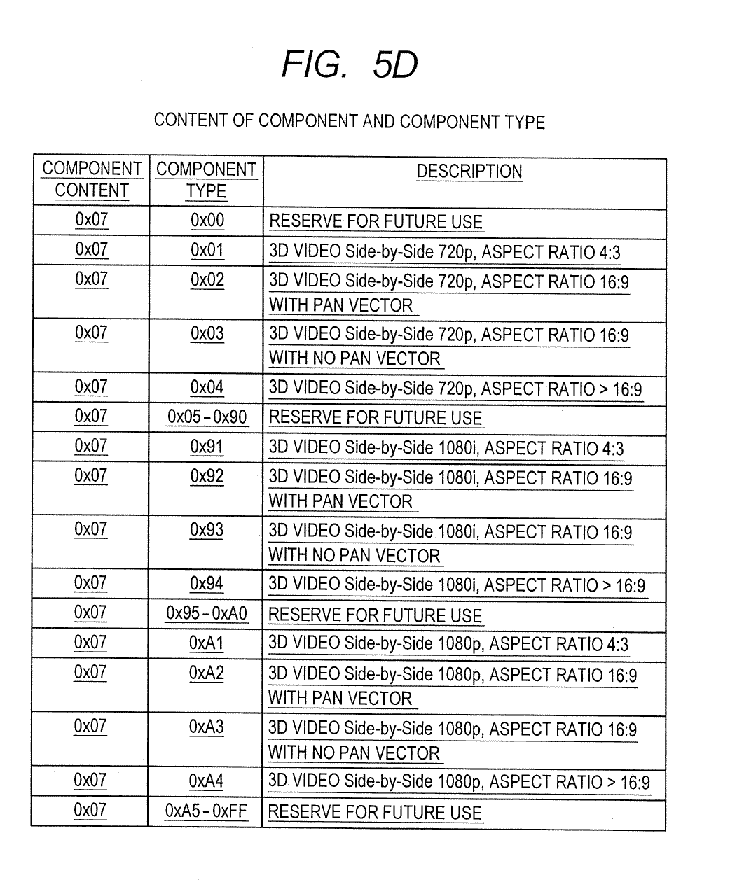

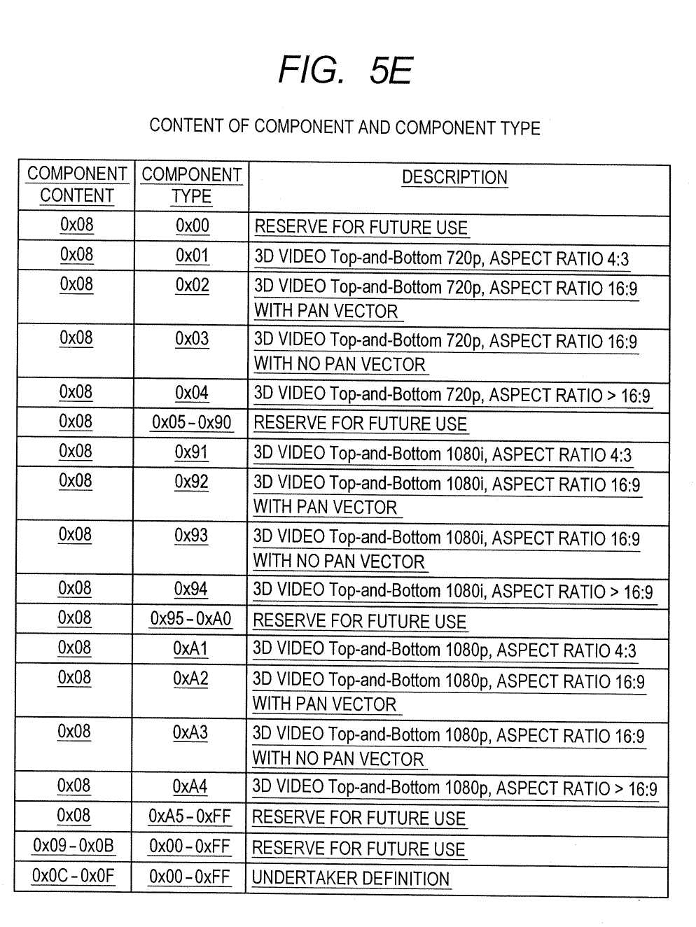

Meaning of the component descriptor is as follows. Thus, “descriptor_tag” is a field of 8 bits, describing a value therein, with which this descriptor can be discriminated to be a component descriptor. “descriptor_length” is also a field of 8 bits, describing a size of this descriptor therein. “stream_component” (contents of component) is a filed of 4 bits, presenting a type of the stream (video, audio, data), and it is encoded in the structure shown in FIG. 4. “component_type” (component type) is a field of 8 bits, defining the type or kind of the component, such as, video, audio or data, for example, and it is also encoded in the structure shown in FIG. 4. “component_tag” is a field of 8 bits. The component stream of service can refer to the described content (FIG. 5) indicated by the component descriptor, with using this 8 bits field.

In a program map section, a value of the component tag to be given to each stream should be different one. The component tag is a label for discriminating or identifying the component stream, having the same value to that of the component tag within a stream ID descriptor (but, when the stream ID descriptor is within PMT). A field of 24 bits of “ISO_{—}639_language code (language code) discriminates the language of component (audio or data), and also discriminates the language of characters described, which are included in this descriptor.

A language code is expressed by 3-character code, which is defined in ISO 639-2 (22). Each character is encoded by 8 bits, in accordance with ISO8859-1 (24), and is inserted into a field 24 bits, in that sequence. For example, Japanese language is “jpn” by 3 alphabetic characters, and is encoded as follows: “0110 1010 0111 0000 0110 1110”. “text_char” (component description) is a field of 8 bits. The field of a series of component description defines description of characters of the component stream.

FIGS. 5A to 5E show an example of “stream_content” (component content) and “component_type” (component type). “0x01” of the component content shown in FIG. 5A shows about various video methods of the video stream compressed by the MPEG 2 method.

“0x05” of the component content shown in FIG. 5B shows about various video methods of the video stream compressed by the H.264 AVC method. “0x06” of the component content shown in FIG. 5C shows about various video methods of the 3D video stream compressed by the multi-aspects video encoding (for example, H.264 MVC method).

“0x07” of the component content shown in FIG. 5D shows about various video methods of the stream of 3D video of “Side-by-Side” method, which compressed by the MPEG 2 or the H.264 AVC method. In this example, the same value is set to the component contents between the MPEG 2 and the H.264 AVC method, however different values may be set between the MPEG 2 and the H.264 AVC.

“0x07” of the component content shown in FIG. 5D shows about various video methods of the stream of 3D video of “Side-by-Side” method, which compressed by the MPEG 2 or the H.264 AVC method. In this example, the same value is set to the component contents between the MPEG 2 and the H.264 AVC method, however different values may be set between the MPEG 2 and the H.264 AVC.

“0x08” of the component content shown in FIG. 5E shows about various video methods of the stream of 3D video of “Top-and-Bottom” method, which compressed by the MPEG 2 or the H.264 AVC method. In this example, the same value is set to the component contents between the MPEG 2 and the H.264 AVC method, however different values may be set between the MPEG 2 and the H.264 AVC.

As is shown in FIG. 5D or 5E, by combining “stream_content” (component content), being a constituent element of the component descriptor, and “component_type” (component type), and thereby obtaining the structure indicating on whether it is the 3D video or not, and a combination of the method of 3D video, the resolution and aspect ratio, it is possible to transmit various kinds of video method information, including 2D program/3D program discrimination, with less amount or volume of transmission, even if it is a broadcast combining 3D and 2D.

In particular, when transmitting the 3D picture program including videos of plural numbers of aspects within one (1) picture of, such as, the “Side-by-Side” method or the “Top-and-Bottom” method, with using a coding method, such as, MPEG 2 and H.264 AVC (except for MVC), not the coding method, which is defined, originally, as the multi-aspect video coding method, it is difficult to discriminate or identify if the transmission is made by including the pictures of plural number of aspects within one picture for use of the 3D picture program, or is an ordinary picture of one (1) aspect, only with using “stream_type” (stream format type) mentioned above. Therefore, in this case, discrimination or identification of various video methods, including discrimination that the corresponding program is 2D program/3D program, may be made by the combination of “stream_content” (component content) and “component_type” (component type). Also, upon basis the fact that the component descriptor is distributed by EIT, relating to the program, which is broadcasted at present or will be broadcasted in future, EPG (program list) is produced by obtaining EIT in the receiving apparatus 4, and thereby it is possible to produce if it is the 3D picture or not, the method of the 3D picture, the resolution, the aspect ratio, as the information of EPG. The receiving apparatus has a merit of enabling to display (output) those information on EPG.

As was mentioned above, upon the fact that the receiving apparatus 4 can observe “stream_content” and “component_type”, there can be obtained an effect of enabling to recognize the program, which is received at present or will be received in future, to be the 3D program or not.

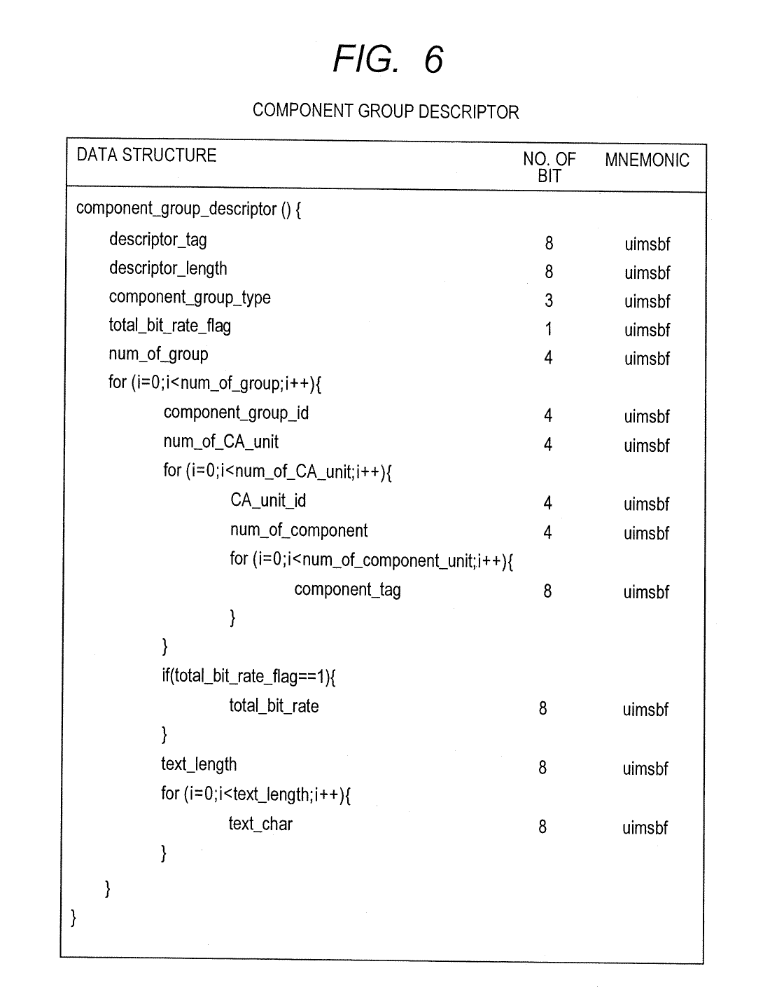

FIG. 6 shows an example of the structure of a component group descriptor (Component Group Descriptor), one of the program information. The component group descriptor defines the combination of components within an event, to be discriminated. Thus, there is described grouping information of plural numbers of components. This descriptor is disposed in EIT.

Meaning of the component group descriptor is as follows. Thus, “descriptor_tag” is a field of 8 bits, for describing a value therein, with which this descriptor can be discriminated to be the component group descriptor. “descriptor_length” is a field of 8 bits, for describing a size of this descriptor therein. “component_group_type” (component group type) is a field of 3 bits, for indicating a group type of the component.

Herein, “001” indicates 3DTV service, and it can be distinguished from a multi-view TV service of “000”. Herein, the multi-view TV service is a TV service for enabling to display the 2D pictures of plural numbers of aspects, switching them for each aspect thereof. For example, in the multi-aspect video encoded video stream, or in the stream of coding method, originally, not being the coding method, which is defined as the multi-aspect video coding method, there may be cases where the stream of the case when transmitting, including the pictures of plural numbers of aspects within one (1) picture, is applied, not only the 3D video program, but also a multi-view TV program. In this case, if the multi-aspects pictures are included in the stream, there are also cases where discrimination cannot be made on whether it is the 3D video program or the multi-view TV program, only by the “stream_type” (stream format type) mentioned above. In such cases, discrimination with using “component_group_type” (component group type) is effective. “total_bit_rate_flag” is a flag of one (1) bit, and this indicates a condition of describing a total bit rate within the component group in an event. When this bit is “0”, it indicates that the total bit rate field within the component group does not exist in that descriptor. When this bit is “1”, it indicates that the total bit rate field within the component group exists in that descriptor. “num_of_group” (group number) is a field of 4 bits, and this indicates a number of the component groups in the event.

“component_group_id” (component group indemnification) is a filed of 4 bits, describing the component group identification, in accordance with that shown in FIG. 8. “num_of_CA_unit” (accounting unit number) is a field of 4 bits, and this indicates a number of accounting/unaccounting units within the component group. “num_of_CA_id” (accounting unit identification) is a field of 4 bits, for describing the accounting unit identification therein, to which the component belongs, according to that shown in FIG. 9.

“num_of_component” (component number) is a field of 4 bit, and this indicates a number of the component (s), belonging to that component group and further to the accounting/unaccounting units indicated by “CA_unit_id” just before. “component_tag” (component tag) is a field of 8 bits, and this indicates a component tag value, belonging to the component group.

“total_bit_rate” (total bit rate) is a field of 8 bits, for describing the total bit rate of the components within the component group therein, raising a transmission rate of the transport stream packet to a unit per ¼ Mbps. “text_length” (component group description length) is a field of 8 bits, and this indicates the byte length of the component group description following thereto. “text_char” (component group description) is a field of 8 bits. In a series of character information fields, there are described the explanation relating to the component group.

As was mentioned above, the receiving apparatus 4 can observe “component_group_type”, and thereby obtaining an effect of enabling to recognize the program, which is received at present or will be received in future, is the 3D program.

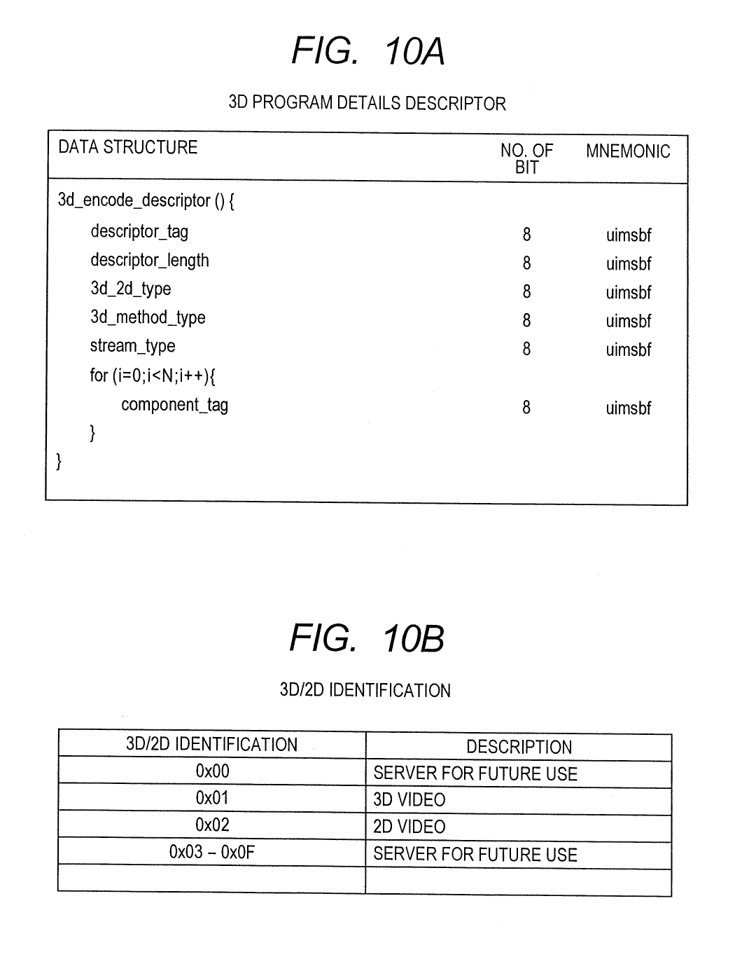

Next, explanation will be given on an example of using a new descriptor for indicating information relating to the 3D program. FIG. 10A shows an example of the structure of a 3D program details descriptor, as one of the broadcast information. The 3D program details descriptor shows detailed information when the program is the 3D program, and this is utilized for determination of the 3D program in the receiving apparatus. This descriptor is disposed in PMT and/or EIT. The 3D program details descriptor may be provided, in parallel with “stream_content” (component content) and “component_type” (component type) for use of the 3D video program shown in FIGS. 5C to 5E. However, with transmitting the 3D program details descriptor, there may be achieve the structure of not transmitting “stream_component” (component content) and “component_type” (component type) for use of the 3D video program. Meaning of the 3D program details descriptor is as follows. Next, “descriptor_tag” is a field of 8 bits, for describing a value (for example, “0xE1”) therein, with which this descriptor can be discriminated to be the 3D program details descriptor. “descriptor_length” is a field of 8 bits, for describing the length of this descriptor therein.

“3d_{—}2d_type” (3D/2D type) is a field of 8 bits, and this indicates type of 3D picture/2D picture in the 3D program. This field is 3D picture, for example, in a main component, and of the 3D program constructed with the 2D picture, in a commercial program inserted in the program on the way thereof, it is the information for identifying on whether it is the 3D picture or the 2D picture; i.e., it is disposed for the purpose of preventing a malfunction in the receiving apparatus (i.e., a problem of display (output) generated due to the fact that the broadcast program is the 2D picture, although the receiving apparatus is executing the 3D process). “0x01” indicates the 3D picture, and “0x02” indicates the 2D picture, respectively.

“3d_method_type” (3D method type) is a field of 8 bits, and this shows the method of 3D. “0x01” indicates ““3D 2-aspect separate ES transmission method”, “0x02” the Side-by-Side method, and“0x03” the Top-and-Bottom method, respectively. “stream_type” (stream format type) is a field of 8 bits, and this indicates a format of ES of the program, in accordance with that shown in FIG. 3 explained in the above.

However, it is also possible to apply the structure of transmitting the program descriptor when the program is of the 3D picture, but not when it is the 2D picture program. Upon only presence/absence of transmission of the 3D program details descriptor, it is possible to discriminate whether the corresponding program is the 2D video program or the 3D video program.

“component_tag” (component tag) is a field of 8 bits. The component stream of service is able, because of this 8 bits field, to refer the described content (see FIG. 5) indicated by the component descriptor. In the program map section, the value to be assigned to each stream should be a different value. The component tag is a label for identifying the component stream, and has a value same to that of the component tag within the stream identification descriptor (however, in case where the stream identification descriptor is within PMT).

As was mentioned above, the receiving apparatus 4 can observe the 3D program details descriptor, and if there is this descriptor, thereby obtaining an effect of enabling to recognize the program, which is received at present or will be received in future, is the 3D program. In addition thereto, in case where the program is the 3D program, it is possible to identify or discriminate the type of the 3D transmission method, and if the 3D picture and the 2D picture are mixed with, it is possible to discriminate the type thereof.

Next, explanation will be given on an example of identifying or discriminating to be the 3D picture or the 2D picture by a unit of the service (composition channel). FIG. 12 shows an example of the structure of the service descriptor (Service Descriptor), as one of the program information. The service descriptor indicates a composition channel name and a name of undertaker thereof by character code, together with a service form type. This descriptor is disposed in SDT.

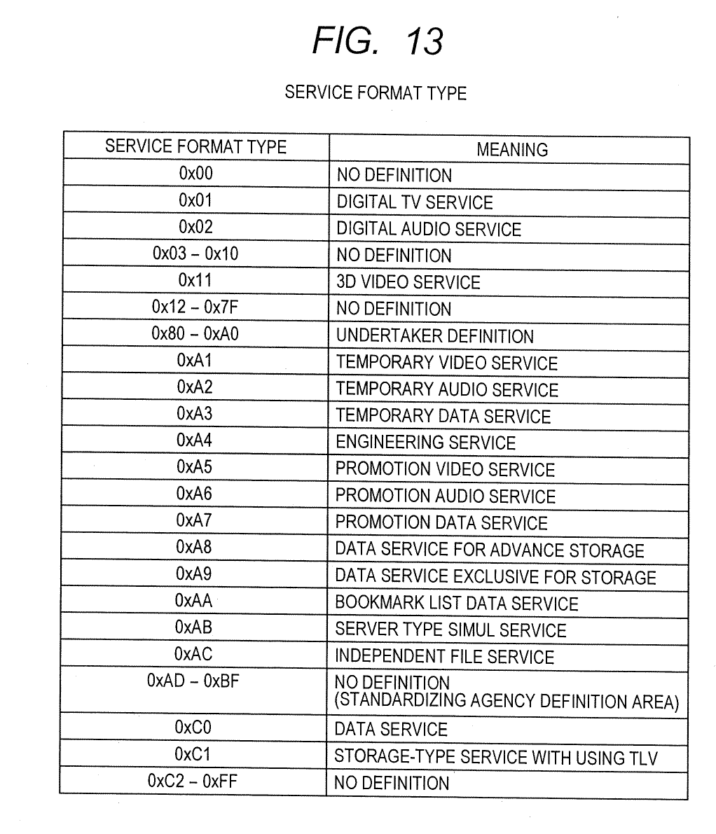

Meaning of the service descriptor is as follows. Thus, “service_type” (service form type) is a field of 8 bits, and this shows a kind of the service, in accordance with that shown in FIG. 13. “0x01” indicates the 3D video service. A field of 8 bits of “service_provider_name_length” (undertaker name length) indicates a byte length of the undertaker's name following thereto. “char” (character code) is a field of 8 bits. A series of character information fields indicates a undertaker name or a service name. A field of 8 bits of “service_name_length” (service name length) indicates a byte length of the service name following thereto.

As was mentioned above, the receiving apparatus 4 can observe “service_type”, and thereby obtaining an effect of enabling to recognize that the service (the composition channel) is the channel of 3D program. In this manner, if it is possible to discriminate the service (the composition channel) is the 3D video service or the 2D video service, on the EPG display can be made such a display indicating that the corresponding service is the 3D video program broadcast service. However, in spite of the service mainly broadcasting the 3D video program, there may be a case where the 2D picture must be broadcasted, where a source of the advertising video is only the 2D video, for example. Accordingly, in discrimination of the 3D video service with using “service_type” of that service descriptor, it is preferable to execute the discrimination of the 3D video program in combination with “stream_content” (component content) and “component_type” (component type), as was mentioned previously, the discrimination of the 3D vido program with using “component_group_type” (component group type), or in combination with the discrimination of the 3D video program by means of the 3D program details descriptor. When executing the discrimination by combining plural numbers of information, it is possible to discriminate that, although being the 3D video broadcast service, it is the 2D picture in a part of the programs, etc. If such discrimination can be made, the receiving apparatus is able to indicates that the corresponding service is “3D video broadcast service”, clearly, on EPG, for example, and further, if the 2D video program is mixed with, it is possible to exchange a display control, etc., between the 3D video program and the 2D video program, depending on necessity thereof, when receiving the program and so on.

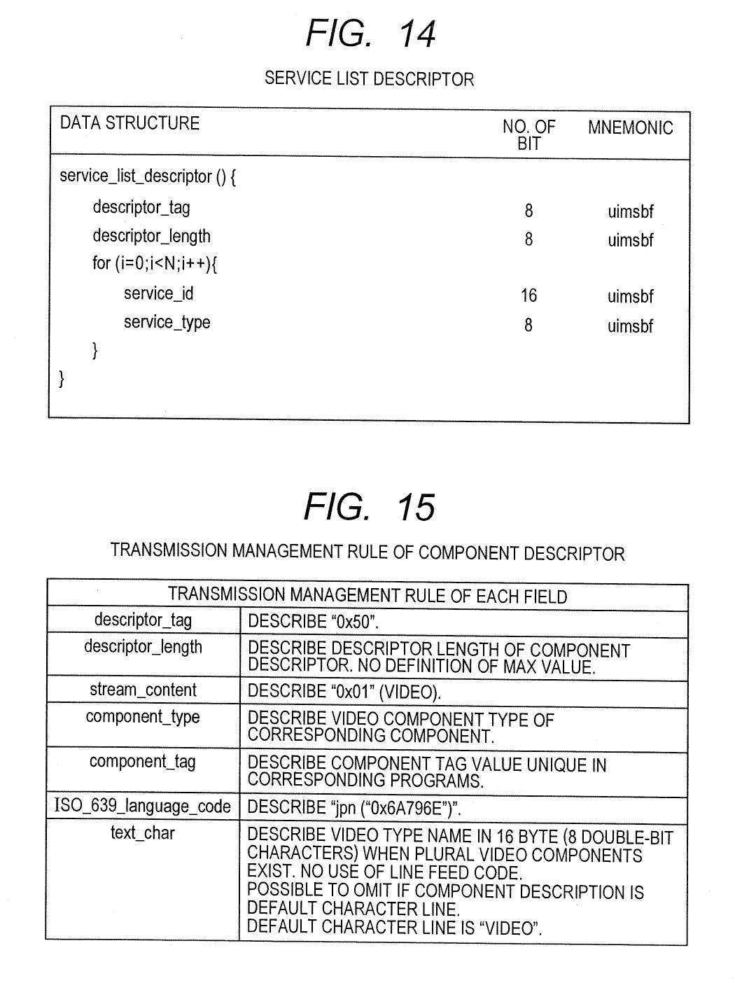

FIG. 14 shows an example of the structure of a service list descriptor (Service List Descriptor), as one of the program information. The service list descriptor provides service identification and a list of services according to the service types. Thus, it describes the composition channel and a list of that type. This descriptor is disposed in NIT.

Meaning of the service descriptor is as follows. Thus, “service_id” (service identification) is a field of 16 bits, for identifying the information service in that transport stream, uniquely. The service identification is equal to the broadcast program number identification (“program_number”) in the program map section corresponding thereto. “service_type” (service form type) is a field of 8 bits, and this indicates the type of the service, in accordance with that shown in FIG. 12.

With those “service_type” (service form type), since it is possible to discriminate to be “3D video broadcast service” or not, therefore, for example, with using the list of the composition channel and the type thereof, which are shown in that service list descriptor, it is possible to execute such a display of grouping only “3D video broadcast service” on the EPG display, etc.

As was mentioned above, the receiving apparatus 4 can observe “service_type”, and thereby obtains an effect of enabling to recognize that the composition channel is the channel of the 3D program.

The examples of the descriptors, which are explained in the above, describe only the representative members thereof, but it can be also considered to combine plural numbers of the members into one (1), or divide one of the members into plural numbers of members, each having detailed information, and so on.

### <Example of Transmission Management Rule of Program Information>

The component descriptor, the component group descriptor, the 3D program details descriptor, the service descriptor and the service list descriptor of the program information, which are explained in the above, are information, which are transmitted from a transmitting apparatus 1, being produced and added in a management information assigning unit 16, and being stored in PSI of MPEG-TS (as an example, PMT, etc.) or in SI (as an example, EIT or SDT or NIT, etc.)

Hereinafter, explanation will be given on an example of a transmission management rule or regulation in the transmitting apparatus 1 of the program information.

FIG. 15 shows an example of the transmission management rule of the component descriptors in the transmitting apparatus 1. In “descriptor_tag” is described “0x50” that means it is a component descriptor. In “descriptor_length” is described a descriptor length of the component descriptor. The maximum value of the descriptor length is not defined. In “stream_content” is described “0x01” (video).

In “component_type” is described the video component type of the corresponding component. The component type is determined from those shown in FIG. 5. In “component_tag” is described a component tag value to be unique within the corresponding program. In “ISO_{—}639_language_code” is described “jpn” (“0x6A706D”).

In “text_char” is described 16 byte (8 double-byte characters) or less than that, as a name of the video type, when there are plural numbers of video components. No line feed (or, return) code is used. In case where description of the component is a character line of default, this filed can be omitted. The default character line is “video”.

However, one (1) is necessarily transmitted, for all the video components having “component_tag” value of “0x00-0x0F”, included in an event (program).

With managing in the transmitting apparatus 1 in this manner, the receiving apparatus 4 can observe “stream_component” and “component_type”, and thereby obtains an effect of enabling to recognize that the program, which is received at present or will be received in future, is the 3D program.

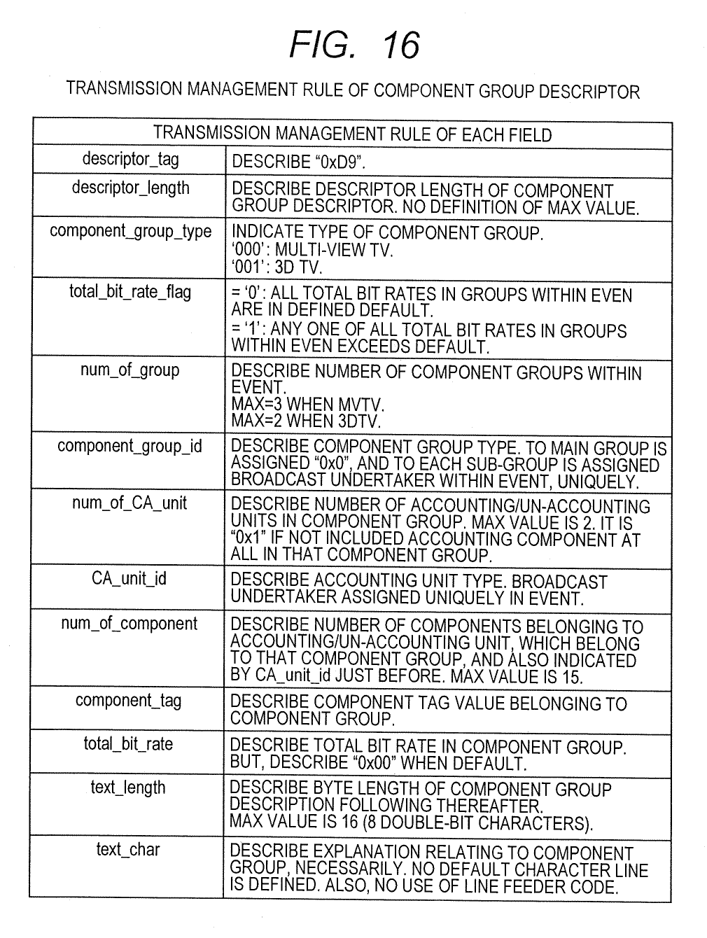

FIG. 16 shows an example of the transmission management rule in the transmitting apparatus 1 of the component group descriptor.

In “descriptor_tag” is described “0xD9” meaning that it is the component group descriptor. In “descriptor_length” is described the descriptor length of the component group descriptor. The maximum length of the descriptor is not defined. “component_group_type” indicates the type of the component group. “000” indicates a multi-view TV, and “001” indicates a 3D TV, respectively.

In “total_bit_rate_flag” is indicated “0” when all the total bit rates in the group within the event is at a predetermined default value, or “1” when any one of the total bit rates in the group within the event exceeds the predetermined default value.

In “num_of_grou” is described a number of the component groups within the event. It is assumed to be “3” at the maximum in case of the multi-view TV (MVTV), and “2” at the maximum in case of the 3D TV (3DTV).

In “component_group_id” is described a component group identification. “0x0” is assigned in case of a main group, and the broadcast undertaker is assigned, uniquely, within the event, in case of each sub-group.

In “num_of_CA_unit” is described a number of accounting/unaccounting units in the component group. The maximum number is assumed to be “2”. It is “0x1”, when there is no component included, on which accounting should be taken, at all, within the corresponding component group.

In “CA_unit_id” is described the accounting unit identification. To this is assigned the broadcast undertake, uniquely, within the event. In “num_of_component” is described a number of the components belonging to the corresponding accounting/unaccounting units and further shown by “CA_unit_id” just before. The maximum number is assumed to be “15”.

In “component_tag” is described a component tag value belonging to the component group. In “total_bit_rate” is described a total bit rate within the component group. However, “0x00” is described in case of a default value.

In “text_length” is described a byte length of description of the component group following thereafter. The maximum value is assumed to be “16” (8 double-byte characters). In “text_char” is described an explanation relating the component group, necessarily. No default character line is defined. Also, no line feed (or, return) code is used.

However, when executing the multi-view TV service, “component_group_type” is transmitted as “000”, necessarily. Also, when executing the 3D TV service, “component_group_type” is transmitted as “001”, necessarily.

With doing the transmission management in the transmitting apparatus 1, the receiving apparatus 4 can observe “component_group_type”, and thereby obtains an effect of enabling to recognize that the program, which is received at present or will be received in future, is the 3D program.

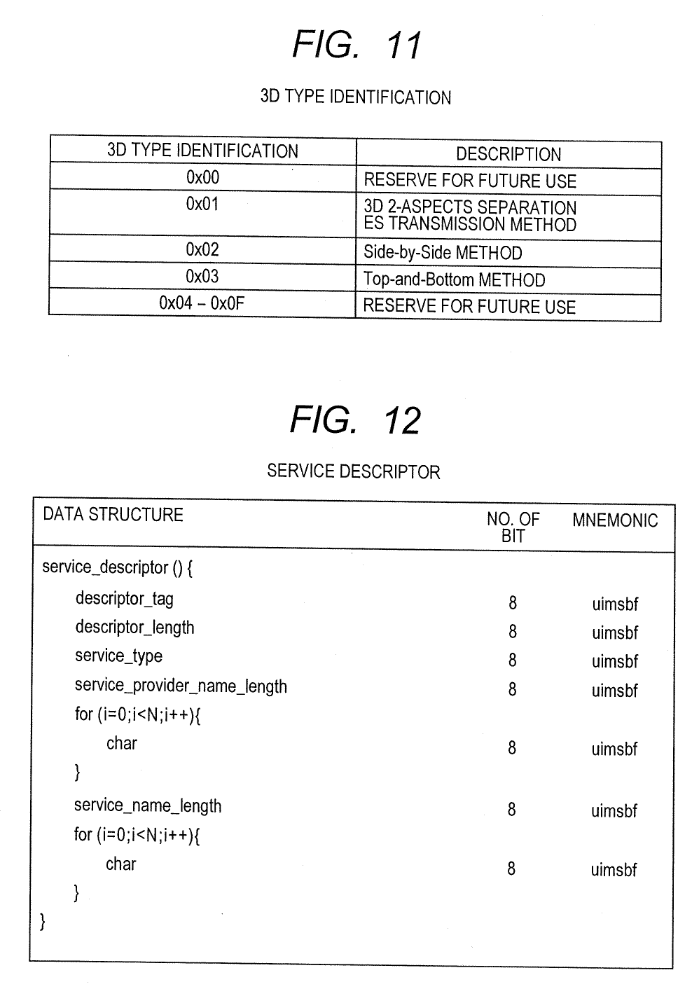

FIG. 17 shows an example of the transmission management rule in the transmitting apparatus 1 of the 3D program details descriptor. In “descriptor_tag” is described “0xE1” meaning that it is the 3D program details descriptor. In “descriptor_length” is described a descriptor length of the 3D program details descriptor. In “3d_{—}2d_type” is described 3D/2D selection. It is selected from those shown in FIG. 10B. In “3d method type” is described the 3D method identification. This is determined from those shown in FIG. 11. In “stream_type” is described the format of ES of a program. This is determined from those shown in FIG. 3. In “component_tag” is described a component tag value, to be unique within the corresponding programs.

With executing the transmission management in the transmitting apparatus, the receiving apparatus 4 can observe the 3D program details descriptor, and thereby, if there is this descriptor, obtaining an effect of enabling to recognize that the program, which is received at present or will be received in future, is the 3D program.

FIG. 18 shows an example of the transmission management rule in the transmitting apparatus 1 of the service descriptor. In “descriptor_tag” is described “0x48” meaning that it is the service descriptor. In “descriptor_length” is described a descriptor length of the service descriptor. In “service_type” is described a type of the service.

The service type is determined from those shown in FIG. 13. In “service_provider_name_length” is described the undertaker's name incase of the BS/CS digital television broadcast. The maximum value is assumed to be “20”. Since no “service_provider_name_length” is managed in case of the BS/CS digital television broadcast, “0x00” is described therein.

In “char” is described the undertaker's name in case of the BS/CS digital television broadcast, in 10 double-byte characters. Nothing is described in case of the terrestrial digital television broadcast. In “service_name_length” is described the composite channel name length. The maximum value is assumed to be “20”. In “char” is described the composite channel name. It is within 20 bytes and within 10 double-byte characters. However, for each target composite channel, only one (1) is disposed, necessarily.

With doing the transmission management in the transmitting apparatus 1, the receiving apparatus 4 can observe “service_type”, and thereby obtains an effect of enabling to recognize that the composite channel is the 3D program channel.

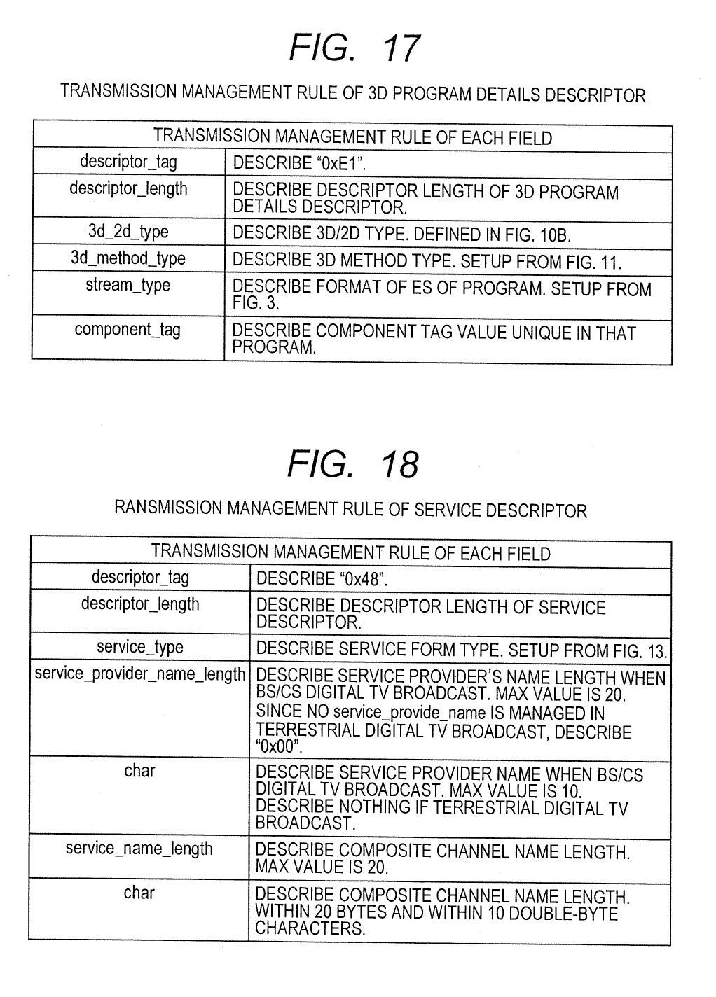

FIG. 19 shows an example of the transmission management rule in the transmitting apparatus 1 of the service list descriptor. In “descriptor_tag” is described “0x41” meaning that it is the service list descriptor. In “descriptor_length” is described a descriptor length of the service list descriptor. In “loop” are described loop(s) of the number of service(s), which are included in the target transport stream.

In “service_id” is described “service_id” included in that transport stream. In “service_type” is described the service type of the target service. It is determined from those shown in FIG. 13. However, it is disposed in NIT, necessarily for TS loop.

With doing the transmission management in the transmitting apparatus 1, the receiving apparatus 4 can observe “service_type”, and thereby obtains an effect of enabling to recognize that the composite channel is the 3D program channel.

In the above, although the explanation was given on an example of transmission of the program information within the transmitting apparatus 1; however, if executing the transmission, by inserting indication, “3D program will start from now”, “please ware glasses for 3D viewing when enjoying 3D display”, “2D display is recommended when viewer's eyes are tired or body condition is bad” or “viewing 3D programs for long time may bring about fatigue of eyes or bad condition of body”, etc., into the 3D program produced by the transmitting apparatus 1, with using a telop (subtitle), etc., on a first screen when the 3D program starts, in particular, when the program is changed from the 2D program to the 3D program, then there can be a merit that attention/alarming against viewing of the 3D program can be given to the user viewing the 3D program, on the receiving apparatus 4.

### <Hardware Structure of Receiving Apparatus>

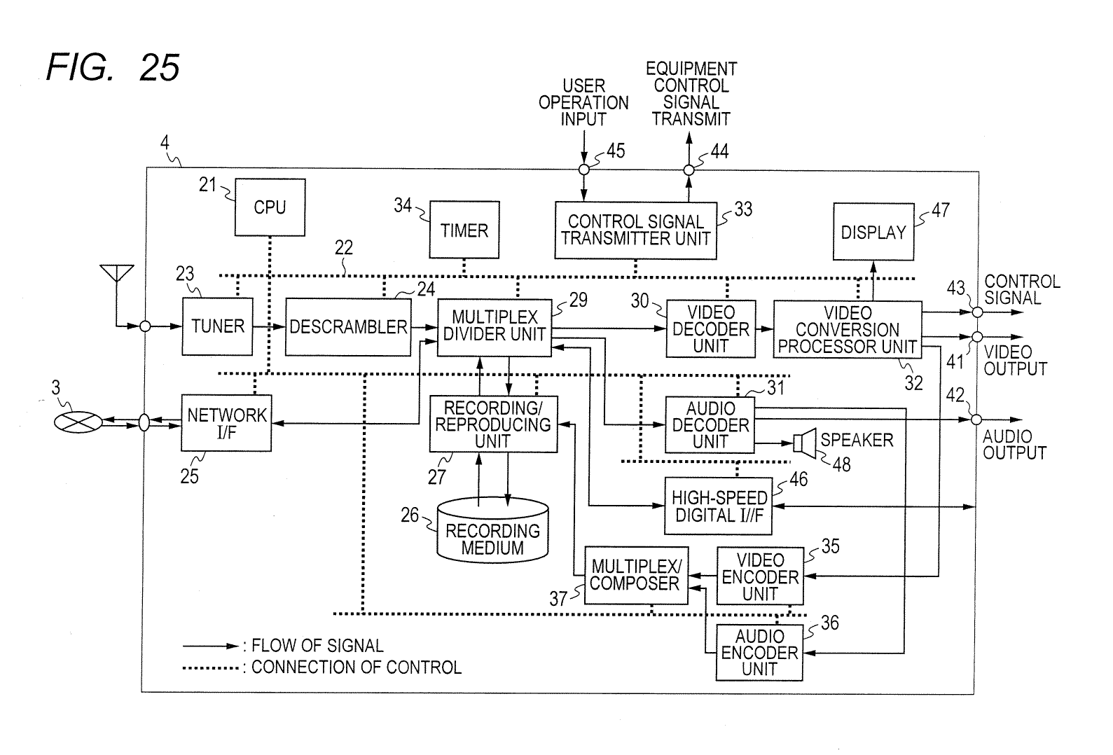

FIG. 25 is hardware structure view for showing an example of the structure of the receiving apparatus 4, in the system shown in FIG. 1. A reference numeral 21 depicts a CPU (Central Processing Unit) for controlling the entire of the receiver, 22 a common bus for transmitting control and information between the CPU 21 and each unit within the receiving apparatus, 23 a tuner for receiving broadcast signals transmitted from the transmitting apparatus 1 through broadcast transmission network, such as, radio-wave (satellite, terrestrial), cable, etc., and executing a tuning into a specific frequency, a demodulation, an error correction process, etc., thereon, thereby outputting a multiplexed packet of MPEG2-Transport Stream (hereinafter, may be called “TS”), etc., 24 a descrambler for decoding scramble made by the scramble unit 13, 25 a network I/F (Interface) for receiving/transmitting information between the network and for receiving/transmitting various kinds of information and MPEG2-TS between the Internet and the receiving apparatus, 26 a recording medium, a HDD (Hard Disk Drive) and/or a flash memory, which is/are received within the receiving apparatus 4, or a removable HDD, disc-type recording medium or flash memory, etc., 27 a recording/reproducing unit for controlling the recoding medium 26, thereby controlling recording of signals to the recoding medium 26 and reproduction of signals from the recording medium 26, and 29 a multiplex divider unit for dividing or separating the signals multiplexed into the format, such as, MPEG2-TS, etc., into signals, such as, video ES (Elementary Stream), audio ES and program information, etc., respectively. A reference numeral 30 depicts a video decoder unit for decoding the video ES to video signals, 31 an audio decoder unit for decoding the audio ES to audio signals, thereby outputting to a speaker 48 or output from an audio output 42, 32 a video conversion processor unit for executing a process of converting the video signal decoded in the video decoder unit 30 into a predestined format in accordance with an instruction from the CPU mentioned above, a process of superimposing a display, such as, OSD (On Screen Display) produced by the CPU 21, etc., on the video signal, or 2D/3D conversion, which will be mentioned later, thereby outputting the video signal after processing to a display 47 or a video signal output portion 41 or a video encoder unit 35, and outputting a sync signal corresponding to the format of the video signal after processing and a control signal (to be used for equipment control) from the video signal output portion 41 and a control signal output unit 43, 33 a control signal receiving/transmitting unit for receiving an operation input from a user operation input portion 45 (for example, a key code from a remote controller generating an IR (Infrared Radiation) signal) or for transmitting an equipment control signal (for example, IR) to external equipment, which is produced by the CPU 21 or the video conversion processor unit 32, from an equipment control signal transmitter unit 44, 34 a timer having a counter in an inside thereof, and for keeping the present time, 35 a video encoder unit for encoding the video inputted signal to the video ES, 36 an audio encoder unit for encoding the inputted audio signal to the audio ES, 37 a multiplex/composer unit for multiplexing the video ES, audio ES and program information, which are inputted, into a format, such as, MPEG2-TS, etc., 46 a serial interface for executing necessary processes, such as, encoding, etc., upon TS reconstructed in the multiplexer unit mentioned above, thereby outputting TS an outside, or for decoding TS received from the outside, thereby inputting to the multiplex divider unit 29, 47 a display for displaying thereon the 3D video and the 2D video, which are decoded by the video decoder unit 30 and converted to the pictures thereof by the video conversion processor unit 32, and 48 a speaker for outputting sound upon basis of the audio signal, which is decoded in the audio decoder unit, respectively, and wherein, the receiving apparatus is mainly constructed with those devices mentioned above. When displaying 3D on the display, the sync signal and/or the control signal can be outputted from the control signal output unit 43 and/or the equipment control signal transmitter unit 44, if necessary.

In the figure, a flow of signal connecting each block is shown like a single signal path, as an outlook thereof; however, there are cases where plural numbers of signals are transmitted/received, simultaneously, due to time-divided multiplexing, connecting via the multiple line, or the like. For example, between the multiplex divider unit 29 and the video decoder unit 30, plural numbers of video signals can be transmitted, at the same time; therefore it is also possible to execute the processes of, such as, decoding plural numbers of video ES in the video decoder unit, 2-screen display of the picture, and simultaneous decoding for recoding and viewing, etc.

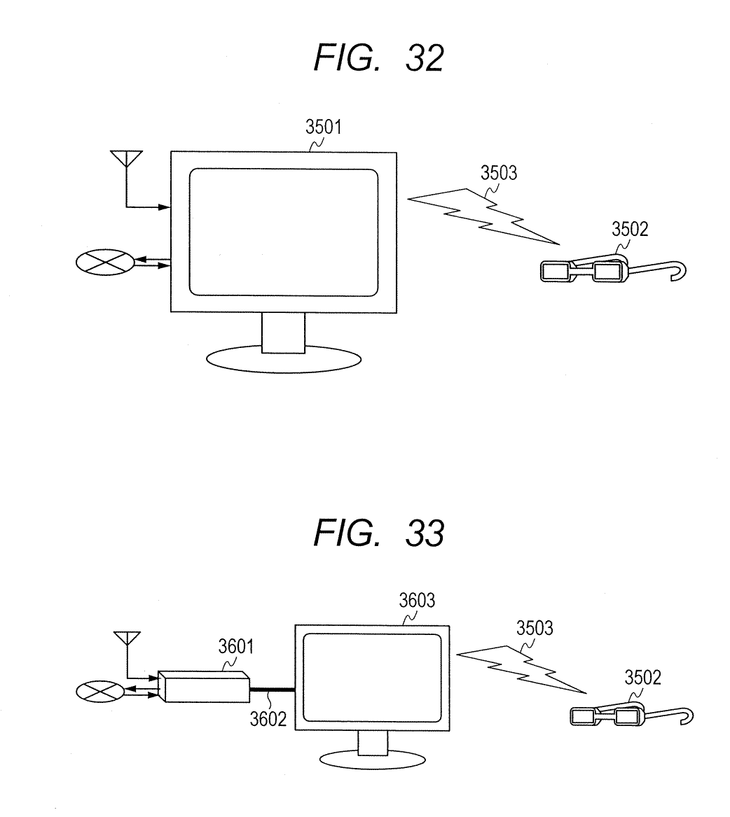

System structures or configuration including the receiving apparatus and a viewing/listening apparatus and a 3D view assisting or supporting device (for example, 3D glasses) will be shown in FIGS. 32 and 33. Examples are shown in FIG. 32 and in FIG. 33. FIG. 32 shows the system configuration where the receiving apparatus and the viewing/listening apparatus are combined as a unit and FIG. 33 shows an example when the receiving apparatus and the viewing/listening apparatus are separated in the structures thereof.

In FIG. 32, a reference numeral 3501 depicts a display device, including the structures of the above-mentioned receiving apparatus 4 therein, thereby enabling the 3D video display and the audio output, 3503 a 3D view supporting device control signal (for example, IR signal) outputted from the display device 3501 mentioned above, and 3502 the 3D view supporting device, respectively. In the example shown in FIG. 32, the video signal is displayed on a video display, which is equipped on the display device, and the audio signal is outputted from a speaker (s) equipped on the display device 3501. Also, in the similar manner, the display device 3501 has output terminals for outputting the 3D view supporting device control signal from an output portion of the equipment control signal 44 or the control signal 43.

However, the explanation mentioned above was given to the example, upon an assumption that the display device 3501 and the 3D view supporting device 3502 shown in FIG. 32 obtain the display through an active shutter method, which will be mentioned later; however, in case where the display device 3501 and the 3D view supporting device 3502 shown in FIG. 32 are of the method for executing the 3D video display through the polarizing division, which will be mentioned later, the 3D view supporting device 3502 may be a one of brining about such polarizing division that different videos enter into the left-side eye and the right-side eye, but it does not matter if not outputting the 3D view supporting device control signal 3503 from the display device 3501, to be outputted from the output portion of the equipment control signal 44 or the control signal 43.

Also in FIG. 33, a reference numeral depicts a video/audio output apparatus including the structures of the receiving apparatus 4 therein, 3602 a transmission path for transmitting video/audio/control signals (for example, HDMI cable), and 3603 a display for displaying/outputting the video signal and the audio signal inputted from an outside.

In this case, the video signal outputted from the video output 41 of the video/audio output apparatus 3601 (the receiving apparatus 4) and audio signal outputted from the audio output 42, and the control signal outputted from the control signal output unit 43 are converted into a transmission signal of format, which is suitable to the format defined on the transmission path 3602 (for example, the format defined by HDMI regulation), and inputted to the display 3603, passing through the transmission path 3602. The display 3603 receives that transmission signal thereon decodes it into the original video signal, audio signal and the control signal, and thereby outputting the 3D view supporting device control signal 3503 to the 3D view supporting device 3502, as well as, outputting the video and audio.

However, the explanation mentioned above was given to the example, upon an assumption that the display device 3601 and the 3D view supporting device 3602 shown in FIG. 33 obtain the display through the active shutter method, which will be mentioned later; however, in case where the display device 3601 and the 3D view supporting device 3602 shown in FIG. 33 are of the method for executing the 3D video display through the polarizing division, which will be mentioned later, the 3D view supporting device 3502 may be a one of brining about such polarizing division that different videos enter into the left-side eye and the right-side eye, but it does not matter if not outputting the 3D view supporting device control signal 3603 from the display device 3601.

However, a part of each of the constituent elements of 21-46 shown in FIG. 25 may be constructed by one (1) or plural numbers of LSI(s). Also, the function of apart of each of the constituent elements of 21-46 shown in FIG. 25 may be achieved by software.

### <Function Block Diagram of Receiving Apparatus>

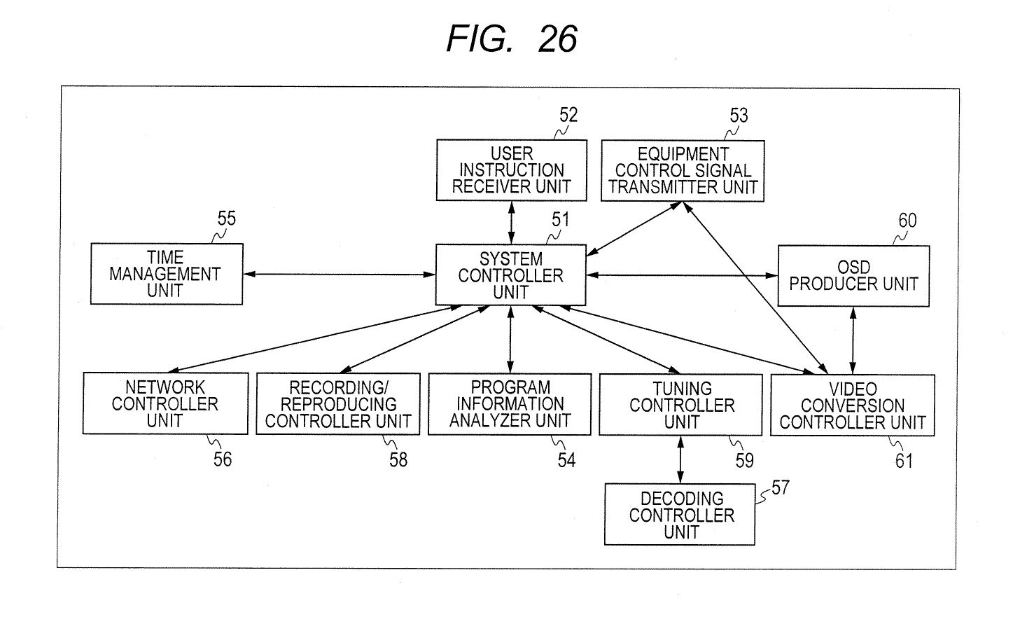

FIG. 26 shows an example of function block diagram of the processes executed within an inside of the CPU 21. Herein, each function block exists as a module of software, which is executed by the CPU 21, for example, and wherein information and data are delivered between the modules with using any means (for example, message passing, function call, event transmission); thereby achieving delivery of the information and the data and also indication of the control.

Also, each module, as well as, each of hardware inside the receiving apparatus 4, executes communication of the information, through the common bus 22. Also, relation lines (i.e., arrows) described in the figures are shown, mainly, on the portions relating to the explanation given presently; however, also between other modules, there are processes, which needs the communication means and the communication. For example, the tuning controller unit 50 obtains the necessary program information from the program information analyzer unit 54, appropriately.

Next, explanation will be given on the function of each function block. A system controller unit 51 manages the condition of each module and an indication condition of the user, etc., and also indicates the control to each module. A user instructor receiver unit 52, receiving and interpreting an input signal of a user operation, which is received by a control signal transmitter/receiver 33, informs or transmits the instruction user to the system controller unit 51. An equipment control signal transmitter unit 53, in accordance with an instruction(s) from the system controller unit 51 and/or other module(s), gives an instruction to the control signal transmitter/receiver 33 to transmit the equipment control signal.

The program information analyzer unit 54 obtains the program information from the multiplex divider unit 29, to analyze the content thereof, and provides necessary information to each module. A time management unit 55 obtains time correction information (TOT: Time offset table) included in TS, from the program information analyzer unit 54, and thereby managing the present time, and at the same time, it gives a notice of alarm (a notice of reaching to the time designated) or one-shot timer (a notice of passage of a predetermined time-period), in accordance with a request of each module.

A network controller unit 56 controls the network I/F 25, so as to obtain various kinds of information and TS from a specific URL (Unique Resource Locater) and/or a specific IP (Internet Protocol) address. A decode controller unit 57 controls the video decoder unit 30 and the audio decoder unit 31, i.e., instructing start and stop of decoding, and obtaining information included in the stream, etc.

A recording/reproducing controller unit 58 controls the recording/reproducing unit 27, and thereby reading out the signal from the recoding medium 26, from a specific position of a specific content, in arbitrary format of read-out (ordinary, reproduction, fast-forward, rewinding, pause). Also, it executes control of recording the signal inputted into the recording/reproducing unit 27 to the recording medium.

A tuning controller unit 59 controls the tuner 23, the descrambler 24, the multiplex divider unit 29 and the decoding controller unit 57, and thereby receiving the broadcast signal and recording of the broadcast signal. Or, it executes reproduction from the recording medium, and it also executes controls outputting the video signal and the audio signal therefrom. About details of operations of broadcast receiving and recoding operations of the broadcast signal, and reproducing operations from the recording medium, they will be mentioned later.

An OSD producer unit 60 produces OSD data, including a specific message therein, and gives an instruction to a video conversion controller unit 61 to superimpose the OSD data produced on the video signal. Herein, the OSD producer unit 60 produces OSD data having parallax, such as, for the left-side eye and for the right-side eye, and requests the video conversion controller unit 61 to make the 3D display upon basis of the OSD data for the left-side eye and for the right-side eye, and thereby achieving a message display in 3D.

The video conversion controller unit 61 controls the video conversion processor unit 32, so as to superimpose the video obtained by converting the video signal inputted in the video conversion processor unit 32 into 3D or 2D, in accordance with an instruction from the system controller unit 51 mentioned above, and the OSD inputted from the OSD producer unit 60, and further execute processing on the video (scaling or PinP, or 3D display, etc.), or 2D/3D conversion, depending on necessity thereof, and thereby displaying it on the display 47 or outputting it to an outside. Details of methods of conversion of the 3D video or the 2D video into the predetermined format and the 2D/3D conversion within the video conversion processor unit 32 will be mentioned later. Each function block provides such function of those.

### <Broadcast Receiving>

Herein, explanation will be given on controlling steps and flows of the signals when executing broadcast receiving. First of all, the system controller unit 51, receiving an instruction of the user (for example, pushing down the CH button on the remote controller), indicating to receive the broadcast of a specific channel (CH), from the user instructor receiver unit 52, instructs the tuning controller unit 59 to execute tuning into CH instructed by the user (hereinafter, “designated CH”).

The tuning controller unit 59 receiving the instruction mentioned above gives an instruction of receiving control at the designated CH (tuning into a designated frequency band, demodulation process of the broadcast signal, error correction process), to the tuner 23, and thereby driving it to output TS to the descrambler 24.

Next, the tuning controller unit 59 instructs the descrambler 24, to descramble the TS and to output it to the multiplex divider unit 29, and instructs the multiplex divider unit 29, to divide inputted TS from multiplexing, and also to output the video ES divided from multiplexing to the video decoding unit 30 and the audio ES to the audio decoder unit 31.

Also, the tuning controller unit 59 instructs the decoding controller unit 57 to decode the video ES and the audio ES, which are inputted into video decoder unit 30 and the audio decoder unit 31. The decoding controller unit 57 receiving the decoding instruction mentioned above controls the video decoder unit 30 to output the video signal decoded to the video conversion processor unit 32, while controls the audio decoder 31 to output the audio signal decoded to the speaker 48 or the audio output 421. In this manner, control for outputting the video and the audio of CH designated by the user is carried out.

Also, for displaying a CH banner (OSD for showing CH number or the program name, or the program information, etc.) when tuning, the system controller unit 51 instructs the OSD producer unit 60 to produce and output the CH banner. The OSD producer unit 60 receiving the instruction mentioned above transmits data of the CH banner produced to the video conversion controller unit 61, and the video conversion controller unit 61, receiving the data mentioned above, makes such control that the CH banner is superimposed on the video signal, to be outputted. In this manner, message display is carried out, when tuning, etc.

### <Recording of Broadcast Signal>

Next, explanation will be given about recording control of the broadcast signals and flows of the signals. When recoding a specific CH, the system controller 51 instructs the tuning controller unit 59 to tune into a specific CH and to output the signal to the recording/reproducing unit 27.

The tuning controller unit 59 receiving the above-mentioned instruction thereon, similar to the broadcast receiving process mentioned above, instructs the tuner 23 to control, so as to receive the designated CH, instructs the descrambler 24 to descramble the MPEG2-TS receiving from the tuner 23, and instructs the multiplex divider unit 29 to output the input from the descrambler 24 towards to the recording/reproducing unit 27.

Also, the system controller unit 51 instructs the recoding/reproducing controller unit 58 to record the TS inputted into the recording/reproducing unit 27. The recording/reproducing controller unit 58 receiving the instruction mentioned above executes necessary processes, such as, encryption, etc., upon the signal (TS) inputted into the recording/reproducing unit 27, and also, after producing additional information necessary when recoding/reproducing (i.e., content information, such as, the program information of recording CH and/or the bit rate thereof, etc.), and also after recording the management data (ID of recording content, recording position on the recording medium 26, recording format, encoding information, etc.), it executes a process for writing the management data into the recording medium 26. In this manner, recoding of the broadcast signal is carried out. Hereinafter, such recoding method mentioned will be called “TS recording”, for distinguishing from a method of executing the conversion, as will be mentioned below, to record.

Explanation will be given on an example wherein recoding is executed through other passage, in particular, when recording the broadcast signal after treating processes (for example, conversion of the format of the video signal and the audio signal or video compression, or 2D/3D conversion of video, etc.) upon the video and/or the audio included therein (hereinafter, “convert recording”). The system controller unit 51, similar to the TS recording, instructs the tuning controller unit 59 to output a tuning into the specific CH. The tuning controller unit 59 receiving the instruction mentioned above, similar to the broadcast receiving process mentioned above, instructs the tuner 23 to receive the designated CH, and instructs the descrambler 24 to control, so as to descramble the MPEG-2 TS received from the tuner 23, and also instructs the multiplex divider unit 29 to divide TS inputted from the descrambler 24, from multiplexing, and thereby to output to the video decoder unit 30 and the audio decoder unit 31. The video decoder unit 30 decodes the signal, and outputs the video to the video conversion processor unit 32. Herein, the video conversion processor unit 32 executes necessary conversion processes (format conversion of the video signal, the 2D/3D conversion process, etc.), and outputs the signal to the video encoding unit 35. The video encoding unit 35 receiving the output mentioned above encodes that signal, and outputs the video ES to the multiplex/composer unit 37. Similarly, the audio signal is also decoded in the audio decoder unit 31, and the audio signal is outputted to the audio encoder unit 36; then after being treated with necessary processes thereon in the audio encoder unit, the audio ES is outputted to the multiplex/composer unit 37. The multiplex/composer unit 37, inputting that video ES and that audio ES therein, obtains other information necessary for multiplexing (for example, the program information, etc.), from the multiplex divider unit 29, or from the CPU 21 depending on necessity thereof, and multiplexing it together with the above-mentioned video ES and the above-mentioned audio ES, thereby to output to the recording/reproducing unit 27.

Thereafter, similar to the case of the TS recording mentioned above, the system controller unit 51 instructs the recording/reproducing controller unit 58 to record the TS inputted from the multiplex/composer unit 37 to the recording/reproducing unit 27. The recording/reproducing controller unit 58 receiving the instruction mentioned above executes necessary processes, such as, encoding, etc., upon the signal (TS) inputted into the recording/reproducing unit 27, and after producing additional information necessary when recording/reproducing (i.e., content information, such as, the program information of recording CH and/or the bit rat thereof, etc.), and also after recording the management data (ID of recording content, recording position on the recording medium 26, recording format, encoding information, etc.), it executes a process for writing the management data into the recording medium 26. In this manner, recoding of the translated broadcast signal is carried out.

<Reproduction from Recording Medium>

Next, explanation will be given about reproducing proves from the recording medium. When reproducing a specific program, the system controller unit 51 gives an instruction of reproducing the specific program to the recording/reproducing controller unit 58. As the instruction in this instance, there are indicated an ID of content and a reproduction start point (for example, a top of program, a position of 10 minutes from the top, a position of 100 M bytes from the top, etc.) The recording/reproducing controller unit 58 receiving the instruction mentioned above controls the recording/reproducing unit 27, thereby to read out the signal (TS) from the recording medium 27 with using the additional information and the management information, and after executing the necessary processes, such as, decryption, the process is executed on the multiplex divider unit 29 to output TS.

Also, the system controller unit 51 gives an instruction of output of the video/audio signals of the reproduced signal to the tuning controller unit 59. The tuning controller unit 59 receiving the instruction mentioned above controls the input from the recording/reproducing unit 27 to be outputted to the multiplex divider unit 29, and instructs the multiplex divider unit 29 to divide the inputted TS from multiplexing, and to output the video ES divided from multiplexing to the video decoder unit 30, as well as, to output the audio ES divided from multiplexing to the audio decoder unit 31.

Also, the tuning controller unit 59 instructs the decoding controller unit 57 to decode the video ES and the audio ES, which are inputted into the video decoder unit 30 and the audio decoder unit 31, respectively. The decoding controller unit 57 controls the video decoder unit 30 to output the video signal decoded to the video conversion processor unit 32, and also controls the audio decoder unit 31 to output the audio signal decoded to the speaker 48 or the audio output. In this manner, processes for reproducing the signals from the recording medium are carried out.

### <Display Method of 3D Picture>

As a method for displaying 3D picture, being applicable to the present invention, there are several methods, and wherein the pictures for the left-side eye and for the right-side eye are produced in such a manner that parallax is generated between the left-side eye and the right-side eye, and thereby causing a human to recognize that a cubic thing exists.

As one of the method, there is an active shutter method, wherein light shielding is done, alternately, between the left-side glass and the right-side glass, upon the glasses, which the user wears, with using a liquid crystal shutter, etc., and thereby generating the parallax on the screen reflecting or appearing on the left-side and right-side eyes.

In this case, the receiving apparatus 4 outputs sync signal and control signal from the control signal output unit 43 and the equipment control signal transmitting terminal 44, toward to an active shutter-type glasses, which the user wears. Also, the video signal is outputted from the video signal output unit 41 to the external 3D video display device or apparatus, to be displayed the picture for the left-side eye and the picture for the right-side eye thereon, alternately. Or, the similar 3D display is conducted on the display 47 that the receiving apparatus 4 has. Doing in this manner, the user wearing the active shutter-type glasses can enjoy or view the 3D picture on the display 47 that the 3D video display device or the receiving apparatus 4 has.

Also, as other method, there is a polarization method, with applying glasses or linear polarization forming coats on the left-side and right-side glasses, perpendicular to each other in the direction of linear polarization, or applying glasses or linear polarization forming coats on the left-side and right-side glasses, opposite to each other in the direction of circular polarization, upon the glasses, which the user wears, a polarized picture for the left-side eye and a polarized picture for the right-side eye are outputted, simultaneously, differing from each other corresponding to the left-side polarization and the right-side polarization on the glasses; i.e., separating or dividing the pictures to be incident upon the left-side eye and the right-side eye, respectively, depending on the polarization condition thereof, and thereby generating the parallax between the left-side eye and the right-side eye.

In this case, the receiving apparatus 4 outputs the video signal, from the video signal output unit 41 to the 3D video display device or apparatus, and then said 3D video display device displays the video for the left-side eye and the video for the right-side eye under conditions differing from each other. Or, the similar display is carried out by the display 47 that the receiving apparatus 4 has. With doing in this manner, the user wearing the polarization glasses can enjoy or view the 3D video or picture on said 3D video display device displays or the display 47 that the receiving apparatus 4 has. Further, with the polarization method, since the viewing/listening of the 3D video can be made, but without transmitting the sync signal and/or the control signal from the receiving apparatus 4 to the polarization glasses, there is no necessity of outputting the sync signal and/or the control signal from the control signal output unit 43 and the equipment control signal transmitting terminal 44.

Also, other than those, there may be applied a color separation method for separating the pictures for the left-side/right-side eyes depending on the colors. Or, there may be applied a parallax barrier method of creating the 3D picture with using the parallax barrier visible by bear eyes.

However, the 3D display method relating to the present invention should not be restricted to a specific method.

<Example of Detailed Determination Method of 3D Program with Using Broadcast Program>

As an example of the determining method of the 3D program, there is a method of obtaining the information for determining on whether it is a newly included 3D program or not, from various kinds of tables and/or descriptors included in the program information of the broadcast signals and reproduction signals, which are already explained, and thereby enabling to determine on whether it is the 3D program or not.

Determination is made on whether it is the 3D program or not, by confirming the information for determining to be the 3D program or not, which is newly included in the component descriptor or the component group descriptor, described on the table, such as, PMT or EIT [schedule basic/schedule extended/present/following], or confirming the 3D program details descriptor, which is a new descriptor for use of determination of the 3D program, or confirming the information for determining to be the 3D program or not, which is newly included in the service descriptor or the service list descriptor described on the table, such as, NIT, SDT, etc. Those information are attached to the broadcast signal in the transmitting apparatus mentioned previously, and are transmitted. In the transmitting apparatus, those information are assigned to the broadcast signal by the management information assignment unit 16.

As a way of using of each table, for example, with PMT, it has the following characteristics: since describing thereon only the information of the present programs, it is impossible to confirm the information of future programs, but has a high reliability. On the other hand, with EIT [schedule basic/schedule extended], although possible to obtain, not only the information of the present program, but also that of the future programs, however, it has the following demerits: i.e., it takes a long time until when completing receipt thereof, it needs a lot of memory areas for holding them, and it has a low reliability because they are future events. With EIT [following], since it is possible to obtain the information of the program on the next broadcasting time, and therefore is suitable for application into the present embodiment. Also, with EIT [present], it can be used for obtaining the present program information, and it can obtain the information different from that with PMT.

Next, explanation will be made on detailed example of the process in the receiving apparatus 4 relating to the program information, which is transmitted the transmitting apparatus 1 and is explained by referring to FIGS. 4, 6, 10, 12 and 14.

FIG. 20 shows an example of processes for each field of the component descriptor in the receiving apparatus 4.

When “descriptor_tag” is “0x50”, the corresponding descriptor is determined to be the component descriptor. With “descriptor_length”, it is determined to be the descriptor length of the component descriptor. If “stream_content” is “0x01”, “0x05”, “0x06” or “0x07”, then the corresponding descriptor is determined to be valid (video). In case where it is other than “0x01”, “0x05”, “0x06” and “0x07”, the corresponding descriptor is determined to be invalid. In case where the “stream_content” is “0x01”, “0x05”, “0x06” or “0x07”, the following processes are executed.

With “component_type”, the corresponding component is determined of the video component type thereof. Regarding this component type is designated any one of the values shown in FIG. 5. Upon this content, it is possible to determine the corresponding it that relating to the 3D video program or not.

“component_tag” is a component tag value unique within the corresponding program, and can be used by referring to the component tag value of the stream descriptor of PMT.

With “ISO_{—}693 language_code”, the character code disposed thereafter is treaded as “jpn”, even if it is other than “jpn(“0x6A706E”)”.

With “text_char”, characters within 16 bytes (8 double-byte characters) are determined to be the component description. If this field is omitted, it is determined to be a default component description. The default component description is “video”.

As was mentioned above, with the component descriptor, it is possible to determine the video component type building up the event (program), therefore the component descriptor can be used when selecting the video component within the receiving apparatus.

However, it is assumed that only the video component, “component_tag” value of thereof being set to “0x00”-“0x0F”, is a target of the selection alone. The video component, being set with “component_tag” value other than those mentioned above, does not become the target of the selection alone, and should not be used as a target for, such as, component selection function, etc.

Also, there are cases where the component description does not coincide with an actual component, due to mode change, etc., generated during the event (program). (In “component_type” of the component descriptor is described a representative component type of the corresponding component, but such doing of changing this value, in real time, responding to the mode change on the way of the program.)

Also, “component_type” described by the component descriptor is referred to, when determining the default “maximum_bit_rate” in case where the digital copy control descriptor thereof, being description of the information for controlling copy generation and the maximum transmission rate in digital recording equipment, is omitted therefrom, for the corresponding event (program).

In this manner, by executing the process for each field of that descriptor, the receiving apparatus 4 can observe “stream_content” and “component_type”, and thereby obtains an effect of enabling to recognize the program, which is received at present or will be received in future, is the 3D program.

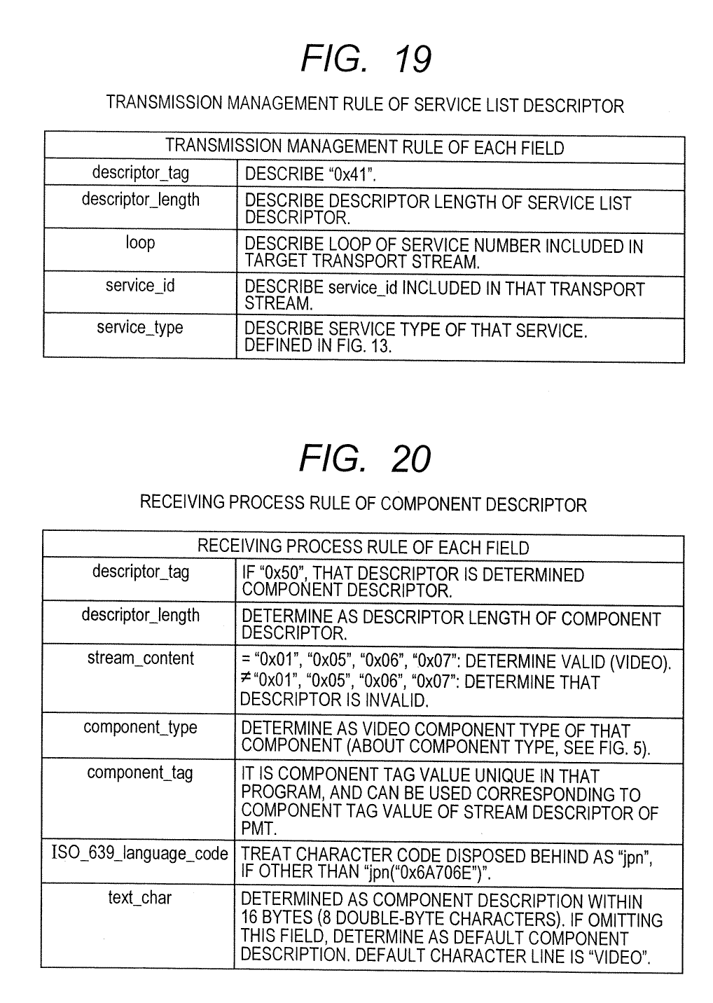

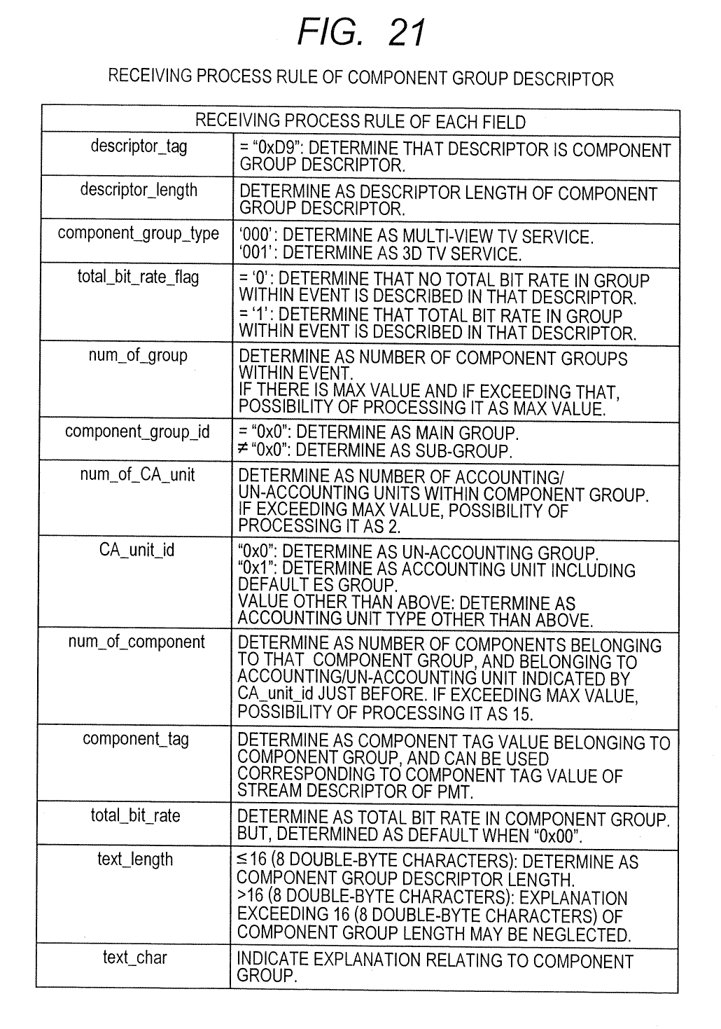

FIG. 21 shows an example of processes for each field of the component group descriptor in the receiving apparatus 4.

When “descriptor_tag” is “0xD9”, the corresponding descriptor is determined to be the component group descriptor.

By means of “descriptor_length”, it is determine to be the descriptor length of the component group descriptor.

When “component_group_type” is “000”, it is determined to be the multi-view TV service, and when “001”, determined to be the 3D TV service.

When “total_bit_rate_flag” is “0”, it is determined that the total bit rate within the group in the event (program) is not described in the corresponding descriptor. If “1”, t is determined that the total bit rate within the group in the event (program) is described in the corresponding descriptor.

With “num_of_group”, it is determined to be the number of the component group in the event (program). There is defined the maximum value, and if exceeding that, there is possibility that it may be processed as that maximum value.

With “num_of_CA_unit”, it is determined to be the number of the accounting/unaccounting unit(s) in the component group. If exceeding the maximum value, there is possibility that it may be processes as “2”.

When “CA_unit_id” is “0x0”, it is determined to be the unaccounting unit group. If “0x1” it is determined to be the accounting unit, including a default ES group therein. If other than “0x0” and “0x1”, it is determined to be an accounting unit type other than those mentioned above.

With “num_of_component”, it is determined to be a number of the components, which belong to the corresponding component group and belong to the accounting/unaccounting unit indicated by “CA_unit_id” just before. If exceeding the maximum value, there is possibility that it may be processed as “15”.

With “component_tag”, it is determined to be the component tag value belonging to the component group, and it can be used by referring to the component tag value of the PMT stream descriptor.

With “total_bit_rate”, it is determined to be the total bit rate within the component group. However, when “0x00”, it is determined to be a default.

If “text_length” is equal to or less than 16 (8 double-byte characters), it is determined to be the component group length, otherwise, if larger than 16 (8 double-byte characters), part of explanation exceeding the 16 (8 double-byte characters) of the component group length can be neglected.

“text_char” indicates an explanation relating to the component group. Further, with disposition of the component group descriptor of “component_group_type”=” 000″, it can be determined that the multi-view TV service is conducted in the corresponding event (program); therefore, it can be utilized in the process for each of the component groups.

Also, with disposing the component group descriptor of “component_group_type”=“001”, it can be determined that the 3D TV service is conducted in the corresponding event (program); therefore, it can be utilized in the process for each of the component groups.

Further, default ES groups of each group are necessarily described in the component, which is disposed at the top of “CA_unit” loop.

In the main group (component_group_id=0x0) are described the followings:
if the default ES group of the group is unaccounting target, it must be “free_CA_mode_{—}0”, but not setup of the component group of “CA_unit_id=0x1”; and
if the default ES of the group is the accounting target, it must be “free_CA_mode=1”, and component group of “CA_unit_id=0x1” must be set up, and described.

Also, in the sub-group (component_group_id>0x0) are described the followings:
into the sub-group, only the accounting unit or the unaccounting unit, being same to that of the main group, can be set up;
if the default ES group of the group is unaccounting target, the component group of “CA_unit_id=0x0 is set up, and described; and,
if the default ES of the group is the accounting target, the component group of “CA_unit_id=0x1 is set up, and described.

In this manner, by executing the process for each field of that descriptor, the receiving apparatus 4 can observe “component_group_type”, and thereby obtains an effect of enabling to recognize the program, which is received at present or will be received in future, is the 3D program.

FIG. 22 shows an example of processes for each field of the 3D program details descriptor in the receiving apparatus 4.

When “descriptor_tag” is “0xE1”, the corresponding descriptor is determined to be the 3D program details descriptor. With “descriptor_length”, it is determined to be the descriptor length of the 3D program details descriptor. With “3d_{—}2d_type”, it is determined to be the 3D/2D type in the corresponding 3D program.

This is designated from those shown in FIG. 10B. With “3d_method_type”, it is determined to be the 3D method type in the corresponding 3D program. This is designated from those shown in FIG. 11.

With “stream_type”, it is determined to be the type of ES of the corresponding 3D program. This is designated from those shown in FIG. 3. With “component_tag”, it is determined to be the component tag value unique within the corresponding 3D program. This can be used, by referring to the component tag value of the stream descriptor of PMT.

Further, it is possible to apply such structure that the corresponding program can be determined to be the 3D video program or not, depending on presence/absence of the 3D program details descriptor itself. Thus, in this case, if there is no 3D program details descriptor, it is determined to be the 2D video program, otherwise, of there is the 3D program details descriptor, then it is determined to be the 3D video program.

In this manner, by executing the process for each field of that descriptor, the receiving apparatus 4 can observe the 3D program details descriptor, and thereby obtains an effect of enabling to recognize that the program, which is received at present or will be received in future, is the 3D program.

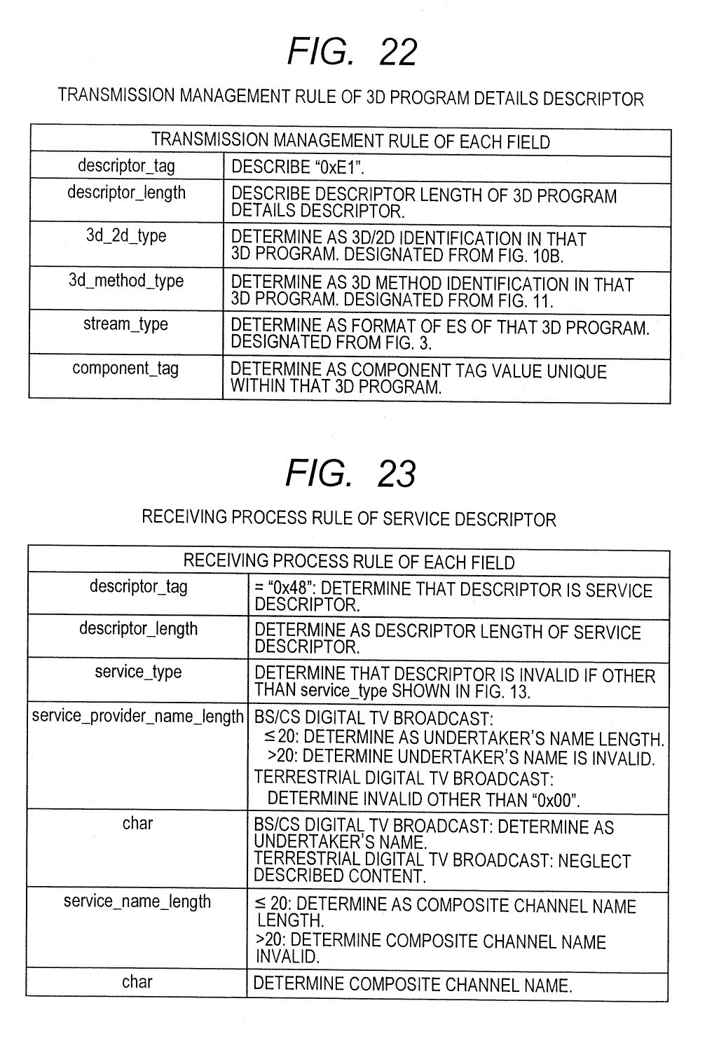

FIG. 23 shows an example of processes for each field of the service descriptor in the receiving apparatus 4. If “descriptor_tag” is “0x48”, the corresponding descriptor is determined to be the service descriptor. With“descriptor_length”, it is determined to be the descriptor length of the service descriptor. With“service_type”, if it is other than“service_type” shown in FIG. 13, then the corresponding descriptor is determined invalid.

With “service_provider_name_length”, if equal to or less than “20”, it is determined to be the undertaker name length of the, while larger than “20”, the undertaker name is determined to be invalid, in case of receiving the BS/CS digital television broadcasts. On the other, in case receiving the terrestrial digital television broadcast, it is determined to be invalid if other than “0x00”.

With “char”, it is determined to be the undertaker's name, in case of receiving the BS/CS digital television broadcasts. On the other hand, in case receiving the terrestrial digital television broadcast, the content described is neglected. If “service_name_length” is equal to or less than “20”, it is determined to be the composite channel name length, while larger than “20”, the composite channel name length is determined to be invalid.

With “char”, it is determined to be the composite channel name. However, if impossible to receive SDT, in which the descriptor is disposed in accordance with the transmission management rule explained in FIG. 18, then basic or fundamental information of the target service is determined to be invalid.

In this manner, by executing the process for each field of that descriptor, the receiving apparatus 4 can observe the “service_type”, and thereby obtains an effect of enabling to recognize that the composite channel is a channel of the 3D program.

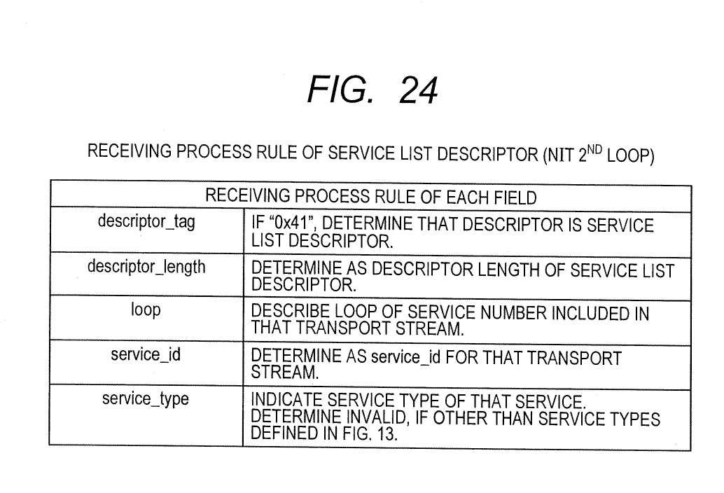

FIG. 24 shows an example of processes for each field of the service list descriptor in the receiving apparatus 4. If “descriptor_tag” is “0x41”, the corresponding descriptor is determined to be the service list descriptor. With “descriptor_length”, it is determined to be the descriptor length of the service list descriptor.

In “loop” is described a loop of the service number included in the target transport stream. With“service_id”, it is determined to be “service_id” for the corresponding transport stream. “service_type” indicates the service type of the target service. Other than those shown in FIG. 13 is determined to be invalid.

As was explained in the above, the service list descriptor can be the information of the transport stream included in the target network.

In this manner, by executing the process for each field of that descriptor therein, the receiving apparatus 4 can observe “service_type”, and thereby obtains an effect of enabling to recognize the composite channel is the channel of the 3D program.

Next, explanation will be made about the detailed descriptors within each table. First of all, although it is possible to determine the type or format of ES, depending on the type if data within “stream_type” described in a 2^{nd} loop of PMT, as was explained in FIG. 3; however, if there is description indicating that the stream being broadcasted at present is the 3D video, among of those, then that program is determined to be the 3D program (for example, in “stream_type”, if there is “0x1F” indicative of the sub-bit stream of the multi-aspect video encoded (example: H.264/MVC), then that program is determined to be the 3D program).

Also, other the “stream_type”, it is also possible to make the determination in the region, while newly assigning the 2D/3D identification bit for identifying to be the 3D program or the 2D program, in relation with the region, which is set “reserved” at present in PMT.

With EIT, similarly, it is also possible to make determination while assigning the 2D/3D identification bit, newly, into the region of “reserved”.

When determining the 3D program with using the component descriptor, which is disposed on PMT and/or EIT, as was explained in FIGS. 4 and 5, while assigning a type indication the 3D video in“component_type” of the component descriptor (for example, FIGS. 5C-5E), it is possible to determine the program to be the 3D program if there is something indicating that “component_type” is 3D. (For example, while assigning it as shown in FIGS. 5C-5E, it is confirmed that value is in the program information of the target program.)

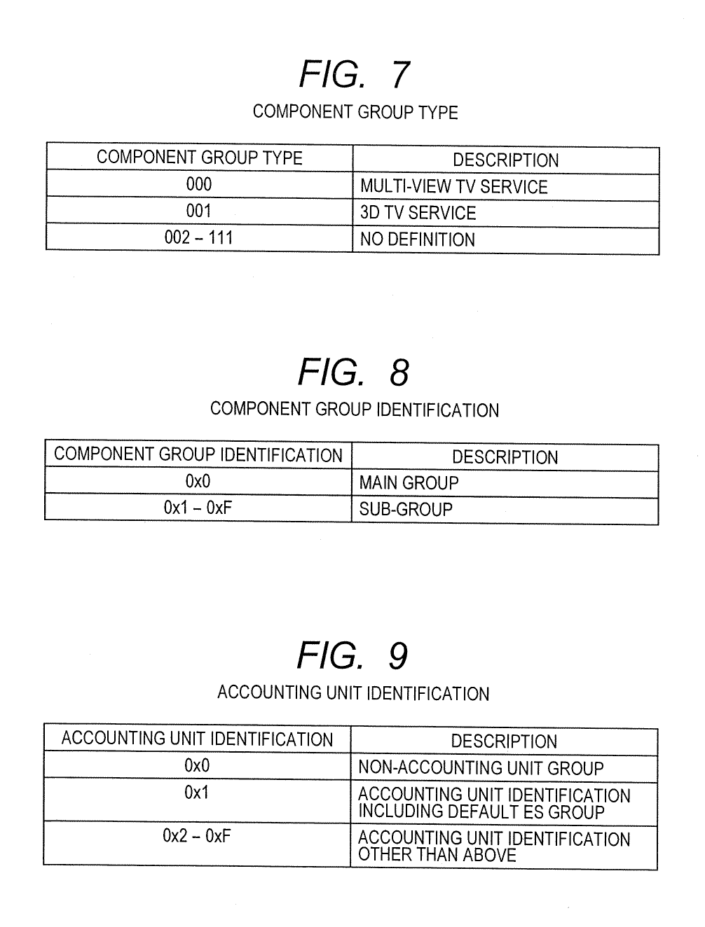

As the determination method with using the component group descriptor disposed in EIT, as was explained in FIGS. 6 and 7, while assigning the description indicating the 3 service into the value of “component_group_type”, it is possible to determine that to be the 3D program, if the value of “component_group_type” indicates the 3D service (for example, while assigning the 3DTV service, etc., into “001” of the bit field, it is confirmed that value is in the program information of the target program.)

As the determination method with using the 3D program details descriptor disposed in PMT and/or EIT, as was explained in FIGS. 10 and 11, when determining on whether the target program is the 3D program or not, it is possible to determine depending on the content of “3d_{—}2d_type” (3D/2D type) within the 3D program details descriptor. Also, about the receiving program, if the 3D program details descriptor is not transmitted, it is determined to be the 2D program. Also, if there is the 3D method in the 3D method types (“3d_method_type” mentioned above) included within the descriptor mentioned above, with which the receiving apparatus is compatible or operable, there can be also a method of determining that the next program is the 3D program. In that case, the analyzing processes of the descriptor come to be complex, however it is possible to execute a message display process to the 3D program, which the receiving apparatus cannot deal with, or stop the operation thereof, for executing the recording process.

In case where assigning the 3D video service to “0x01”, as was explained in FIGS. 12, 13 and 14, in the information of “service_type” included in the service descriptor dispose on SDT, or in the service list descriptor dispose on NIT, when obtaining the program information having that descriptor, it can be determined to be the 3D program. In this case, determination can be made, not by a unit of the program, but by a unit of the service (CH, composite channel), and therefore it is impossible to determine the next program is the 3D program within the same composite channel; however, there is such a merit that it is easy because obtaining of the information is not by the unit of program.

Also, about the program information, there is a method of obtaining it through a communication pass for exclusive use thereof (broadcast signal or Internet). In that case, it is possible to determine the 3D program, in the similar manner, if there are starting time of the program, CH (broadcast composite channel, URL or IP address), and the descriptor indicating on whether it is the 3D program or not.

In the explanation given in the above, the explanation was given about various information (the information included in the tables and the descriptors) for determining to be the 3D video or not, by the unit of service (CH) or program; however, those are not always necessary to be transmitted, in the present invention. It is enough to transmit necessary information, fitting to a broadcasting mode. Among those information, after confirming independent or single information, respectively, determination of being the 3D video, or not, can be made by the unit of service (CH) or program, or determination of being the 3D video, or not, can be made by the unit of service (CH) or program, combining plural numbers of information. In case when determining by combining the plural numbers of information, although relating to the 3D video broadcast service, it is also possible to determine that a part of programs is the 2D video, etc. If such determination can be made, it is possible to display that the corresponding service is “3D video broadcast service” on the receiving apparatus, for example, with EPG, and also, if the 2D video program(s) is/are mixed, other than the 3D video program(s), in that service, it is possible to exchange the display control, etc., between the 3D video program and the 2D video program, when receiving programs.

However, in case where it is determined to be the 3D program, according to the determination method of the 3D program, which was explained in the above, if the 3D components designated in FIGS. 5C-5E, for example, can be processed, appropriately (reproduced, displayed or outputted), by the receiving apparatus 4, it is processed (reproduced, displayed or outputted) in 3D, on the other hand, if they cannot be processed (reproduced, displayed or outputted) appropriately by the receiving apparatus 4 (for example, when there is no 3D video reproducing function compatible or operable with the 3D transmission method designated, etc.), or in case where ES of any one aspect or view point is not transmitted, in a 3D/2D aspect separated ES transmission method, it may be processed (reproduced, displayed or outputted) in 2D.

### <3D Reproduction/Output/Display Processing of 3D Content of 3D/2D Aspect Separated ES Transmission Method>

Next, explanation will be given about the process when reproducing the 3D content (digital content including 3D video). Herein, first of all, explanation will be given on the reproducing process in case of 3D/2D aspect separated ES transmission method, wherein there are such a main aspect video ES and a sub-aspect video ES for one (1) ES, as shown in FIG. 40. Firstly, when the user gives an instruction to exchange to 3D output/display (for example, pushing down the “3D” key on the remote controller), etc., then the user instruction receiver unit 52 instructs the system controller unit 51 to exchange to the 3D video (however, in the process hereinafter, the same processes are executed, even when the user tries to exchange to the 3D output/display under the condition other than that of the user instruction to exchange to 3D output/display of the 3D content, in relation to the 3D content of the 3D/2D aspect separated ES transmission method). Next, the system controller unit 51 determines on whether the present program is 3D program or not, with the method mentioned above.

When the present program is the 3D program, the system controller unit 51, first of all, instructs the tuning controller unit 59 to output the 3D program. The tuner controller unit 59 receiving the instruction mentioned above, first of all, obtains PID (packet ID) and coding method (for example, H.264/MVC, MPEG 2, H.264/AVC, etc.), with respect to each of the main aspect video ES and the sub-aspect video ES, from the program analyzer unit 54, and next, it executes control on the multiplex divider unit 29, so that it divide the main aspect video ES and the sub-aspect video ES from multiplexing, and thereby outputting them to the video decoder unit 30.

Herein, the multiplex divider unit 29 is controlled so that the main aspect video ES is inputted into a 1^{st} input of the video decoder unit and the sub-aspect video ES is inputted into a 2^{nd} input thereof, respectively. Thereafter, the tuning controller unit 59 transmits information to the decoding controller unit 57, indicating that the 1^{st} input of the video decoder unit 30 is for the main aspect video ES and the 2^{nd} input thereof is for the sub-aspect video ES, and further instructs to decode those ESs therein.

For decoding the 3D program differing the coding method between the main aspect video ES and the sub-aspect video ES, such as the combination example 2 and the combination example 4 of the 3D/2D aspect separated ES transmission method as shown in FIG. 40, the video decoder unit 30 may be constructed to have plural numbers of decoding functions corresponding to the coding methods, respective.

For decoding the 3D program being same of the coding method between the main aspect video ES and the sub-aspect video ES, such as the combination example 1 and the combination example 3 of the 3D/2D aspect separated ES transmission method as shown in FIG. 40, the video decoder unit 30 may be the structure having only the decoding function corresponding to a single coding method. In this case, the video decoder unit 30 can be constructed, cheaply.

The decoding controller unit 57 receiving the instruction mentioned above executes the decoding on the main aspect video ES and the sub-aspect video ES, corresponding to the coding methods thereof, and thereby it outputs the video signals for the left-side eye and the right-side eye to the video conversion processor unit 32. Herein, the system controller unit 51 instructs the video conversion controller unit 61 to execute the 3D output process. The video conversion controller unit 61 receiving the above instruction from the system controller unit 51 controls the video conversion processor unit 32, so as to output them from the video output 41, or display the 3 D picture on the display that the receiving apparatus 4 has.

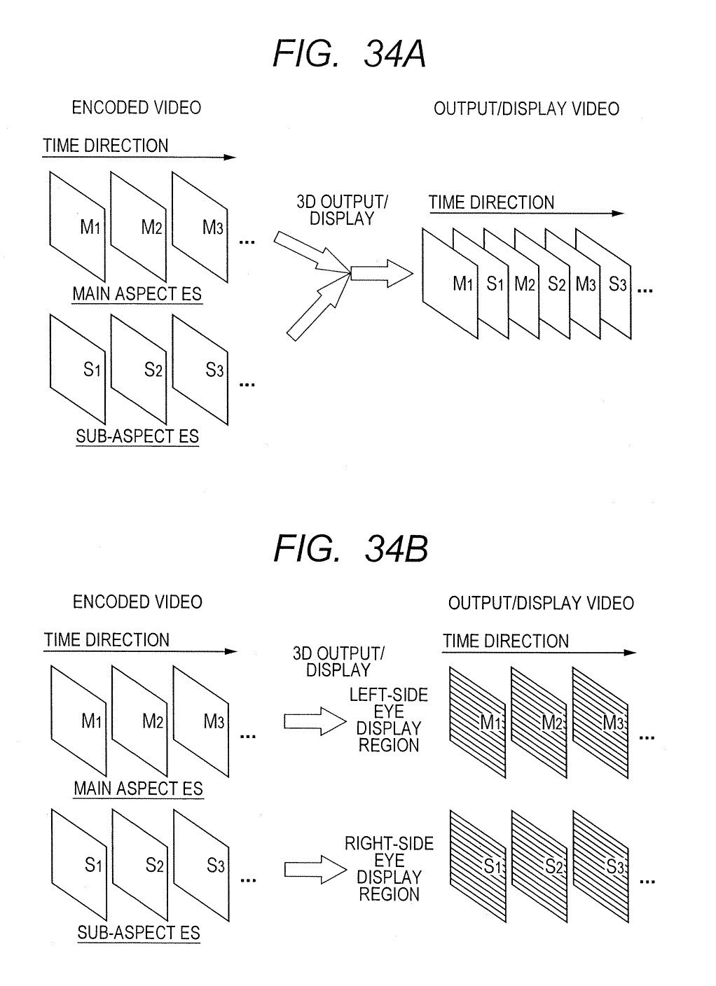

Explanation will be given about that 3D reproduction/output/display method, by referring to FIGS. 34A and 34B.

FIG. 34A is an explanatory view of reproduction/output/display method, corresponding to output and display of a frame sequential method for displaying and outputting, alternately, the videos of left and right aspects of the 3D content of the 3D/2D aspect separated ES transmission method. Frame lines (M1, M2, M3, . . . ) of an upper part on the left in the figure present the plural numbers of frames, which are included in the main aspect (for the left-side eye) video ES of the 3D/2D aspect separated ES transmission method, and frame lines (S1, S2, S3, . . . ) of an lower part on the left in the figure present the plural numbers of frames, which are included in the main aspect (for the left-side eye) video ES of the 3D/2D aspect separated ES transmission method, respectively. The video conversion processor unit 32 outputs/displays the frames, e.g., each frame of the video signals of the main aspect (for the left-side eye)/sub-aspect (for the left-side eye), which are inputted, alternately, as the video signal, as shown by the frame lines (M1, S1, M2, S2, M3, S3, . . . ) on the left side in the figure. With such output/display method, it is possible to use the resolution of the picture, which can be displayed on the display, at the maximum, for each aspect, respectively, and thereby enabling the 3D display of high resolution.

When applying the method shown in FIG. 34A in the system structures shown in FIG. 33, as well as, the output of the video signals mentioned above, the sync signal and the control signal enabling to determine the respective video signals are for use of the main aspect (the left-side eye) and for use of the sub-aspect (the right-side eye), respectively, from the control signal. The external video output device or apparatus receiving the video signals and the sync signals mentioned above outputs the videos of the main aspect (for use of the left-side eye) and the sub-aspect (for use of the right-side eye), synchronizing the video signals with the sync signals, and also transmits the sync signals to the 3D view support device, and thereby enabling to do the 3D display. However, the sync signal outputted from the external video output device or apparatus may be produced in that external video output device or apparatus.

Also, when displaying the video signals mentioned above on the display 47 equipped with the receiving apparatus 4, with applying the method shown in FIG. 34A, in the system structures shown in FIG. 32, the sync signal mentioned above is outputted from the equipment control signal transmitting terminal 44, passing through the equipment control signal transmitter unit 53 and the control signal transmitter unit 33, to execute control of the external 3D view support device (for example, switching of shielding by the active shutter), and thereby conducting the 3D display.

FIG. 34B is a view for explaining a reproduction/output/display method for enabling the output and the display of a method for displaying the videos of the aspects of the left and the right of 3D content of the 3D/2D aspect separated ES transmission method in the regions differing on the display. That method is for decoding the stream of the 3D/2D aspect separated ES transmission method in the video decoder unit 30, and for executing the video conversion process in the video conversion processor unit 32. Herein, for displaying on the different regions, there is a method, for example, displaying lines of odd numbers and lines of even numbers of the display are displayed as the display regions for the main aspect (the left-side eye) and for the sub-aspect (the right-side eye), respectively, etc. Or, the display region may be not by a unit of the line, in case of the display having pixels differing from those for each aspect, the display regions may be the respective regions of combination of plural numbers of pixels for the main aspect (the left-side eye) and combination of plural numbers of pixels for the sub-aspect (the right-side eye). For example, on the display device or apparatus of the polarization method mentioned above, from the different regions mentioned above may be outputted the videos or pictures differing from each other of the polarization condition, corresponding to the respective polarization conditions of the 3D view support device for the left-side eye and for the right-side eye. With such output/display method, the resolution of the picture, which can be displayed on the display, for each aspect, comes to be smaller than that of the method shown in FIG. 34A; however, enabling to output/display the pictures or videos for the main aspect (the left-side eye) and the sub-aspect (the right-side eye), simultaneously, there is no need to display those, alternately. With this, it is possible to enable the 3D display having less flickers comparing to the method shown in FIG. 34A.

Further, in any of the system structures or configuration shown in FIG. 32 or 33, the 3D view support device may be a polarization division or separation glasses, there is no need to execute electronic control, in particular. In this case, it is possible to provide the 3D view support device with a cheaper price.

### <2D Output/Display Process of 3D Content of 3D/2D Aspect Separated ES Transmission Method>

Explanation will be made on the operation when executing 2D output/display of the 3D content of the 3D/2D aspect separated ES transmission method. When the user instructs exchange to the 2D video (for example, pushing down the “2D” key on the remote controller), then the user instruction receiver unit 52 receiving the key code mentioned above, instructs the system controller unit 51 to exchange the signal to the 2D video (however, in the processes hereinafter, the same processes are executed, even when switching is made to the 2D output/display under the condition other than the exchange instruction by the user to the 2D output/display of the 3D content of the 3D/2D aspect separated ES transmission method). Next, the system controller unit 51 instructs the tuning controller unit 59 to output the 2D video, at first.

The tuning controller unit 59 receiving the instruction mentioned above, first of all, obtaining ES for the 2D video (the above-mentioned main aspect ES or the ES having a default tag) from the program information analyzer unit 54, and controls the multiplex divider unit 29 so as to output the above-mentioned ES to the video decoder unit 30. Thereafter, the tuning controller unit 59 instructs the decoding controller unit 57 to decode that ES. Thus, in the 3D/2D aspect separated ES transmission method, since the sub-stream or the ES differs from between the main aspect and the sub-aspect, it is sufficient to decode only the main aspect steam or ES.

The decoding controller unit 57, receiving the instruction mentioned above, controls the video decoder unit 30, so as to decode the ES mentioned above, thereby to output the video signal to the video conversion processor unit 32. Herein, the system controller 51 controls the video conversion processor unit 61 so as to output the 2D video therefrom. The conversion processor unit 61, receiving the instruction mentioned above, outputs the 2D video signal from the video output terminal 41 to the video conversion processor unit 32, or executes control so as to display the 2D picture on the display.

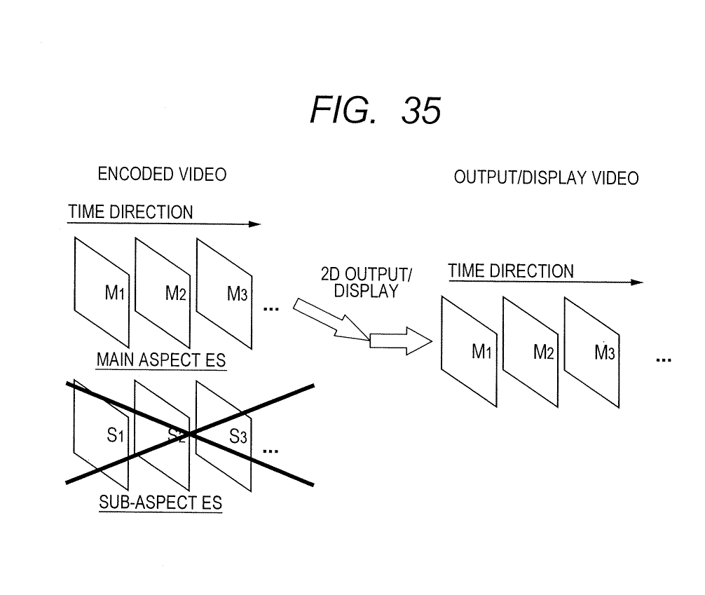

Explanation will be given about that 2D output/display method, by referring to FIG. 35. Though the structure of the encoded video is similar to that shown in FIG. 34, however as was explained in the above, since the second ES (the sub-aspect video ES) is not decoded in the video decoder unit 30, the video signal on one side to be decoded in the video conversion processor unit 32 is converted into the 2D video signal, as shown by the frame lines (M1, M2, M3, . . . ) on the left-hand side in the figure, to be outputted. In this manner, the 2D output/display is carried out.

Herein, although description was made about the method not decoding the ES for the right-side eye, as the 2D output/display method; however, while decoding both ES for the left-side eye and ES for the left-side eye, the 2D display may be achieved by executing thinning upon the video signal for the right-side eye in the video conversion processor unit 32, thereby achieving the 2D display. In that case, there is no necessity of a process for exchanging the decoding process and the multiplex dividing process, and therefore there can be expected effects of reduction of exchanging time and simplification of software processing, etc.

### <3D Output/Display Process of 3D Content of Side-by-Side Method/Top-and-Bottom Method>

Next, explanation will be given on the reproducing process of the 3D content in case where the video for the left-side eye and the video for the right-side eye are in one (1) video ES (for example, the left-side eye and the video for the right-side eye are stored in one (1) of the 2D videos, such as, in the Side-by-Side method or the Top-and-Bottom method). Similarly to the above, when the user instructs to change to the 3D picture, then the user instruction receiver unit 52, receiving the key code mentioned above, instructs the system controller unit 51 to switch to the 3D picture (however, in the processes hereinafter, the same processes are executed even in the case where the switching to the 2D output/display is made under the condition other than that where the exchange instruction is made by the user to change the 3D content according to the Side-by-Side method or the Top-and-Bottom method to the 2D output/display). Next, similarly, the system controller 51 determines on whether the present program is the 3D program or not in accordance with the method mentioned above.

In the present program is the 3D program, the system controller 51 instructs the tuning controller unit 59, at first, to output the 3D video. The tuning controller unit 59 receiving the instruction mentioned above, firstly, obtains PID (packet ID) of the 3D video ES including the 3D video and the coding method thereof (for example, MPEG 2, or H.264/AVC, etc.) from the program analyzer unit 54, and next, controls the multiplex divider unit 29 so as to divide the said 3D video ES from the multiplexing, thereby to output it to the video decoder unit 30, and also controls the video decoder unit 29 to execute the decoding process corresponding to the coding method and to output the video signal decoded to the video conversion processor unit 32.

Herein, the system controller 51 instructs the video conversion controller unit 61 to execute the 3D output process. The video conversion controller unit 61, receiving the instruction mentioned above, instructs the video conversion processor unit 32 to divide the video signal inputted into the video for the left-side eye and the video for the right-side eye, so as to treat the process, such as, scaling, etc. (the details thereof will be mentioned later) thereon. The video conversion processor unit 32 outputs the video signals converted from the video output 41, or display the picture on the display equipped with the receiving apparatus 4.

Explanation will be given about the reproduction/output/display method of that 3D video, by referring to FIGS. 36A and 36B.

FIG. 36A is a view for explaining about the reproduction/output/display method compatible or operable with the output and/or display of a frame sequential method for displaying or outputting the videos of the aspects at the left and the right of the 3D content, according to the Side-by-Side method or the Top-and-Bottom method. Although illustration is made on the explanations of the Side-by-Side method and the Top-and-Bottom method are described together; however, since an aspect differing from, between the both, lies only in the arrangement within the pictures for the left-side eye and the right-side eye, therefore, in the explanation, which will be given hereinafter, is made by referring to the Side-by-Side method, but the explanation of the Top-and-Bottom method will be omitted. The frame lines (L1/R1, L2/R2, L3/R3, . . . ) present the video signals of the Side-by-Side method, wherein the picture for the left-side eye and the picture for the right-side eye are arranged on both sides (the left-hand side and the right-hand side) of one (1) frame. In the video decoder unit 30, the video signals of the Side-by-Side method under the condition of being arranged on the left-hand side and the right-hand side of the one (1) frame of the video for the left-side eye or the right-side eye are decoded, and in the video conversion processor unit 32, each frame of the video of the Side-by-Side method is divided to the left and the right, so as to be the video for the left-side eye and the video for the left-side eye, and further, a scaling is conducted (executing expansion/complement or compression/thinning, etc., to fit to the vertical size of the output picture). Moreover, as is shown by the frame lines (L1, R1, L2, R2, L3, R3, . . . on the left side in the figure, the frames are outputted, alternately, as the video picture.

In FIG. 36A, since the processes after converting the frames alternately, into the output/display pictures to be outputted/displayed, and also outputting of the sync signals and the control signals to the 3D view support device, etc., are similar to the 3D reproduction/output/display process of the content of the 3D/2D aspect separated ES transmission method, which was already explained in FIG. 34A, the explanation thereof will be omitted.

FIG. 36B is a view for explaining the reproduction/output/display method compatible or operable with the output and/or display of the method for displaying the pictures of the aspects at the left and the right of the 3D content, according to the Side-by-Side method or the Top-and-Bottom method, in the different regions on the display. Similar to FIG. 36A, although illustration is made on the explanations of the Side-by-Side method and the Top-and-Bottom method are described together; however, since an aspect differing from, between the both, lies only in the arrangement within the pictures for the left-side eye and the right-side eye, therefore, in the explanation, which will be given hereinafter, is made by referring to the Side-by-Side method, but the explanation of the Top-and-Bottom method will be omitted. The frame lines (L1/R1, L2/R2, L3/R3, . . . ) on the left side in the figure present the video signals of the Side-by-Side method, wherein the picture for the left-side eye and the picture for the right-side eye are arranged on both sides (the left-hand side and the right-hand side) of one (1) frame. In the video decoder unit 30, the video signals of the Side-by-Side method under the condition of being arranged on the left-hand side and the right-hand side of the one (1) frame of the video for the left-side eye or the right-side eye are decoded, and in the video conversion processor unit 32, each frame of the video of the Side-by-Side method is divided to the left and the right, so as to be the video for the left-side eye and the video for the left-side eye, and further, a scaling is conducted (executing expansion/complement or compression/thinning, etc., to fit to the vertical size of the output picture). Moreover, the video for the left-side eye and the video for the right-side eye, being treated with the scaling, are outputted/displayed in the different regions. Similar to the explanation in FIG. 34B, herein for displaying them in the different regions, there are methods, such as, wherein display is made with using the odd-number lines and even-number lines of the display as the display regions for the main aspect (the left-side eye) and for the sub-aspect (the right-side eye), respectively, etc., for example. Other than those, the display method in the different regions and the display method in the displaying apparatus of the polarization method, etc., since they are similar to the 3D reproduction/output/display process of the 3D content of the 3D/2D aspect separated ES transmission method, which was explained in FIG. 34B, the explanation thereof will be omitted.

In the method shown in FIG. 36B, even if a vertical resolution of the display and a vertical resolution of the input video are same, there is necessity of reducing the vertical resolutions, respectively, when outputting or displaying the video for the left-side eye and the video for the right-side eye on the odd-number lines and the even-number lines, respectively; however, in such case, it is enough to execute the thinning corresponding to the resolutions of the display regions of the video for the left-side eye and the video for the right-side eye, in the scaling process mentioned above.

### <2D Output/Display Process of 3D Content of Side-by-Side Method/Top-and-Bottom Method>

Explanation will be given about the operation of each part when executing the 2D display of the 3D content according to the Side-by-Side method or the Top-and-Bottom method, hereinafter. When the user instructs to change to the 2D picture (for example, pushdown of “2D” key on the remote controller), then the user instruction receiver unit 52 instructs the system controller unit 51 to exchange to the 3D video (however, in the process hereinafter, the same processes are executed, even when changing to the 2D output/display under the condition when the user instructs to change to the 2D output/display of the 3D content according to the Side-by-Side method or the Top-and-Bottom method). The system controller unit 51, receiving the instruction mentioned above, instructs the video conversion controller unit 61 to output the 2D video. The video conversion controller unit 61, receiving the instruction mentioned above, controls the video conversion processor unit 32 to execute the 2D video output of the inputted video signal mentioned above.

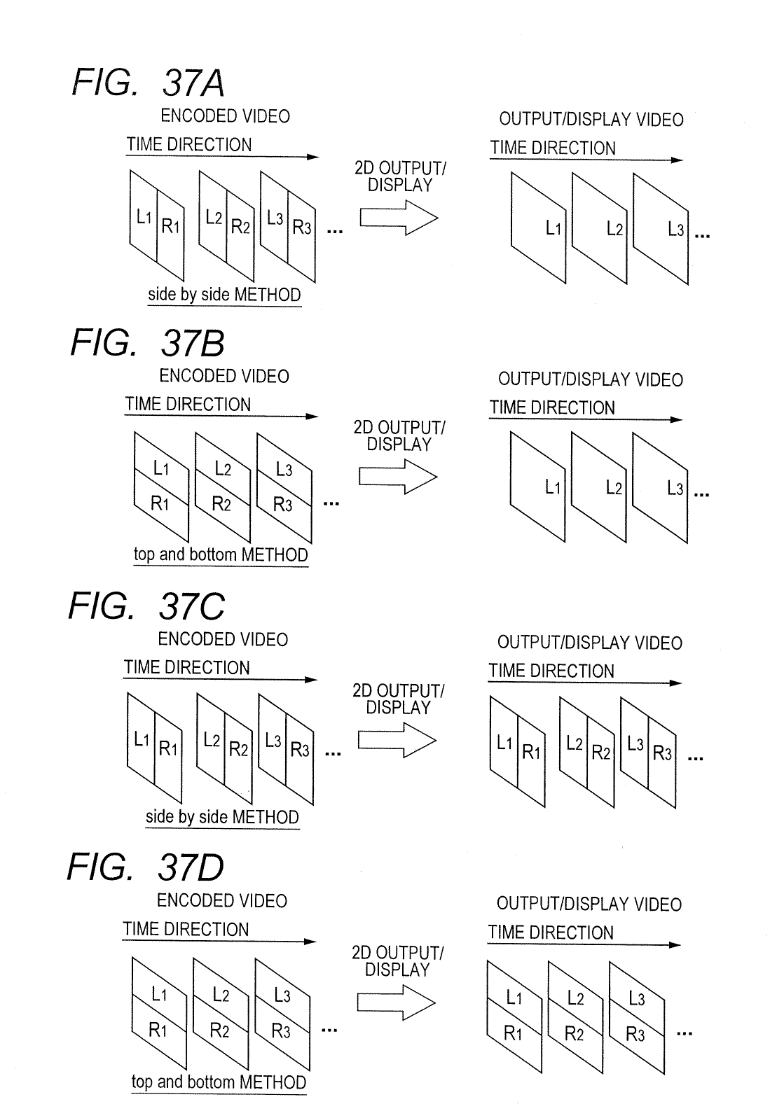

Explanation will be given about the 2D output/display method of videos, by referring to FIGS. 37A and 37B. FIG. 37A illustrates the explanation of the Side-by-Side method and FIG. 37B illustrates that of the Top-and-Bottom method, respectively, and either one thereof differs from only in the arrangement of the video for the left-side eye and the video for the right-side eye in the video; therefore the explanation will be made by referring to the Side-by-Side method shown in FIG. 37A. The frame lines (L1/R1, L2/R2, L3/R3, . . . ) on the left side in the figure present the video signals of the Side-by-Side method, wherein the picture for the left-side eye and the picture for the right-side eye are arranged on the left-side/right-side of one (1) frame. In the video conversion processor unit 32, after dividing each frame of the video signal of the Side-by-Side method into left/right, e.g. the video for the left-side eye and the video for the right-side eye, for each frame, the scaling is treated with only portions of the main aspect video (the video for the left-side eye), and only the main aspect video (the video for the left-side eye) is outputted as the video signal, as shown by the frame lines (L1, L2, L3, . . . ) on the right-hand side in the figure.

The video conversion processor unit 32 outputs the video signal, on which the above-mentioned process is treated with, as the 2D video from the video output 41, and outputs the control signal from the control signal 43.

However, also examples of executing the 2D output/display while keeping the 3D contents of the Side-by-Side method and the Top-and-Bottom method received as the 2 aspects in one (1) video or picture are shown in FIGS. 37C and 37D. For example, as shown in FIG. 33, in case where the receiving apparatus and the viewing apparatus are constructed, separately, an output may be made while keeping the videos of the Side-by-Side method and the Top-and-Bottom method stored as the 2 aspects in one (1) video or picture, and converted in the viewing apparatus, for the 3D display.

### <Example of 2D/3D Conversion>

Explanation will be given on an example when the 2D video (the video not having depth information and/or parallax information) is converted into the 3D video.

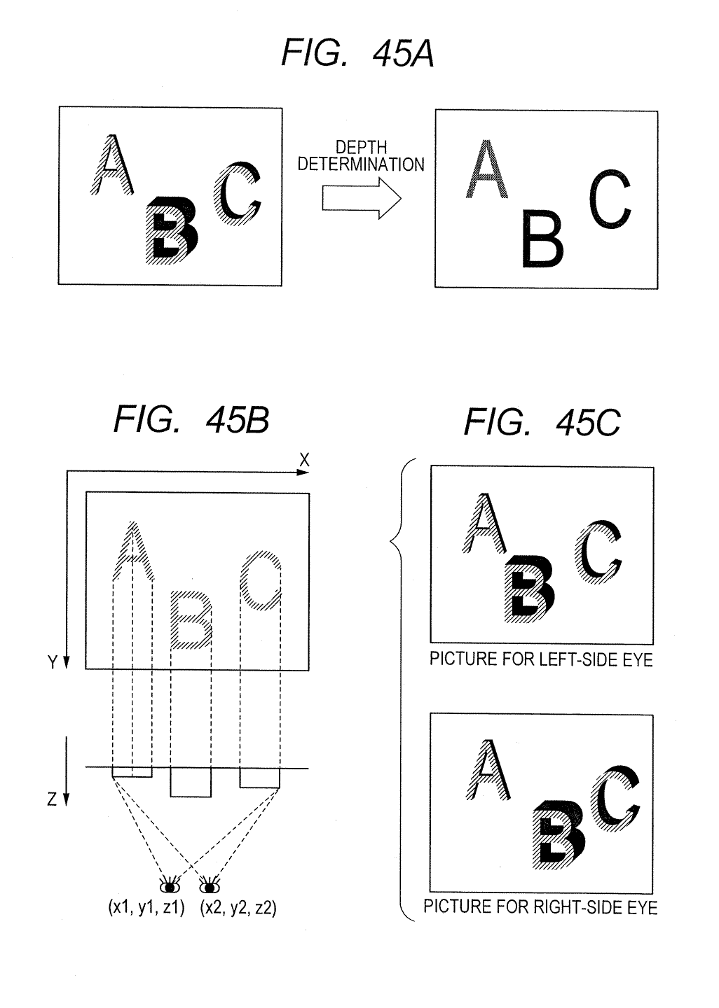

Analysis is made on the 2D video for each picture, and comparison is made on stereoscopic determination elements (form of a body (size, shape), color difference, brightness, chroma, contrast, sharpness of the body, change of shading, position of the body (layout), or determining stereoscopic relationship by conducting filtering process, etc.), and thereafter, depth information (depth-map) is produced for each pixel or region. An example of the depth information is shown in FIG. 45A. The depth information is assigned to each region, for example, “+5” to a region A (background object(s)), “+20” to a region B (an object on the forefront), “+10” to a region C assigned in a middle therebetween, and “0” to a background, etc. In the figure is shown an example of the depth-map where the deeper of the color (black color) is, the nearer to a front.

In this example, it is assumed that the depth is uniform for each object; however, the depth may change within an object, and therefore there can be considered a depth-map by a unit of pixel. In that case, the depth information can be defined by the unit of pixel, then it is possible to emphasize 3D of the picture, much more; however, there are cases where an amount or volume of calculation becomes large. Also, about a numerical value of the depth information may be an arrangement of assigning “0” to the forefront and a small value (a minus value) to the pixel or layer, which is determined to locate in the depth than that, relatively.

Next, upon basis of the depth information mentioned above, a virtual stereoscopic vision of the picture is obtained (for example, the pixel is allocated at a position (x, y, z) on 3D plane). an example of that is shown in FIG. 45B. The horizontal axis in an upper part of the figure indicates an X-coordinate, the vertical axis in the upper part thereof a Y-coordinate, and the horizontal axis in a lower part of the figure a Z-coordinate, respectively. A plane view (projection) seeing the stereoscopic picture from a specific position (for example, x1, y1, z1) is used as the picture for the left-side eye (an upper in FIG. 45C), and a plane view (projection) seeing the stereoscopic picture from other specific position (for example, x2, y2, z2) is used as the picture for the right-side eye (a lower in FIG. 45C). Doing in this manner, it is possible to produce the picture for the left-side eye and the picture for the right-side eye, from the plane picture, through calculation.

With processing the picture for the left-side eye and the picture for the right-side eye, which are produced in this manner, in the similar manner to the 3D output method of the 3D content mentioned above, display of the picture can be made in 3D.

Also, as other method, there is a method of determining the depth information for plural numbers of frames, by calculating the stereoscopic determining element with using plural numbers of video frames, or distinguishing between a dynamic object (i.e., an object having movement. For example, an object having a motion vector, a vector quantity of which is equal to or greater than a predetermined value) and a background or a static object (an object having no or less movement. For example, an object having a motion vector, a vector quantity of which is smaller than the predetermined value), and thereby calculating the depth information in such a manner that the motive object comes close to a front surface to be cubic, etc.

Also, in other method, there is a method of treating one (1) frame of continuing frames having a movement (for example, a frame at time “t”) as the picture for the left-side eye, and treating the frame at other time (for example, a frame at time “t+a”) as the picture for the right-side eye. With such method, there is a merit that it can be done with less volume of calculation; however, there is a demerit that the 3D picture converted is hardly seen in 3D, other than a specific movement (for example, the motive object moves horizontally on the static screen).

Also, relating to portion, which cannot be viewed by a specific frame (i.e., not photographed), there is a method of supplementing the video information from other frame(s), and thereby making up the pictures for both eyes.

With those 2D/3D conversion methods, it is possible to produce a picture that can be recognized to be 3D, easily, for the user, with an accuracy much higher, by combining plural numbers of the determining elements and/or the processing methods.

<Example of Video Display Processing Flow Fitting to User Condition, when Program Changes>

Next, explanation will be given on the output/display process when the broadcasting method (the 3D program and the transmission method thereof, the 2D program) is changed of the program, which is under viewing/listening at present. When the broadcasting method is changed of the program, which is under viewing/listening at present, and if the method for processing the video is not changed within the receiving apparatus, in particular, there is a possibility that a normal video display cannot be performed, and therefore loosing a convenience for the user. Contrary to this, by executing the processes, which will be shown below, it is possible to improve or increase up the convenience for the user.

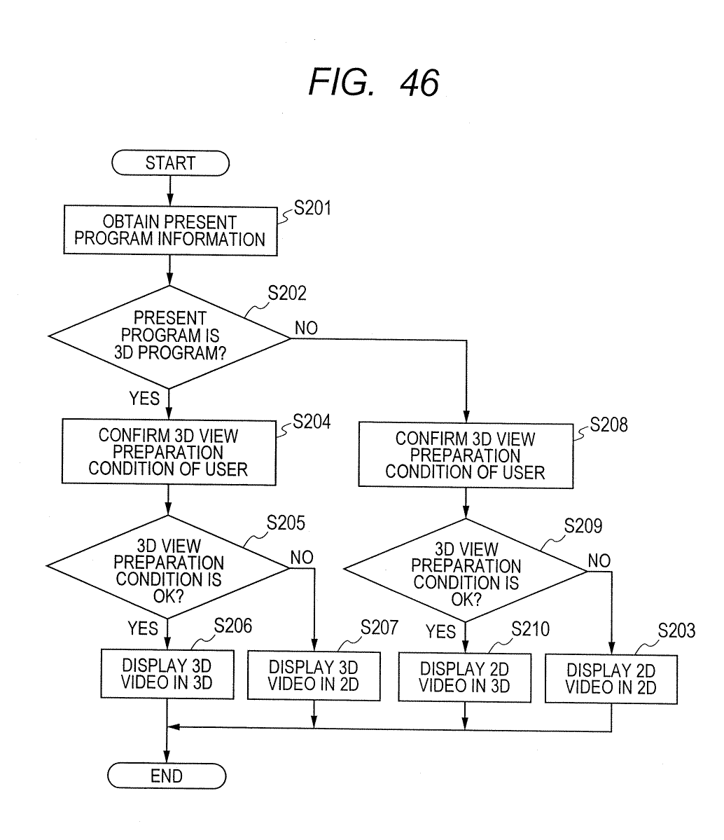

FIG. 46 shows an example of the process flow within the system controller unit 51, which is executed at an opportunity, such as, changing of the present program or the program information, at the time when the program is exchanged or switched.

The system controller unit 51 obtains the program information of the present program from the program analyzer unit 54, thereby to determines on whether the present program is the 3D program or not, according to the determining method of the 3D program, and further it obtains the 3D method type of the present program (such as, the 2 aspects separated ES transmission method/the Side-by-Side method, etc., determined from the 3D method type described in the 3D program details descriptor), at the same time (S201). However, the program information of the present program may be obtained, not limited to the time when the program changes, but may be obtained periodically. If obtaining the program information, periodically, it is effective in the case where the 3D video and the 2D video are mixed up within the same program.

As a result of determination, if it is the 3D program (“yes” of S202), then next, confirmation is made on a 3D view preparation condition of a user (S204).

The 3D view preparation condition means a condition where the user makes preparation for viewing/listening the 3D video or picture. For example, after pushing down the “3D” button on the remote controller, and in particular, like a case when the user selects “see 3D” on an exchange display of 3D/2D, such as, shown in the menu of FIG. 50, i.e., when the fact that the user shows or presents her/his intention of viewing/listening the 3D program is transmitted to the receiving apparatus, passing through the user operation input unit 45, for example, then the system controller unit 51 sets the 3D view preparation condition to “OK”, and holds the condition thereof.

Also, determination of the 3D view preparation condition of the user, other than that, may be made by a user wearing completion signal, generated by the 3D view support device, or while photographing the viewing/listening condition of the user by a photographing device or apparatus, so as to execute an image recognition or a face recognition of the user from the result of photographing, the determination may be made that she/he wears or put on the 3D view support device.

Also, as the operation for determining the 3D view preparation condition to be “NG”, for example, when the fact that the user presents an intention of not viewing/listening the 3D program, through her/his action, for example, the user wears outs the 3D view support device, or pushes down the “2D” button on the remote controller, is transmitted to the receiving apparatus, passing through the user operation input unit 45, for example, then the system controller unit 51 sets the 3D view preparation condition to “NG”, and holds the condition thereof.

When the 3D view preparation condition of the user is “OK” (“yes” of S205), the 3D content is outputted in 3D, in the format corresponding to the 3D method type, respectively, according to the method mentioned above (S206).

Also, when the 3D view preparation condition of the user is not “OK” (“no” of S205), the system controller unit 51 controls so as to display one aspect (for example, the main aspect) of the 3D video signal in 2D, in the format corresponding to the 3D method type, respectively, according to the method explained in FIG. 35 and FIGS. 37A and 37B (S207). In this instance, a display indicating to be the 3D program may be made, being superimposed on the 2D display picture of the program.

As a result of determination of step S202, if the present program is not 3D (“no” of S202), similar to the mentioned above, confirmation on the 3D view preparation condition of the user (S208), as well as, determination (S209) are executed. As a result of the determination, if the 3D view preparation condition of the user is “OK” (“yes” of S209), according to the method mentioned above, the 2D/3D conversion is executed on the video, thereby displaying the video in 3D (S210).

Herein, there can be considered the case where a mark indicative of being executing the 2D/3D conversion (2D/3D conversion mark) is displayed, when executing the 2D/3D conversion, thereby outputting the video. In this case, the user can distinguish between the 3D provided by the broadcast and the 3D produced by the apparatus, and as a result thereof, the user can also decide to stop the 3D viewing/listening thereon.

Also, herein, in case where the apparatus has no 2D/3D converting function, the 2D/3D video may be controlled to output in 2D as it is, without controlling the 2D/3D conversion in the step S210.

Also, when the 3D view preparation condition of the user is not “OK” (“no” of S209), the system controller unit 51 controls the broadcast signal of 2D to be outputted in 2D as it is (S203).

In this manner, determination is made on the broadcasting method of the present broadcast (the 3D program and the transmission method thereof, the 2D program) and on the 3D view preparation condition of the user, and thereby it is possible to output the video in the format suitable to them, automatically.

Herein, as the method for determining the 3D program, by making the determination on whether to be the 3D program or not or determination of the 3D method type, with using the descriptor stored in the user data region or additional information region, which is encoded together with the video, it is possible to control the conversion mentioned above by a unit of frame, and thereby improving the convenience or operability of the user.

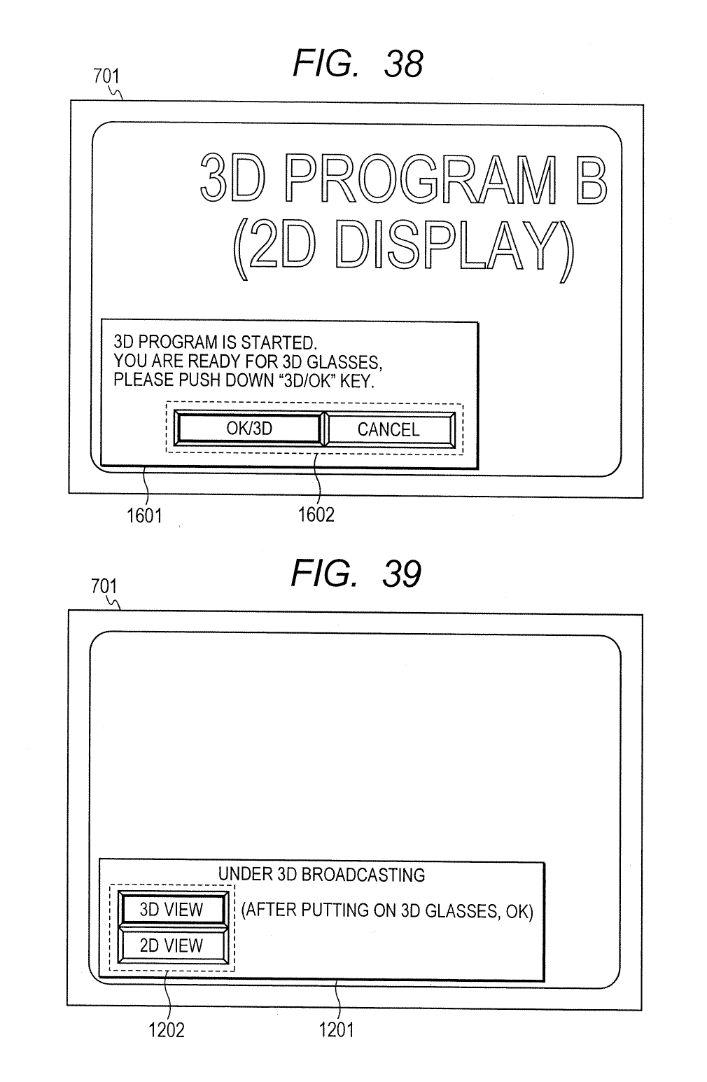

FIG. 38 shows an example of a message, for example, used for display the 3D broadcast video in 2D in the step S207, as well as, to be displayed on the OSD producer unit 60 by the system controller unit 51. The message for noticing the user that the 3D program is started is displayed, and further an object 1602, to which the user makes a response (hereinafter, a user response receiving object: for example, a button on OSD), is displayed, thereby asking the user to select the operation thereafter.

In case where the user pushes down the “OK” button on the remote controller, for example, when displaying the message 1601, the user instruction receiver unit 52 notices that the “OK” button is pushed down, to the system controller unit 51.

As an example of the method for determining the user selection on the screen display shown in 38, when the user operates the remote controller and pushes down the “3D” button, or when she/he adjust a cursor to “OK/3D” button on the screen and pushes down a “OK” button, determination is made that the 3D view preparation condition is “OK”.

Or, when the user pushes down a “Cancel” button or a “Return” button on the remote controller, or when she/he adjusts the cursor to “Cancel” on the screen and pushes down “OK” on the remote controller, the 3D view preparation condition is determined to be “NG”. Other than this, when such an operation to bring the 3D view preparation condition mentioned above into “OK” is done, then the 3D view preparation condition is changed to “OK”.

After the user makes the selection mentioned above, the flow shown in 46 is executed, again, in the system controller unit 51.

With this, even when the 3D program is displayed in 2D, under the condition where the user is “NG” of the 3D view preparation condition, it is possible to inform the user that the 3D program starts, and also to notice that the 3D view preparation condition is in “OK” to the apparatus, easily. Upon those results, the user can decide starting of the 3D program, and can change or switch to the 3D video or picture, easily; thereby enabling to provide a viewing/listening method fitting to convenience of the user.

However, in the example of display shown in FIG. 38 is displayed the object to be used for the user to response; however, it may be a display of characters, a logo or a mark, etc., simply indicating that the corresponding program is compatible or operable with “3D viewing/listening”, such as, simply “3D program”, etc. In this instance, the user recognizing that the program is compatible or operable with the “3D viewing/listening”, after pushing down the “3D” key on the remote controller, may exchange from the 2D display to the 3D display, upon opportunity of the notice to the system controller unit 51 from the user instruction receiver unit 52.

Further, as other example of the message display displayed in the step S207, not only displaying “OK” simply, as shown in FIG. 38, but also can be considered a method of indicating clearly on whether the display method of the program should be the 2D video or the 3D video. Examples of the message and the user response receiving object in such case are shown in FIG. 39.

With doing so, comparing to the display of “OK” as shown in FIG. 38, the user can, not only decide the operation after pushing down of the button, much more easily, but also give an instruction of display in 2D, more clearly, etc. (when pushing down “view in 2D” shown by 1202, the user view preparation condition is determined “NG”); thereby increasing the convenience for the user.

The message display to each user, which are explained in the present embodiment, preferably, is deleted after the operations made by the user. In such case, there can be obtained a merit that the picture can be viewed, easily. Also, when passing a predetermined time-period, similarly, it can be considered that the user already recognize the information of message, then the message is deleted and thereby bringing the picture to be seen, easily, and thereby increasing the convenience for the user.

Further, even in case where the present program is changed after conducting the tuning operation, the flow mentioned above is executed within the system controller unit 51.

### <2D/3D Conversion Priority Process in Apparatus>

Herein, explanation will be given about a method for displaying a picture having no depth (being 2D), in spite of the fact that the broadcast signal is of the 3D transmission method, in a part or the entire 3D program. Under such condition or situation, i.e., when the user enjoys viewing/listening with considering to be the 3D program, there occur cases where the user receives an uncomfortable feeling or displeasure, if a plane picture having no depth is outputted, suddenly. Also, in case where much higher 3D video can be outputted by the 3D video obtained through the 2D/3D conversion within the apparatus, than the 3D video included in the original content, it is possible to increase the convenience for the user, by outputting the video obtained through the 2D/3D conversion of the apparatus.

First of all, explanation will be given about the method for determining depth of the picture of 3D program. The picture having less depth can be considered the picture having less difference, between the pictures of separated aspects (hereinafter, “separated aspect picture(s)”), for the left-side eye and the right-side eye, respectively. Then, as an example, there is a method for determining the picture having no depth, when the difference is lower than a predetermined value, by calculating the difference of numerical values, such as of R, G and B or Y, U and V, respectively, for example, for each pixel being same of the position of the picture display, on the separate aspect picture, and then comparing a total sum of those differences to a difference of the picture, as a predetermined value.

In more details thereof, in case of the picture, i.e., the 3D transmission method thereof is “Side-by-Side”, size in the horizontal direction of the entire picture is “X” (thus, size in the horizontal direction of the picture each aspect is “X/2”), and size in the vertical direction thereof is “Y”, the difference can be calculated by the following equation (1), if comparing the difference of the separate aspect picture by Y, U and V components:

$${\sum }_{b = 0}^{Y} {\sum }_{a = 0}^{X / 2} [ \begin{matrix}\begin{matrix}\{ Y ( a , b ) - Y ( a + X / 2 , b ) \} + \\ \{ U ( a , b ) - U ( a + X / 2 , b ) \} +\end{matrix} \\ \{ V ( a , b ) - V ( a + X / 2 , b ) \}\end{matrix} ] \leq D \qquad ( 1 )$$

Where, the left-hand side presents the total sum of the difference values of the YUV components of the picture, and the right-hand side is a constant value (herein, D). Also, an equation, Y(x,y) indicates a value of Y component of the picture on (x,y) coordinates thereof, and also U(x,y) and V(x,y) are similar to.

Herein, with calculation while setting the constant value (d) to “0”, determination can be made that it is the picture having no depth, only if the pictures of 2 aspects coincide with, completely (namely, the condition that there is completely no depth information).

As the method for determining, other than the example of difference of each pixel, there are methods, such as, comparing histogram of each element of both pictures (for example, Y, U and V, or R, G and B), or comparing the difference, relating to a result of calculating a specific digital filter (for example, a high-pass filter) on both pictures, etc.

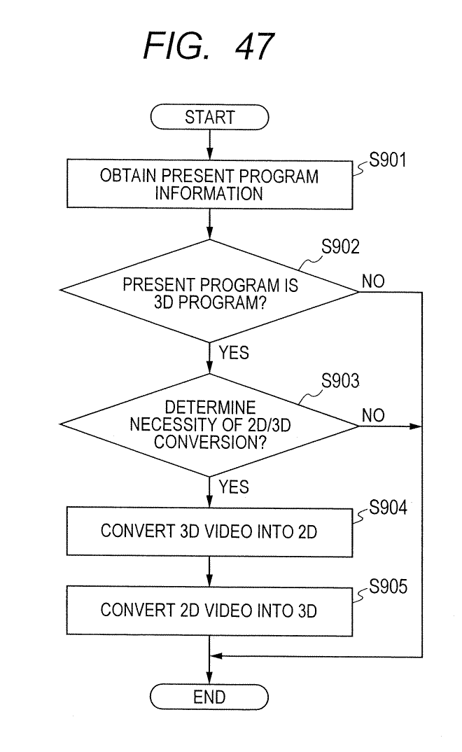

Explanation will be given about a processing flow of the system controller unit 51, applying those depth determinations therein, by referring to FIG. 47. The system controller unit 51 obtains the program information of the signal inputted (S901), and determines on whether the present program is the 3D program or not (S902). If determined the present program is not the 3D program (“no” of S902), no process is executed, in particular. If determined the present program is the 3D program (“yes” of S902), then the process is carried out, continuously.

Next, determination is made on whether the process of converting from the 2D video to the 3D video is necessary or not (2D/3D conversion necessity determination) (S903). As a method for determining, the result of determination of the depth mentioned above is applied, for example. Thus, the 2D/3D conversion is determined necessary, when the pixel difference of the picture is equal to or less than a predetermined value (i.e., the equation (1) is true), while determining the 2D/3D conversion unnecessary, when the pixel difference of the picture is equal to or greater than the predetermined value (i.e., the equation (1) is false). When determination is not made that the 2D/3D conversion is necessary (“no” of S903), no process is executed, in particular.

On the other hand, when determination is not made that the 2D/3D conversion is necessary (“yes” of S903), the 3D video is converted into 2D (S904). As a method of conversion, for example, when displaying the 3D video mentioned above in 2D, the 2D video is outputted according to the method described. Next, on the above-mentioned 2D video converted, the 2D/3D conversion is executed, according to the method mentioned above (S905).

As was mentioned above, in case of the 3D picture having no sense of depth, for example, with execution of the 2D/3D conversion of the video on side of the apparatus, it is possible to obtain the sense of depth.

Although the explanation was made on the example of making the determination of necessity by analyzing the picture, in the determination of necessity of the 2D/3D conversion; however, after determining the 2D/3D conversion with using a flag included in the signal (for example, a 2D/3D conversion flag), the process mentioned above may be executed. With this, for the transmitting side, it is possible to notice the receiving side of being the picture, upon which the 2D/3D conversion may be executed or should be executed, with using the flag, and thereby enabling to control the necessity/unnecessity of execution of the 2D/3D conversion in the receiving apparatus.

Also, by executing the control with using the flag mentioned above on the receiving apparatus side, it is possible to provide a picture that can be considered appropriate for the 2D/3D conversion, after executing the conversion thereon. Also, the processes, such as, the depth determining process, etc., in the example mentioned above, are unnecessary, thereby bring about a merit that the processing load in the apparatus can be lighten or reduced.

As a position where the 2D/3D flag should be inserted, there can be considered a method of describing it at the position similar to the position where the information is described in the example of the determining method of the 3D program mentioned above. In case of describing into the program information, since frequency of renewing is low, there can be obtained a feature that the processing load for confirming the flag is reduced within the apparatus, and if inserting it within a header of the video signal, although there is also a possibility of increasing the processing load for confirming the flag; however, it is possible to confirm the flag by a unit of stream of video, and there is a case that quality of the picture to be provided can be improved, by switching the flag by the unit of frame, for example.

In case where the flag mentioned above is not included in the signal, it may be treated, as “the 2D/3D conversion is inhibited”, or on the contrary thereof, as “the 2D/3D conversion is permitted”, for example.

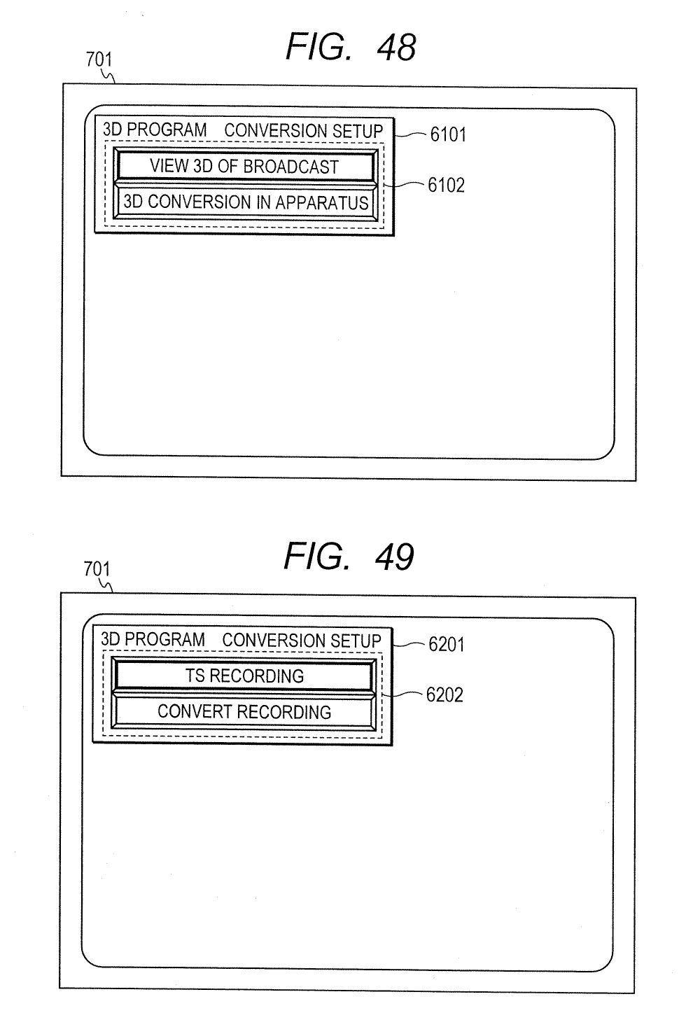

Or, as other method for determining the necessity of the 2D/3D conversion, there can be considered a method of determining it depending on setup made by the user. For example, with using the screen of user setup as shown in FIG. 48, the setup made by the user is determined. Herein, where the user operates GUI on the screen with using the remote controller, etc., for example, and selects “view 3D of broadcast” on choices of 6102, the necessity of the 2D/3D conversion mentioned above is determined “no”, and where she/he selects “3D conversion on apparatus”, the necessity of the 2D/3D conversion mentioned above is determined “yes”.

Also with a method other than those mentioned above, the user setup may be switched by pushing-down of the button on the remote controller (for example, “3D on apparatus/3D on broadcast switching button”). In this manner, if the user determines the necessity of the 2D/3D conversion by her/himself, it is possible to display a preferable one, between the 3D picture, which is already given to the video by the user, intentionally, or the picture 2D/3D converted on the apparatus.

Also, as further other method for determining the necessity of the 2D/3D conversion, for example, in case that there is no video information of any aspect (for example, the stream of sub-aspect (for the right-side eye) is not transmitted), within the streams, which are transmitted by the 3D 2-aspects separated ES transmitting method, etc., it is preferable to determine the 2D/3D conversion is necessary. With making such determination, it is possible to output the video converted into 3D within the apparatus, automatically, such as, where there is only the picture of an aspect of one side (for example, where the ES of the one side is not transmitted with the 3D 2-aspects separated ES transmitting method). In this case, in the step S904 shown in FIG. 47 may be executed no process, in particular.

Determination of necessity of those 2D/3D conversions may be made, combining the conditions, respectively. For example, even in the case where the 2D/3D flag is “not need conversion”, if determination of the picture is “need conversion” and the selection made by the user is “need conversion”, the 2D/3D conversion is executed, etc., i.e., it is possible to execute the 2D/3D conversion fitting to a favor of the user much more, by determining it depending on the respective priorities and/or combinations.

### <Recording of Converted Content>

Having done a convert recording of the video, which is 2D/3D converted as mentioned above, it is not necessary to execute the similar process when reproducing; therefore, the processing load when reproducing is lightened or reduce, and further delay is lessened on display. Or, outputting the content, which is 2D/3D converted and the convert recording is made thereof, to an outside (for example, a high-speed digital I/F output, or a network output), there can be obtained a merit that the 2D/3D converted video can be viewed/listened or enjoyed on an external equipment having no 2D/3D converting function.

When executing the convert recording accompanying the 2D/3D conversion, it is preferable to change each descriptor or flag, etc., into the content that shows “3D”, in particular, the descriptors or the flags, etc., which are applied in the method for determining the 3D program mentioned above, within the video encoder unit 35 or the multiplex divider unit 37, etc. Also, with description of the 3D method type converted, it is preferable to adapt the 3D method type to be applied above-mentioned method for determining the 3D program, too, fitting to the above-mentioned content, which is converted.

Also, when executing the convert recording, the information described in the program information (for example, EIT) shows 3D, and in case where the information described in the stream (for example, a user data area of MPEG) shows 2D, etc., it is preferable to execute the 2D3D conversion, automatically. This is because there can be assumed a case where the video is changed from 3D to 2D on the way of the program, and in such case, the video of the entire program is changed to 3D by executing the 2D/3D conversion, and thereby it is possible to increase the convenience for the user when viewing/listening the reproduction.

About setting up of recording format for executing TS recording or the convert recording, there can be considered a method of selecting the recording format depending on selection by user, while setting up a selection content in advance by the user. It is possible to make the following operation; such as, execute TS recording as recording, even if the picture under the viewing/listening is the 2D/3D converted video, or on the contrary to that, execute the convert recording accompanying the 2D/3D conversion on the recording side, but without executing the 2D/3D conversion on the video to be viewed, etc., and it is possible to increase the convenience for he user.

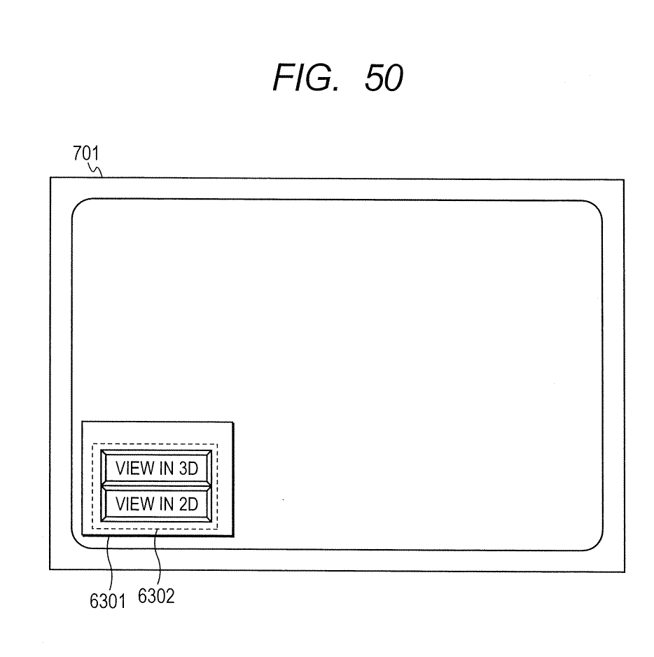

An example of a setup screen for the setup mentioned above is shown in FIG. 49. This screen may be a format to be set up every time for each of the programs reserved, for example, a method of setting up by operating a GUI screen, such as, “Menu”, “Various Setup”, etc., or for example, executing the reserved recording of the program, etc., such as, every time when registering the program reservation.

### <Example of Flow of 2D/3D Video Display Process Based on if Next Program is 3D Content or Not>

Next, explanation will be given about an output/display process of content when the next program is 3D content. Relating to viewing/listening of a 3D content program in case where the next program is 3D content, i.e., of said next program, if display of the 3D content is started, in spite of the fact that the user is not under the condition of viewing/listening the 3D content, then the user cannot view/listen that content under the best condition, therefore there is a possibility of loosing the convenience of the user. On the contrary to this, with execution of the following processes, it is possible to increase the convenience for the user.

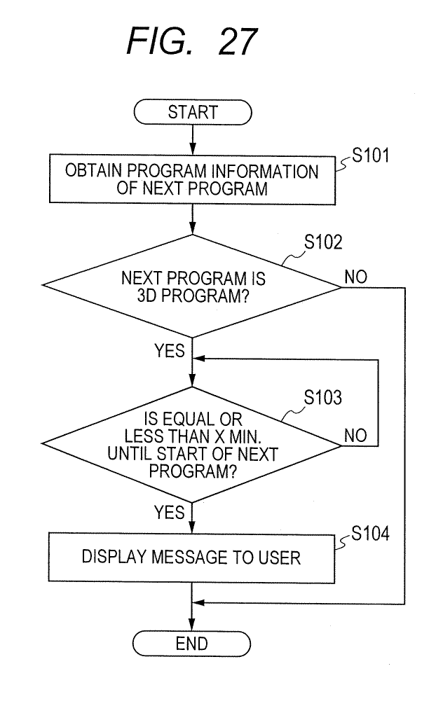

In FIG. 27 is shown an example of flow to be executed in the system controller unit 51, in case where the time until start of the next program is changed due to tuning process, etc., or in case where determining that starting time of the next program is changed, upon the information of the starting time of the next program or ending time of the present program, etc., which are transmitted from the broadcast station. Firstly the system controller unit 51 obtains the program information of the next program from the program information analyzer unit 54 (S101), and determines on whether the next program is the 3D program or not, in accordance with the method for determining the 3D program mentioned above.

When the next program is not the 3D program (“no” of S102), the process is ended, but without executing processes, in particular. When the next program is the 3D program (“yes” of S102), time up to starting of the next program is calculated. In more details, the starting time of the next program or the ending time of the present program are obtained from EIT of the program information mentioned above, which is obtained, and obtains the present time from the time management unit 55, thereby calculating the difference thereof.

When it is not equal to or less than X min. until starting of the next program (“no” of S103), the system controller unit waits for, without executing the process, in particular, until the time, i.e., X min. before starting of the next program. When it is equal to or less than X min. until starting of the next program (“yes” of S103), a message indicative of that the 3D program will start, soon, is displayed to the user (S104).

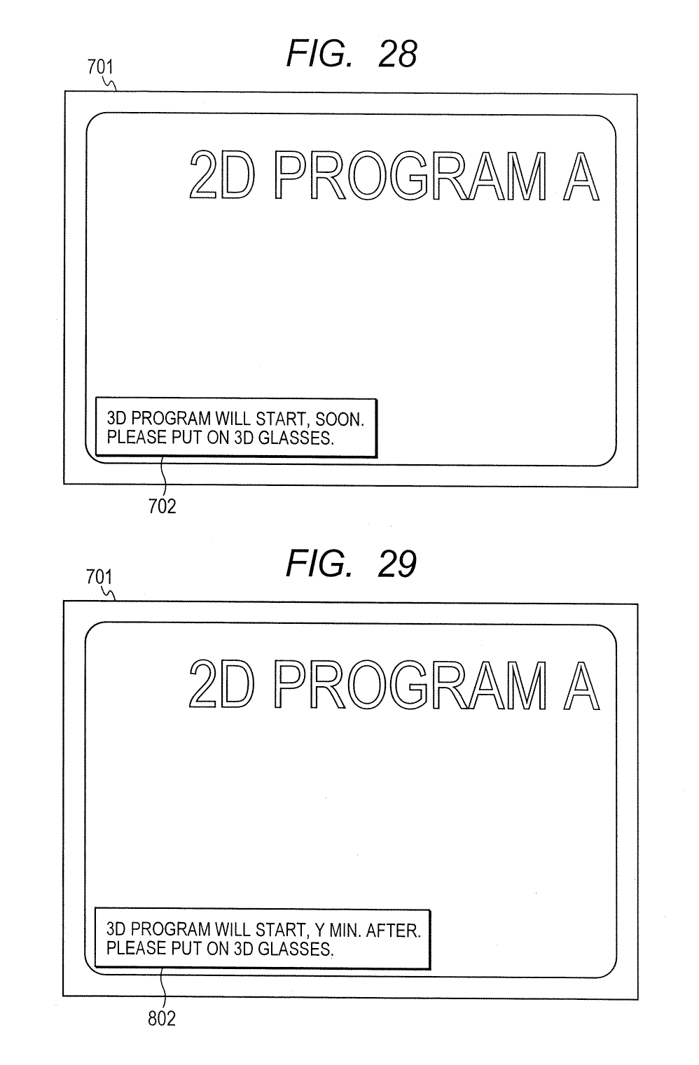

FIG. 28 shows an example of the display of the message at that instance. A reference numeral 701 depicts the entire screen displayed on the apparatus, 702 shows the message displayed on the apparatus. In this way, it is possible to prompt an attention to the user to prepare the 3D view support device.

About the determination time X until starting of the program, if making X small, there is brought about a possibility the 3D view preparation by the user is not in time. Also, when making X large, there can be considered demerits, such as, display of the message for a long time becomes an obstacle of the viewing/listening, an interval is made after completion of the preparation; therefore, it is necessary to adjust it to an appropriate time-period.

Also, when displaying the message to the user, the starting time of the next program may be displayed in details thereof. An example of the display on the screen in that case is shown in FIG. 29. A reference numeral 802 depicts the message indicating the time until starting of the 3D program. Herein, it is described by a unit of minute, but may be described by a unit of second. In that case, although the user can notice the starting time of the next program in details thereof; however, there is a demerit that the processing load is increased to be high.

However, although the example of the time-period until the 3D program is started is shown in FIG. 29; however, the time when the 3D program is started may be displayed. When the 3D program will be started at 9 o'clock PM, there may be displayed a message, such as, “3D program will starts from 9 o'clock PM. Please put on 3D glasses”, etc., for example.

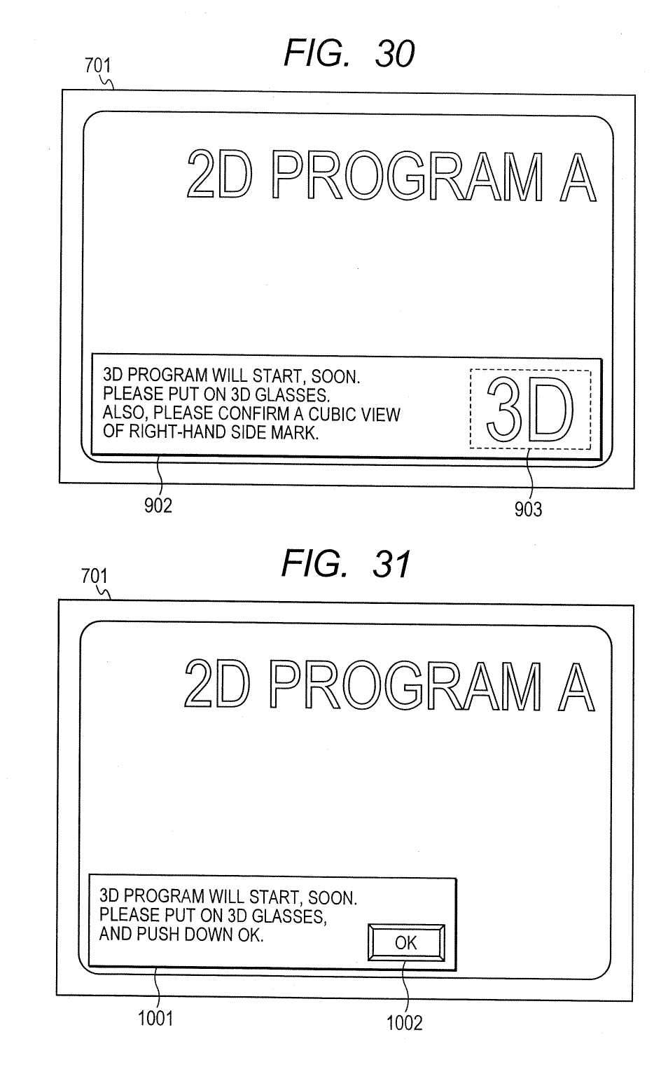

Also, as is shown in FIG. 30, there can be considered to add a mark, which can be seen in cubit when wearing the 3D view support device (a 3D check mark). A reference numeral 902 depicts a message for announcing the start of the 3D program, and 903 depicts the mark that can be seen in cubit when wearing the 3D view support device. With this, it is possible for the user to confirm or check the normal operation of the 3D view support device. For example, if something wrong (for example, shortage of a battery, or malfunction) generates on the 3D view support, for the user, it is possible to deal with, such as, repair or exchange, etc., until the time when the program starts.

Next, explanation will be given about the method for determining a condition of whether the 3D view preparation is completed or not, and thereby changing the video to the 2D display or the 3D display, after noticing to the user that the next program is 3D.

The method for noticing to the user that the next program is 3D is as was mentioned above. However, this differs from that mentioned above, in an aspect that, in particular, about the message to be displayed to the user in the step S104, it is an object to be responded by the user (hereinafter, a user response receiver object: for example, a button on OSD). An example of this message is shown in FIG. 31.

A reference numeral 1001 depicts a message, as a whole, and 1002 a button, for the user to make a response, respectively. When displaying the message 1001 shown in FIG. 31, if the user pushes down the “OK” button on the remote controller, for example, the user instruction receiver unit 52 informs the system controller unit 51 that the “OK” button is pushed down.

The system controller unit 51 receiving that information mentioned above reserves the fact that the 3D view preparation condition of the user is “OK” as the condition. Next, after time passes by, when the present program becomes the 3D program, the process flow in the controller system unit 51 is same to the video display process fitting to the user condition when the program changes, as was explained in the above.

Also, in the example mentioned above, there can be considered that the process is executed by only determining the program information of the next program, which was obtained previously. In this case, there can be also considered a method of using the program information, which is obtained previously (for example, in the step S101 shown in FIG. 27), without determining on whether the present program is the 3D program or not. In this case, there can be considered a merit that processing structures come to simple, etc., but there is a demerit having a possibility that the 3D video exchange process is executed even when the program structure is changed, suddenly, so that the next program is not the 3D program.

With such message display to each user as was explained in the present embodiment, it is preferable to be deleted after the operation by the user. In such case, there can be obtained a merit that the user is able to view/listen the picture, easily, after she/he makes the operation. Also, after passing a predetermined time-period, similarly, by considering that the user already notices the information of the message, the message is deleted, and thereby brought into the condition that the picture can be viewed, easily; this increases the convenience of the user.

With the embodiment explained in the above, on a scene where the 3D program and the 2D program are exchanged, etc., it is possible to execute the most suitable exchange control judging from the condition of the user and the condition of the broadcast program, and also, with the picture displayed at that occasion, it is possible to provide the most suitable 3D picture to the user, by executing the 2D/3D conversion judged from the characteristic of the picture, the condition of the broadcast signal, and the setup values made by the user.

Also, bringing the converted video mentioned above into be recorded, there can be expected to have the following effects: i.e., enabling reduction of the load when reproducing/displaying and/or the delay, the most suitable display of the picture at a point of exchanging of the picture also upon the reproduction by the equipment having no such 2D/3D converting function, etc.

In the explanation given in the above, the explanation was given on the example of transmitting the 3D program details descriptor, which was explained in FIG. 10A, disposing on the table, such as, PMT (Program Map Table) or EIT (Even Information Table), etc. In the place of this, or in addition to this, the information included in said 3D program details descriptor may be transmitted, storing it in the user data area or region of the additional information region or area, which is encoded together with the picture when encoding the picture. In this case, those information may be contained within the video ES of the program.

As the information to be stored can be listed up: “3d_{—}2d_type” (3D/2D type) information, which is explained in FIG. 10B, or “3d_method_type” (3D method type) information, which is explained in FIG. 11, etc. However, when storing them, “3d_{—}2d_type” (3D/2D type) information and “3d_method_type” (3D method type) information may be treated as separate information, or as the information for discriminating both, the type thereof, the 3D picture or the 2D picture, and the information for identifying to which 3D method that 3D picture belongs, in combination.

In more details, if the picture coding method is the MPEG 2 method, the coding may be done on the user data area or region following “Picture header”, and “Picture Coding Extension”, including the 3D/2D type information and the 3D method type information therein.

Also, if the picture coding method is the H.264/AVC method, the coding may be done on the additional information included in an access unit (supplemental enhancement information), including the 3D/2D type information and the 3D method type information therein.

In this manner, transmitting the information indicative of the type of the 3D picture or the 2D picture, and/or the information indicative of the type of the 3D method, on a coding layer of the picture within ES brings about an effect that the picture can be identified by a unit of frame (or picture).

In this case, since the identification or discrimination mentioned above can be made by a unit shorter than that when storing it into PMT (Program Map Table), it is possible to improve or increase the response speed of a receiver in response to the exchange between 3D video/2D video on the picture transmitted, and therefore noises, having a possibility of generating at the time of exchanging between 3D video/2D video, can be suppressed, much more.

Also, in case where no 3D program details descriptor mentioned above is disposed on the PMT (Program Map Table), but in case of storing the information mentioned above on the video/picture coding layer, which is encoded together with the picture when encoding the picture, in particular, when 2D/3D mixture broadcast is started, newly, at the conventional broadcast station, for example, for the broadcast station side, it is sufficient to renew only the encoder unit 12 in the transmitting apparatus 1 shown in FIG. 2, into the structures enabling the when the 2D/3D mixture broadcast; i.e., there is no necessity of alter the structures of the PMT (Program Map Table) added in the management information assignment unit 16, and thereby enabling to start the 2D/3D mixture broadcast with low costs.

However, if the 3D relation information, such as, “3d_{—}2d_type” (3D/2D type) information and/or “3d_method_type” (3D method type) information, etc. (in particular, the information for identifying the 3D/2D), is not stored in the predetermined region(s) or area(s), such as, the user data area or region and/or the additional information region or area, which is/are encoded together with the picture when encoding the picture, then the receiver may be constructed so that it determines such video is the 2D picture. In this case, the broadcast station can omit to storage of those information when processing the encoding, regarding the 2D picture, and it is possible to reduce the number of steps for processing in broadcasting.

In the explanation given in the above, as the example of disposing or arranging the identification information for discriminating or identifying the 3D video, by a unit of the program (event) or a unit of service, the explanation was made on the example of including it in the program information, such as, the component descriptor, the component group descriptor, the service descriptor and the service list descriptor, etc., or the example of providing the 3D program details descriptor, newly. Also, it is mentioned those descriptors are included on the table(s), such as, PMT, EIT [basic/schedule extended/present/following], NIT, SDT, etc., and transmitted.

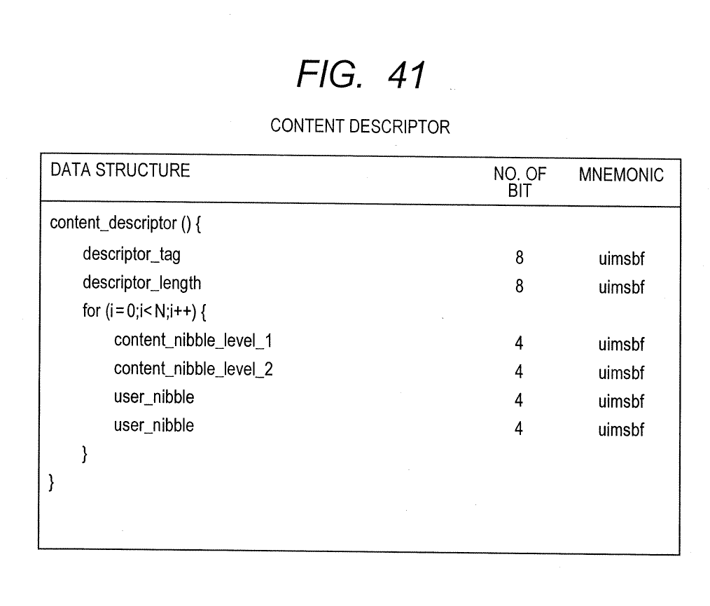

Herein, as a further other example, explanation will be made of an example of disposing or arranging the identification information of the 3D program (event) within the content descriptor (Content descriptor) shown in FIG. 41

FIG. 41 shows an example of the content descriptor, as one of the program information. The content descriptor describes the information relating to a genre (or category) of the event (program). This descriptor is disposed in EIT. In this content descriptor can be also described the information indicative of program characteristics, other than the genre information of the event (program).

The structure of the component descriptor is as follows. “descriptor_tag” is a field of 8 bits for identifying the descriptor itself, in this descriptor are described the content descriptor and a distinguishable value thereof “0x54”. “descriptor_length” is a field of 8 bits, and describing size of this descriptor therein.

“content_nibble_level_{—}1” (genre 1) is a field of 4 bits, and presents a first stage classification of content identification. In more details, there is described a large or rough classification. When presenting the program characteristic, “0xE” is designated.

“content_nibble_level_{—}2” (genre 2) is a field of 4 bits, and presents the second stage classification of content identification in more details than “content_nibble_level_{—}1” (genre 1). In more details, there is described a middle-level classification of the program genre. If “content_nibble_level_{—}1”=“0xE”, the type on the program characteristic code table is described therein.

“user_nibble” (user genre) is a field of 4 bits, and describes the program characteristics therein, only when “content_nibble_level_{—}1”=“0xE”. In case other than that, it is assumed to be “0xFF” (no definition). As is shown in FIG. 41, the field of 4 bits of “user_nibble” can be disposed by two (2) pieces, and the program characteristics can be defined by a combination of two (2) values of those “user_nibble”s (hereinafter, the bits disposed in front is called a ‘first “user_nibble” bit’, and that disposed behind a ‘second “user_nibble” bit’, respectively.)

The receiver receiving that content descriptor determines that the said descriptor is the content descriptor if “descriptor_tag” is “0x54”. Also, it is possible to determine the end of data described in the present descriptor, by means of “descriptor_length”. Further, processing is executed, with determining the description of parts, equal to or less than the length indicated by “descriptor_length”, to be effective, while neglecting the description exceeding that.

Also, the receiver determines on whether the value of “content_nibble_level_{—}1” is “0xE” or not, and determines it as the large classification when deciding “0xE”. When not “0xE”, it is not determined as the genre (category); but it is so determined that any program characteristic is designated in the following “user_nibble”.

The receiver determines “content_nibble_level_{—}2” is the middle classification of the program genre (category) when the value of “content_nibble_level_{—}1” is not “0xE”, to be used together with the large classification of the program genre (category) in searching or displaying, etc. When the above-mentioned “content_nibble_level_{—}1” is “0xE”, determination is made that it indicates a type on the program characteristic code table, which is defined by a combination of the first “user_nibble” bit and the second “user_nibble” bit.

The receiver determines that, when the above-mentioned “content_nibble_level_{—}1” is “0xE”, the first “user_nibble” bit and the second “user_nibble” bit are bits for indicating the program characteristic in combination thereof. when the above-mentioned “content_nibble_level_{—}1” is not “0xE”, the first “user_nibble” bit and the second “user_nibble” bit are neglected, even if any value is inserted therein.

Therefore, when the value of “content_nibble_level_{—}1” of the descriptor is not “0xE”, the broadcast station is able to transmit the genre (category) information of the target event (program) to the receiver, in combination of the values of “content_nibble_level_{—}1” and “content_nibble_level_{—}2”.

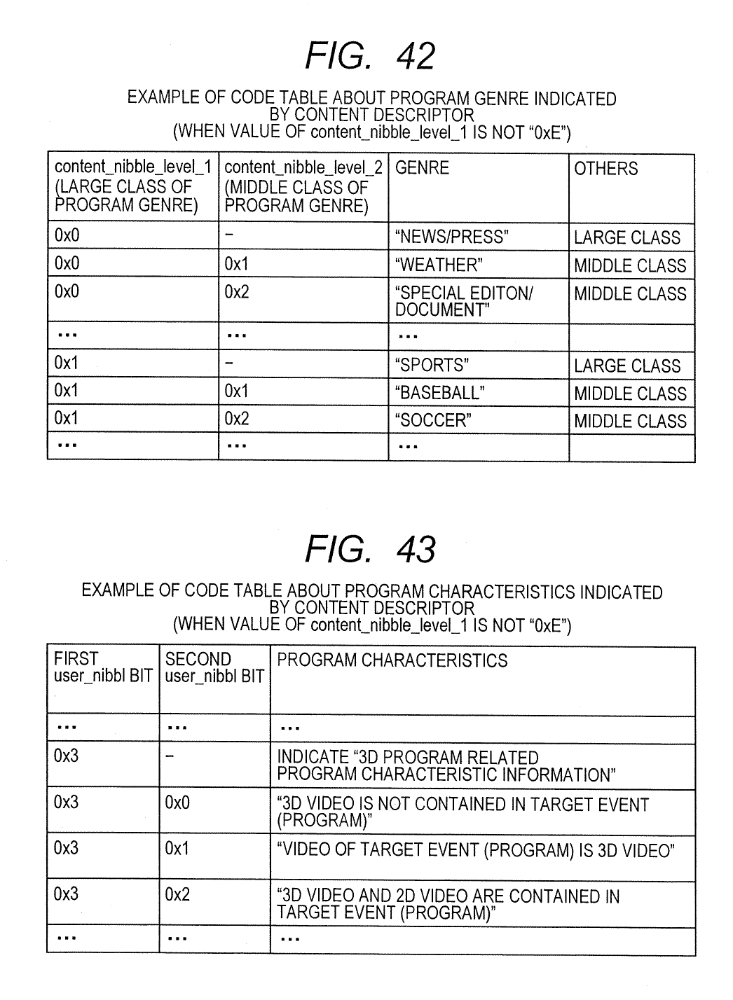

Herein, explanation will be given about an example, as shown in FIG. 42, wherein the large classification of the program genre (category) is defined as “news/press” when the value of “content_nibble_level_{—}1” is “0x0”, and it is further defined as “weather” when the value of “content_nibble_level_{—}1” is “0x0” and also when the value of the content of “content_nibble_level_{—}2” is “0x1”, and it is further defined as “special edition/document” when the value of “content_nibble_level_{—}1” is “0x0” and also when the value of the content of “content_nibble_level_{—}2” is “0x2”, respectively, as well as, the large classification of the program genre (category) is defined as “sports” when the value of “content_nibble_level_{—}1” is “0x1”, and it is further defined as “baseball” when the value of “content_nibble_level_{—}1” is “0x1” and also when the value of “content_nibble_level_{—}1” is “0x2”, and it is further defined as “soccer” when the value of “content_nibble_level_{—}1” is “0x1” and also when the value of “content_nibble_level_{—}2” is “0x2”, respectively.

In this case, the receiver is able to determined the large classification of the program genre (category) to be “news/press” or “sports”, depending on the value of “content_nibble_level_{—}1”, and further determine the middle classification of the program genre (category), which is leveled to be lower than the large classification of the program genre (category), such as, “news/press” or “sports”, by the combination of the value of “content_nibble_level_{—}1” and the value of “content_nibble_level_{—}2”.

However, for achieving such the determining process as mentioned above, it is enough to memorize a genre code table information for indicating a corresponding relationship of definitions between the combination of the value of “content_nibble_level_{—}1” and the value of “content_nibble_level_{—}2” and the program genre (category), within a memory unit, which the receiver has.

Herein, explanation will be made about a case of transmitting the program characteristic information of the 3D program relation of the target event (program) with using that content descriptor. Hereinafter, explanation will be made about the case where the identification information of the 3D program is transmitted, not as the program genre (category), but as the program characteristic.

First of all, when transmitting the program characteristic information relating to the 3D program with using the content descriptor, the broadcast station transmits the content descriptor with setting “content_nibble_level_{—}1” thereof to “0xE”. With this, the receiver is able to determine the information transmitted by that content descriptor is, not the genre (category) information, but the program characteristic information of the target event (program). Also, with this, it is possible to determine that the first “user_nibble” bit and the second “user_nibble” bit indicate, which are described in the content descriptor, indicate the program characteristic information by the combination thereof.

Herein, explanation will be given about an example, as shown in FIG. 43, wherein the program characteristic information of the target event (program), which is transmitted by the said content descriptor, is defined as “program characteristic information relating to 3D programs” when the value of the first “user_nibble” bit is “0x3”, the program characteristic is further defined as “no 3D picture is included in target event (program)” when the value of the first “user_nibble” bit is “0x3” and also when the value of the second “user_nibble” bit is “0x0”, the program characteristic is further defined as “picture of target event (program) is 3D picture” when the value of the first “user_nibble” bit is “0x3” and also when the value of the second “user_nibble” bit is “0x1”, and the program characteristic is further defined as “3 D picture and 2 D picture are included in target event (program)” when the value of the first “user_nibble” bit is “0x3” and also when the value of the second “user_nibble” bit is “0x2”, respectively.

In this case, the receiver is able to determine the program characteristics relating to the 3D programs of the target event (program) by the combination of the value of the first “user_nibble” bit and the value of the second “user_nibble” bit, and the receiver receiving EIT, which includes that descriptor therein, is able to make a display of explanation, that “no 3D picture is included” about the program, which will be received in future or which is received at present, that “3D picture program” about that program, and that “3 D picture and 2 D picture are included” about that program, or a display of graphics indicating that, on the display of the electronic program table (EPG).

Also, the receiver receiving EIT including or containing that content descriptor therein is able to search or pick up the program including no 3D picture therein, the programs including the 3D picture therein, and the pictures including the 3D picture and the 2D picture therein, etc., and thereby making a list display of those programs, so on.

Further, for achieving that determining processes, it is enough to memorize the program characteristic code table information, in advance, indicating the corresponding relationship between the combination of the first “user_nibble” bit and the value of the second “user_nibble” bit, in the memory unit that the apparatus has.

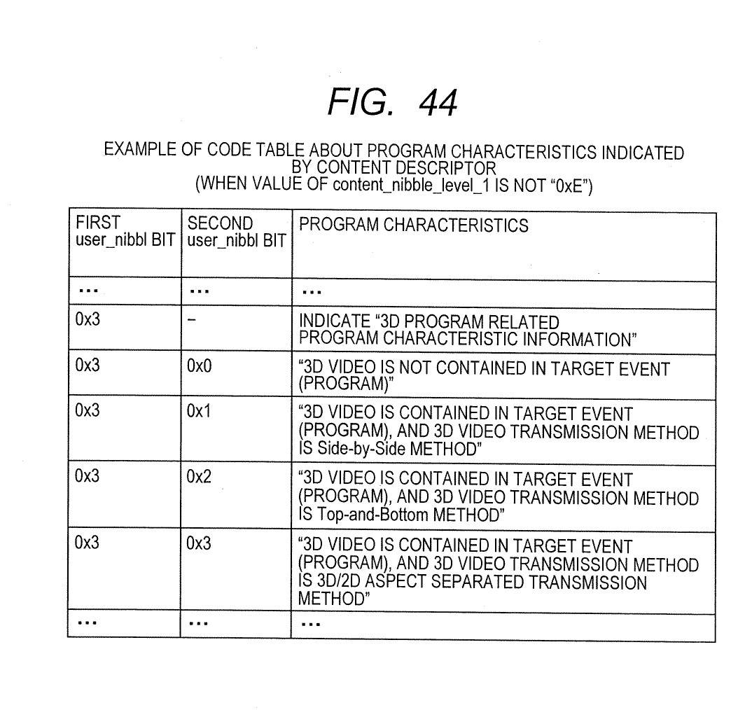

Also, as an example of other definition of the program characteristic information relating to the 3D programs, explanation will be given about the case where, for example, as shown in FIG. 44, the program characteristic information of the target event (program) transmitted by that content descriptor is defined as “program characteristic information relating to 3D programs”, when the value of the first “user_nibble” bit is “0x3”, and the program characteristic is further defined as “no 3D picture is included in target event (program)” when the value of the first “user_nibble” bit is “0x3” and also when the value of the second “user_nibble” bit is “0x0”, the program characteristic is further defined as “3D picture is included in target event (program), and 3D picture transmission method is Side-by-Side method” when the value of the first “user_nibble” bit is “0x3” and also when the value of the second “user_nibble” bit is “0x1”, the program characteristic is further defined as “3D picture is included in target event (program), and 3D picture transmission method is Top-and-Bottom method” when the value of first “user_nibble” bit is “0x3” and also when the value of the second “user_nibble” bit is “0x2”, and the program characteristic is further defined as “3D picture is included in target event (program), and 3D picture transmission method is 3D 2-aspects separated ES transmission method” when the value of the first “user_nibble” bit is “0x3” and also when the value of the second “user_nibble” bit is “0x3”, respectively.

In this case, the receiver is able to determine the program characteristics relating to the 3D programs of the target event (program), by the combination of the value of the first “user_nibble” bit and the value of the second “user_nibble” bit, and also to determine, not only on whether the 3D picture is included or not in the target event (program), but also of the 3D transmitting method when including the 3D video therein. If the receiver memorizes the information of the 3D transmission method operable therewith (3D reproducible) into the memory unit owned by the receiver, the receiver is able to make a display of explanation, that “3D picture is included” about the program, which will be received in future, or which is received at present, that “3D picture is included, and can be 3D reproduced by this receiver” about that program, and that “3D picture is included, but not 3D reproduced by this receiver” about that program, or a display of graphics indicating that, on the display of the electronic program guide (EPG), by comparing the information of the 3D transmission method operable (reproducible), which is memorized in the memory unit in advance, and the information of the 3D transmission method of the target event (program), which is determined by the content descriptor included in EIT.

Also, in the example mentioned above, although the program characteristic is defined “3D picture is included in target event (program), and 3D transmission method is 3D 2-aspects separated ES transmission method” when the value of the first “user_nibble” bit is “0x3” and also when the value of the second “user_nibble” bit is “0x3”; however, the value of the second “user_nibble” bit may be prepared for each of detailed combinations of “3D 2-aspects separated ES transmission method” shown in FIG. 40. With doing so, further detailed identification can be made.

Also, the information of the 3D transmission method of the target event (program) may be displayed.

Also, the receiver receiving EIT including that content descriptor therein is able to search or pick up the programs including no 3D picture therein, the programs including the 3D picture therein and 3D reproducible, and the programs including the 3D picture but 3D un-reproducible in, etc., and thereby making a list display of those programs, and so on.

And a program search can be made on each 3D transmission method, relating to the programs including the 3D picture therein, and also the list display can be made of the programs by each 3D transmission method. Further, the search of the program(s), which include(s) therein but cannot be 3D reproduced by the present receiver, and/or the program search by each 3D transmission method is/are effective if they can be reproduced by other video program reproducing apparatus owned by the user, for example even if they cannot be 3D reproduced by the present receiving apparatus. This is because, even with the program including the 3D picture therein, which cannot be 3D reproduced by the present receiver, it is also possible to output that program, keeping the transport stream format thereof as it is, from the video output portion of the present receiver to other 3D video program reproducing equipment, thereby reproducing in 3D the program of the received transport stream format, on the 3D video program reproducing equipment, and also it is possible to reproduce in 3D the program mentioned above, which is recorded on that removable medium by the other 3D video program reproducing equipment mentioned above, if there is a recoding unit for recording the content onto a removable medium in the present receiver.

However, for achieving such determination process as was mentioned above, it is enough to memorized the program characteristic code table information, in advance, indicating the corresponding relationship of the combination of the value of the first “user_nibble” bit and the value of the second “user_nibble” bit and the definition of the program characteristic, and also the information of the 3D transmission method, being compatible or operable with the receiver (3D reproducible), into the memory unit that the receiver has.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A receiving apparatus, for receiving a digital broadcast signal, which is broadcasted by combining 3D video program content and 2D video program content, comprising:
a receiver unit, which is configured to receive a digital broadcast signal, including program content and a first identification information for identifying said program content to be a 3D picture program or a 2D picture program; and
a controller unit, which is configured to determine said program content received to be a 3D video program content or a 2D video program content, upon basis of said first identification information about said program content received by said receiver unit, and further determine a 3D view preparation condition, being a condition for preparing view of 3D video by a user, wherein
a video signal is outputted, being exchanged between 2D display and 3D display, determined from the 3D view preparation condition of the user and the information of whether the program content identified from said first identification information is the 3D video program content or the 2D video program content.

2. A receiving apparatus, for receiving a digital broadcast signal, which is broadcasted by combining 3D video program content and 2D video program content, comprising:
a receiver unit, which is configured to receive a digital broadcast signal, including program content, a first identification information for identifying said program content to be a 3D picture program or a 2D picture program, and a second identification information for identifying a type of 3D transmission of said 3D video program when said program content is the 3D video program; and
a controller unit, which is configured to determine said program content received to be a 3D video program content or a 2D video program content, upon basis of said first identification information about said program content received by said receiver unit, determine a type of the 3D method of said 3D video program content, when said program content is the 3d video program content, and further determine a 3D view preparation condition, being a condition for preparing view of 3D video by a user, wherein
a video signal is outputted, being exchanged between 2D display and 3D display, upon basis of the 3D view preparation condition of the user, the information of whether the program content identified from said first identification information is the 3D video program content or the 2D video program content, and further the type of the 3D method of the broadcast, which is identified from said second identification information.

3. The receiving apparatus, as described in the claim 1, further comprising:
a video converter unit, which is configured to execute a process of converting the 2D video into the 3D video, wherein
the 2D video program content received is converted into the 3D video program content upon basis of the 3D view preparation condition of the user, the video format, which is identified from said first identification information, and the 3D method type of the broadcast, which is identified from said second identification information.

4. The receiving apparatus, as described in the claim 2, further comprising:
a video converter unit, which is configured to execute a process of converting the 2D video into the 3D video, wherein
the 2D video program content received is converted into the 3D video program content upon basis of the 3D view preparation condition of the user, the video format, which is identified from said first identification information, and the 3D method type of the broadcast, which is identified from said second identification information.

5. The receiving apparatus, as described in the claim 3, further comprising:
a video processor unit, which is configured to be able to output OSD, wherein
a message that a process is executed for converting the 2D video into the 3D video depending on necessity thereof is displayed, when executing a process for converting the 2D video into the 3D video.

6. The receiving apparatus, as described in the claim 4, further comprising:
a video processor unit, which is configured to be able to output OSD, wherein
a message that a process is executed for converting the 2D video into the 3D video depending on necessity thereof is displayed, when executing a process for converting the 2D video into the 3D video.

7. The receiving apparatus, as described in the claim 1, further comprising:
a video processor unit, which is configured to be able to output OSD, wherein
a message that the 3D program is started, when the 3D program is displayed as the 2D program.

8. The receiving apparatus, as described in the claim 2, further comprising:
a video processor unit, which is configured to be able to output OSD, wherein
a message that the 3D program is started, when the 3D program is displayed as the 2D program.

9. The receiving apparatus, as described in the claim 7, further comprising:
a user operation input unit, with which a user inputs an operation, wherein
on the message that the 3D program is started is displayed GUI for inputting the 3D view preparation condition of the user.

10. The receiving apparatus, as described in the claim 8, further comprising:
a user operation input unit, with which a user inputs an operation, wherein
on the message that the 3D program is started is displayed GUI for inputting the 3D view preparation condition of the user.

11. A receiving apparatus, for receiving a digital broadcast signal, which is broadcasted by combining 3D video program content and 2D video program content, comprising:
a receiver unit, which is configured to receive a digital broadcast signal, including program content and a first identification information for identifying said program content to be a 3D picture program or a 2D picture program;
a controller unit, which is configured to determine said program content received to be a 3D video program content or a 2D video program content, upon basis of said first identification information about said program content received by said receiver unit, and further determine necessity of a process for converting 2D video into 3D video; and
a video converter unit, which is configured to convert the 2D video into the 3D video, wherein
determination is made on the 3D video program, of whether the process for converting the 2D video into the 3D video is necessary or not, and when the process for converting the 2D video into the 3D video is determined necessary, then a video is outputted, after being converted from the 2D video into the 3D video.

12. A receiving apparatus, for receiving a digital broadcast signal, which is broadcasted by combining 3D video program content and 2D video program content, comprising:
a receiver unit, which is configured to receive a digital broadcast signal, including program content, a first identification information for identifying said program content to be a 3D picture program or a 2D picture program, and a second identification information for identifying a type of 3D transmission of said 3D video program when said program content is the 3D video program; and
a controller unit, which is configured to determine said program content received to be a 3D video program content or a 2D video program content, upon basis of said first identification information about said program content received by said receiver unit, determine a type of the 3D method of said 3D video program content, when said program content is the 3d video program content, and further determine necessity of a process for converting 2D video into 3D video; and
a video converter unit, which is configured to convert the 2D video into the 3D video, wherein
determination is made on the 3D video program, of whether the process for converting the 2D video into the 3D video is necessary or not, and when the process for converting the 2D video into the 3D video is determined necessary, then a video is outputted, after being converted from the 2D video into the 3D video.

13. The receiving apparatus, as described in the claim 11, wherein coincidence between a video for a left-side eye and a video for a right-side eye is used as a condition for determining of whether the process for converting the 2D video into the 3D video is necessary or not.

14. The receiving apparatus, as described in the claim 12, wherein coincidence between a video for a left-side eye and a video for a right-side eye is used as a condition for determining of whether the process for converting the 2D video into the 3D video is necessary or not.

15. The receiving apparatus, as described in the claim 13, wherein,
said receiver unit receives the digital broadcast signal, including a 2D/3D conversion identification information therein, for determining of whether the process for converting the 2D video into the 3D video is necessary or not,
said controller unit executes the process for converting the 2D video into the 3D video upon basis of said identification information, and
said 2D/3D conversion identification information is used as a condition for determining the process for converting from the 2D video into the 3D video necessary, when determining necessity of the process for converting from the 2D video into the 3D video necessary.

16. The receiving apparatus, as described in the claim 14, wherein,
said receiver unit receives the digital broadcast signal, including a 2D/3D conversion identification information therein, for determining of whether the process for converting the 2D video into the 3D video is necessary or not,
said controller unit executes the process for converting the 2D video into the 3D video upon basis of said identification information, and
said 2D/3D conversion identification information is used as a condition for determining the process for converting from the 2D video into the 3D video necessary, when determining necessity of the process for converting from the 2D video into the 3D video necessary.

17. The receiving apparatus, as described in the claim 11, further comprising:
a user operation input unit, with which a user inputs an operation, wherein
determination is made of whether the process for converting from the 2D video into the 3D video is necessary or not, upon setup by the user, in the determination of whether the process for converting from the 2D video into the 3D video is necessary or not.

18. The receiving apparatus, as described in the claim 12, further comprising:
a user operation input unit, with which a user inputs an operation, wherein
determination is made of whether the process for converting from the 2D video into the 3D video is necessary or not, upon setup by the user, in the determination of whether the process for converting from the 2D video into the 3D video is necessary or not.

19. The receiving apparatus, as described in the claim 1, further comprising:
a recording/reproducing unit, which is configured to be able to record or reproduce said video converted, wherein
a signal including said video converted is recorded or reproduced.

20. The receiving apparatus, as described in the claim 2, further comprising:
a recording/reproducing unit, which is configured to be able to record or reproduce said video converted, wherein
a signal including said video converted is recorded or reproduced.

21. The receiving apparatus, as described in the claim 11, further comprising:
a recording/reproducing unit, which is configured to be able to record or reproduce said video converted, wherein
a signal including said video converted is recorded or reproduced.

22. The receiving apparatus, as described in the claim 12, further comprising:
a recording/reproducing unit, which is configured to be able to record or reproduce said video converted, wherein
a signal including said video converted is recorded or reproduced.

23. The receiving apparatus, as described in the claim 19, further comprising:
a user operation input unit, with which a user inputs a recoding method, wherein
a signal including the video converted or the video not converted is recorded, in accordance with said recording method inputted.

24. The receiving apparatus, as described in the claim 20, further comprising:
a user operation input unit, with which a user inputs a recoding method, wherein
a signal including the video converted or the video not converted is recorded, in accordance with said recording method inputted.

25. The receiving apparatus, as described in the claim 21, further comprising:
a user operation input unit, with which a user inputs a recoding method, wherein
a signal including the video converted or the video not converted is recorded, in accordance with said recording method inputted.

26. The receiving apparatus, as described in the claim 22, further comprising:
a user operation input unit, with which a user inputs a recoding method, wherein
a signal including the video converted or the video not converted is recorded, in accordance with said recording method inputted.

27. A receiving method, for receiving a digital broadcast signal, which is broadcasted by combining 3D video program content and 2D video program content, comprising the following steps of:
a receiving step for receiving a digital broadcast signal, including program content and a first identification information for identifying said program content to be a 3D picture program or a 2D picture program; and
a determining step for determining said program content received to be a 3D video program content or a 2D video program content, upon basis of said first identification information about said program content received by said receiver unit, and further determining a 3D view preparation condition, being a condition for preparing view of 3D video by a user, wherein
a video signal is outputted, being exchanged between 2D display and 3D display, determined from the 3D view preparation condition of the user and the information of whether the program content identified from said first identification information is the 3D video program content or the 2D video program content.

28. A receiving method, for receiving a digital broadcast signal, which is broadcasted by combining 3D video program content and 2D video program content, comprising the following steps of:
a receiving step for receiving a digital broadcast signal, including program content, a first identification information for identifying said program content to be a 3D picture program or a 2D picture program, and a second identification information for identifying a type of 3D transmission of said 3D video program when said program content is the 3D video program; and
a determining step for determining said program content received to be a 3D video program content or a 2D video program content, upon basis of said first identification information about said program content received by said receiver unit, determining a type of the 3D method of said 3D video program content, when said program content is the 3d video program content, and further determining a 3D view preparation condition, being a condition for preparing view of 3D video by a user, wherein
a video signal is outputted, being exchanged between 2D display and 3D display, upon basis of the 3D view preparation condition of the user, the information of whether the program content identified from said first identification information is the 3D video program content or the 2D video program content, and further the type of the 3D method of the broadcast, which is identified from said second identification information.

29. The receiving method, as described in the claim 27, further comprising the following step of:
a video converting step for execute a process of converting the 2D video into the 3D video, wherein
the 2D video program content received is converted into the 3D video program content upon basis of the 3D view preparation condition of the user, the video format, which is identified from said first identification information, and the 3D method type of the broadcast, which is identified from said second identification information.

30. The receiving method, as described in the claim 28, further comprising the following step of:
a video converting step for executing a process of converting the 2D video into the 3D video, wherein
the 2D video program content received is converted into the 3D video program content upon basis of the 3D view preparation condition of the user, the video format, which is identified from said first identification information, and the 3D method type of the broadcast, which is identified from said second identification information.

31. The receiving method, as described in the claim 29, further comprising the following step of:
a video processing step for outputting OSD, wherein
a message that a process is executed for converting the 2D video into the 3D video depending on necessity thereof is displayed, when executing a process for converting the 2D video into the 3D video.

32. The receiving method, as described in the claim 30, further comprising the following step of:
a video processing step for outputting OSD, wherein
a message that a process is executed for converting the 2D video into the 3D video depending on necessity thereof is displayed, when executing a process for converting the 2D video into the 3D video.

33. The receiving method, as described in the claim 27, further comprising the following step of:
a video processing step for outputting OSD, wherein
a message that the 3D program is started, when the 3D program is displayed as the 2D program.

34. The receiving method, as described in the claim 28, further comprising the following step of:
a video processing step or unit, which is configured to be able to output OSD, wherein
a message that the 3D program is started, when the 3D program is displayed as the 2D program.

35. The receiving apparatus, as described in the claim 7, further comprising the following step of:
a user operation inputting step for a user to input an operation, wherein
on the message that the 3D program is started is displayed GUI for inputting the 3D view preparation condition of the user.

36. The receiving apparatus, as described in the claim 8, further comprising the following step of:
a user operation inputting step for a user to input an operation, wherein
on the message that the 3D program is started is displayed GUI for inputting the 3D view preparation condition of the user.

37. A receiving method, for receiving a digital broadcast signal, which is broadcasted by combining 3D video program content and 2D video program content, comprising the following steps of:
a receiving step for receiving a digital broadcast signal, including program content and a first identification information for identifying said program content to be a 3D picture program or a 2D picture program;
a determining step for determining said program content received to be a 3D video program content or a 2D video program content, upon basis of said first identification information about said program content received by said receiver unit, and further determining necessity of a process for converting 2D video into 3D video; and
a video converting step for converting the 2D video into the 3D video, wherein
determination is made on the 3D video program, of whether the process for converting the 2D video into the 3D video is necessary or not, and when the process for converting the 2D video into the 3D video is determined necessary, then a video is outputted, after being converted from the 2D video into the 3D video.

38. A receiving method, for receiving a digital broadcast signal, which is broadcasted by combining 3D video program content and 2D video program content, comprising the following steps of:
a receiving step for receiving a digital broadcast signal, including program content, a first identification information for identifying said program content to be a 3D picture program or a 2D picture program, and a second identification information for identifying a type of 3D transmission of said 3D video program when said program content is the 3D video program; and
a determining step for determining said program content received to be a 3D video program content or a 2D video program content, upon basis of said first identification information about said program content received by said receiver unit, determining a type of the 3D method of said 3D video program content, when said program content is the 3d video program content, and further determining necessity of a process for converting 2D video into 3D video; and
a video converting step for converting the 2D video into the 3D video, wherein
determination is made on the 3D video program, of whether the process for converting the 2D video into the 3D video is necessary or not, and when the process for converting the 2D video into the 3D video is determined necessary, then a video is outputted, after being converted from the 2D video into the 3D video.

39. The receiving method, as described in the claim 37, wherein coincidence between a video for a left-side eye and a video for a right-side eye is used as a condition for determining of whether the process for converting the 2D video into the 3D video is necessary or not.

40. The receiving method, as described in the claim 38, wherein coincidence between a video for a left-side eye and a video for a right-side eye is used as a condition for determining of whether the process for converting the 2D video into the 3D video is necessary or not.

41. The receiving method, as described in the claim 37, further comprising the following steps of:
a receiving step for receives the digital broadcast signal, including a 2D/3D conversion identification information therein, for determining of whether the process for converting the 2D video into the 3D video is necessary or not; and
a controlling step for executing the process for converting the 2D video into the 3D video upon basis of said identification information, wherein
said 2D/3D conversion identification information is used as a condition for determining the process for converting from the 2D video into the 3D video necessary, when determining necessity of the process for converting from the 2D video into the 3D video necessary.

42. The receiving method, as described in the claim 38, further comprising the following steps of:
a receiving step for receiving the digital broadcast signal, including a 2D/3D conversion identification information therein, for determining of whether the process for converting the 2D video into the 3D video is necessary or not; and
a controlling step for executing the process for converting the 2D video into the 3D video upon basis of said identification information, wherein
said 2D/3D conversion identification information is used as a condition for determining the process for converting from the 2D video into the 3D video necessary, when determining necessity of the process for converting from the 2D video into the 3D video necessary.

43. The receiving method, as described in the claim 37, further comprising the flowing step:
a user operation inputting step for a user to input an operation, wherein
determination is made of whether the process for converting from the 2D video into the 3D video is necessary or not, upon setup by the user, in the determination of whether the process for converting from the 2D video into the 3D video is necessary or not.

44. The receiving method, as described in the claim 38, further comprising the flowing step:
a user operation inputting step for a user to input an operation, wherein
determination is made of whether the process for converting from the 2D video into the 3D video is necessary or not, upon setup by the user, in the determination of whether the process for converting from the 2D video into the 3D video is necessary or not.

45. The receiving method, as described in the claim 27, further comprising the following step of:
a recording/reproducing step for recording or reproducing said video converted, wherein
a signal including said video converted is recorded or reproduced.

46. The receiving method, as described in the claim 28, further comprising the following step:
a recording/reproducing step for recording or reproducing said video converted, wherein
a signal including said video converted is recorded or reproduced.

47. The receiving method, as described in the claim 37, further comprising the following step:
a recording/reproducing step for recording or reproducing said video converted, wherein
a signal including said video converted is recorded or reproduced.

48. The receiving method, as described in the claim 38, further comprising the following step:
a recording/reproducing step for recording or reproducing said video converted, wherein
a signal including said video converted is recorded or reproduced.

49. The receiving method, as described in the claim 27, further comprising the following step:
a user operation inputting step for a user to input a recoding method, wherein
a signal including the video converted or the video not converted is recorded, in accordance with said recording method inputted.

50. The receiving method, as described in the claim 28, further comprising the following step:
a user operation inputting step for a user to input a recoding method, wherein
a signal including the video converted or the video not converted is recorded, in accordance with said recording method inputted.

51. The receiving method, as described in the claim 37, further comprising the following step:
a user operation inputting step for a user to input a recoding method, wherein
a signal including the video converted or the video not converted is recorded, in accordance with said recording method inputted.

52. The receiving method, as described in the claim 38, further comprising the following step:
a user operation inputting step for a user to input a recoding method, wherein
a signal including the video converted or the video not converted is recorded, in accordance with said recording method inputted.
